(19) United States
(12) Patent Application Publication
(10) Pub. No.: US 2012/0246282 A1
(43) Pub. Date: Sep. 27, 2012

(54) COMMUNICATION SETTING METHOD, SERVER, RELAY DEVICE, COMMUNICATION SYSTEM, AND INFORMATION PROCESSING DEVICE

(75) Inventor: Naoki OGUCHI, Kawasaki (JP)

(73) Assignee: Fujitsu Limited, Kawasaki (JP)

(21) Appl. No.: 13/423,605

(22) Filed: Mar. 19, 2012

(30) Foreign Application Priority Data
Mar. 22, 2011 (JP) 2011-063414

(51) Int. Cl. G06F 15/177

(52) U.S. Cl. 709/221

(57) ABSTRACT

A communication setting method includes receiving, at a server in a network to be connected to another network by a plurality of connected devices, a setting request from a terminal to the server, selecting, at the server, one of the plurality of connected devices based on terminal location information regarding the location of the terminal relating to the received setting request, transmitting a setting response including identification information for identifying the selected connected device form the server to the terminal, setting, at the terminal, the connected device of this terminal based on the identification information included in the setting response.

### CROSS-REFERENCE TO RELATED APPLICATION

This application is based upon and claims the benefit of priority of the prior Japanese Patent Application No. 2011-063414, filed on Mar. 22, 2011, the entire contents of which are incorporated herein by reference.

### FIELD

The embodiments discussed herein are related to a communication setting method, a server, a relay device, a communication system, and an information processing device.

### BACKGROUND

Heretofore, there has widely been employed DHCP (Dynamic Host Configuration Protocol) for automatically performing communication settings such as an IP (Internet Protocol) address and so forth as to an information processing device to be connected to a network such as the Internet or the like. Thus, the settings and management of the network may be eased.

DHCP servers are generally disposed within the same LAN (Local Area Network) segment as with an information processing device which is a host. Also, an arrangement may be made wherein a DHCP server is disposed outside of a router, a DHCP message is relayed to the DHCP server by a DHCP relay agent serving as a router, and accordingly, the DHCP server may inform a setting to a host over a different LAN. DHCP has widely been employed for settings of a host in a network.

Also, a technique called OTV (Overlay Transport Virtualization) for connecting networks having the same subnet address provided to distant bases using layer 2 has been proposed by the IETF (Internet Engineering Task Force) (e.g., see IETF draft-hasmit-otv-01). With OTV, an MAC (Media Access Control) packet addressed to another host in another base having the same address space as with the base to which the above host belongs may have been transmitted from a certain host. In this case, a customer edge (CE: Customer Edge) directly connected to a transmission source host without passing through another device of the same type may subject a packet addressed to the MAC address of the other base to Ether over IP capsuling, to transfer the destination.

Note that a technique for a DHCP server performing a network setting as to a terminal device has been acquainted (e.g., see Japanese Laid-open Patent Publication No. 2003-348136 and Japanese Laid-open Patent Publication No. 2010-62598).

### SUMMARY

According to an aspect of the invention, a communication setting method includes receiving, at a server in a network to be connected to another network by a plurality of connected devices, a setting request from a terminal to the server, selecting, at the server, one of the plurality of connected devices based on terminal location information regarding the location of the terminal relating to the received setting request, transmitting a setting response including identification information for identifying the selected connected device form the server to the terminal, setting, at the terminal, the connected device of this terminal based on the identification information included in the setting response.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a communication system according to a first embodiment;

FIG. 2 is diagram illustrating a communication system according to a second embodiment;

FIG. 3 is a diagram illustrating a DHCP server and information processing device according to the second embodiment;

FIG. 4 is a diagram illustrating a switch and edge device according to the second embodiment;

FIGS. 5A and 5B are diagrams indicating a DHCP DISCOVER message and DHCP REQUEST message including identification information according to the second embodiment;

FIG. 6 is a diagram indicating a setting table according to the second embodiment;

FIG. 7 is a block diagram illustrating the communication system according to the second embodiment;

FIG. 8 is a flowchart illustrating setup information transmission processing according to the second embodiment;

FIG. 9 is a sequence chart illustrating operation at the time of activation of a VM in the communication system according to the second embodiment;

FIG. 10 is a sequence chart illustrating operation at the time of activation of the VM in the communication system according to the second embodiment;

FIG. 11 is a sequence chart illustrating operation at the time of activation of the VM in the communication system according to the second embodiment;

FIG. 12 is a sequence chart illustrating operation at the time of activation of the VM in the communication system according to the second embodiment;

FIG. 13 is a diagram illustrating the live migration of the VM according to the second embodiment;

FIG. 14 is a sequence chart illustrating operation at the time of the live migration of the VM in the communication system according to the second embodiment;

FIG. 15 is a sequence chart illustrating operation at the time of the live migration of the VM in the communication system according to the second embodiment;

FIG. 16 is a block diagram illustrating a communication system according to a third embodiment;

FIG. 17 is a diagram illustrating an edge device according to the third embodiment;

FIG. 18 is a sequence chart illustrating operation at the time of activation of a VM in the communication system according to the third embodiment;

FIG. 19 is a sequence chart illustrating operation at the time of the live migration of the VM in the communication system according to the third embodiment;

FIG. 20 is a sequence chart illustrating operation at the time of the live migration of the VM in the communication system according to the third embodiment;

FIG. 21 is a block diagram illustrating a communication system according to a fourth embodiment;

FIG. 22 is a diagram illustrating the communication system according to the fourth embodiment;

FIG. 23 is a diagram illustrating a base station control device according to the fourth embodiment;

FIG. 24 is a sequence chart illustrating operation at the time of activation of a mobile station in the communication system according to the fourth embodiment;

FIG. 25 is a sequence chart illustrating operation at the time of handover of the mobile station in the communication system according to the fourth embodiment;

FIG. 26 is a block diagram illustrating a communication system according to a fifth embodiment;

FIG. 27 is a diagram illustrating the communication system according to the fifth embodiment;

FIGS. 28A and 28B are diagrams indicating a DHCP DISCOVER message and DHCP REQUEST message including identification information according to the fifth embodiment;

FIG. 29 is a diagram indicating a setting table according to the fifth embodiment;

FIG. 30 is a sequence chart illustrating operation at the time of activation of a mobile station in the communication system according to the fifth embodiment;

FIG. 31 is a sequence chart illustrating operation at the time of handover of the mobile station in the communication system according to the fifth embodiment;

FIG. 32 is a block diagram illustrating a communication system according to a sixth embodiment;

FIG. 33 is a diagram illustrating a mobile station according to the sixth embodiment;

FIG. 34 is a sequence chart illustrating operation at the time of activation of the mobile station in the communication system according to the sixth embodiment;

FIG. 35 is a sequence chart illustrating operation at the time of handover of the mobile station in the communication system according to the sixth embodiment;

FIG. 36 is a sequence chart illustrating operation at the time of handover of the mobile station in the communication system according to the sixth embodiment;

FIG. 37 is a block diagram illustrating a communication system according to a seventh embodiment;

FIG. 38 is a diagram indicating a configuration table according to the seventh embodiment;

FIG. 39 is a sequence chart illustrating operation at the time of activation of a VM in the communication system according to the seventh embodiment;

FIG. 40 is a sequence chart illustrating operation at the time of the live migration of the VM in the communication system according to the seventh embodiment;

FIG. 41 is a sequence chart illustrating operation at the time of the live migration of the VM in the communication system according to the seventh embodiment;

FIG. 42 is a block diagram illustrating a communication system according to an eighth embodiment; and

FIG. 43 is a diagram illustrating the communication system according to the eighth embodiment;

### DESCRIPTION OF EMBODIMENTS

Hereinafter, embodiments according to the present disclosure will be described with reference to the drawings.

While inventing the present embodiments, observations were made regarding a related art. Such observations include the following, for example.

In a communication system of the related art, there may be cases having different suitable communication settings according to the location of an information processing device which is a host depending on network configurations.

For example, there may be a case where one default router or default gateway is selected from multiple router devices or gateway devices within a network as to the host, and set. Here, the default router and default gateway are the substantially same conception. The default router or the default gateway is a computer or router or the like serving as input/output at the time of accessing outside of the network to which the host is connected. And the default router or the default gateway is applied to a case where the host does not apparently specify a particular gateway.

If a default router of which the location is distant from the host has been set, communication between the host and the default router flows a long distance route over the network. This results in usage of a band at long distance over the network, thereby leading to waste of communication resources.

In particular, this may cause a great problem in a case where multiple geographically distant networks have been connected by the above OTV, or the like. For example, the networks of two spots of Boston and Seattle may be connected by OTV, and a gateway device may be provided to each of Boston and Seattle. Now, there may be a case where the gateway device in Boston has been set as a default router as to the host over the network in Seattle. In such a case, in the event of attempting to access another host in Seattle over an external network from the host in Seattle, this passes through the gateway device in Boston. In particular, for example, when attempting to access another host in Seattle over the external network from the host in Seattle, the host in Seattle is consequently connected to the other host in Seattle after temporarily going out on the external network via the gateway device in Boston. Consequently, communication travels out and back between Seattle and Boston. Such a situation uses a band at long distance over the network, which is not desirable from a point of view of waste of communication resources. Also, this is not desirable from a point of view of delay in communication.

In such a case, in order to suppress communication volume within the network, it is desirable to select a router device of which the location is closer to the host as a default router.

Here, it may be generally difficult for a DHCP server to determine the location of the host. For example, in the event that the substantially same subnet address is set to multiple networks, it is difficult for a DHCP server to determine which network the host belongs to.

### First Embodiment

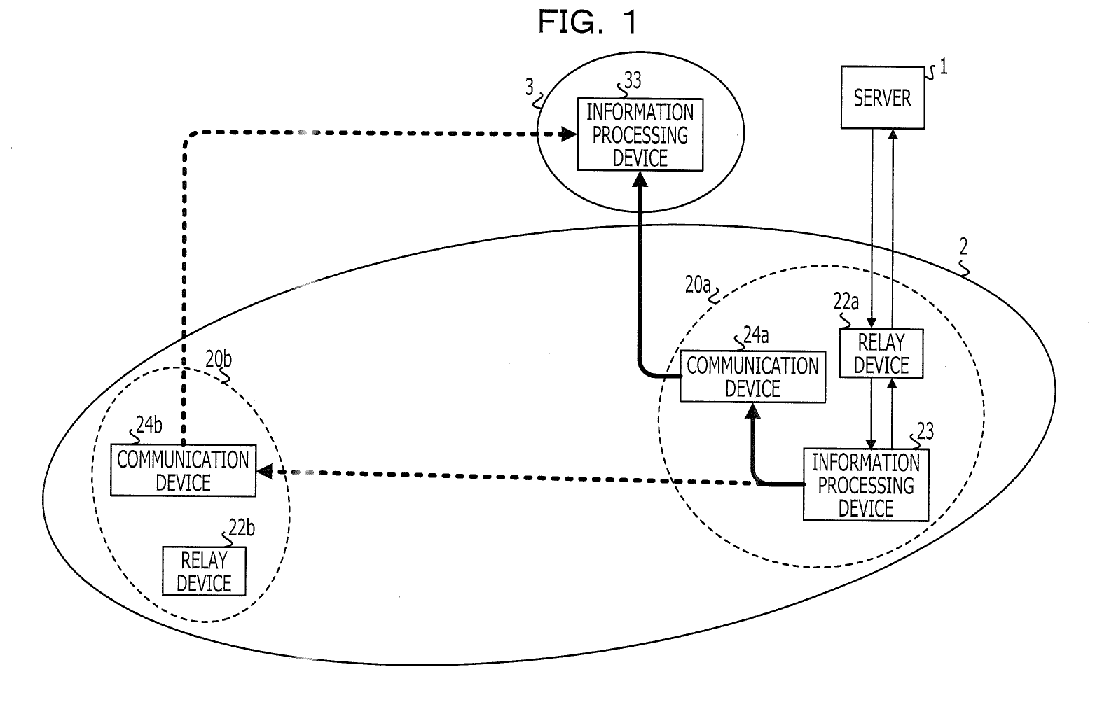

FIG. 1 is a diagram illustrating a communication system according to a first embodiment. The communication system according to the first embodiment includes networks 2 and 3. Also, the network 2 further includes networks 20a and 20b which are subnets to which the same subnet address is set. With the networks 20a and 20b, path length between both may be longer as compared to other communication paths. Also, between the networks 20a and 20b may be connected with a virtual path according to tunneling such as EoIP.

A server 1 is a DHCP server which performs communication setting of another device, or the like, and performs a setting of a default router as to an information processing device 23, and so forth.

In the event of having received a setup information request (e.g. setting request) including identification information, the server 1 transmits setup information (e.g. setting information) indicting settings of the information processing device 23 to the information processing device 23 in response to the setup information request from the information processing device 23 transferred by a relay device 22a. The setup information may be an IP address such a communication device 24a to be set as a default router of the information processing device 23, for example. At this time, the server 1 selects, based on identification information included in the setup information request, and setup information indicating settings as to the network 20a correlated with the identification information, the setup information correlated with the identification information. The server 1 then transmits a setup information response (e.g. setting response) including the selected setup information. The setup information response may be a DHCP OFFER message including the settings of DHCP, for example. Also, the setup information response may be a DHCP ACK message at the time of handover of wireless communication, at the time of DHCP Renewing, or at the time of DHCP Rebinding, for example.

The network 20a includes a relay device 22a, an information processing device 23, and a communication device 24a. The network 20b includes a communication device 24b and a relay device 22b. The network 3 includes an information processing device 33, and also includes a relay device and a communication device which are not illustrated.

The information processing device 23 may be an actual computer (hereafter, physical machine), or may be a virtual machine (Virtual Machine: VM) which operates over a physical machine. In the event of having received the setup information response transmitted from the server 1, the information processing device 23 may perform communication setting suitable for the network 20a to which the information processing device 23 belongs, such as the default router or the like, using setup information included in the setup information response.

In the event of performing communication setting in accordance with the server 1, the information processing device 23 transmits a setup information request for requesting the IP address of the own device, allocation of a default router, or the like to the server 1 via the relay device 22a. The setup information request may be a DHCP DISCOVER message, for example. Also, the setup information request may be a DHCP REQUEST message at the time of DHCP Renewing, at the time of DHCP Rebinding, or at the time of handover of wireless communication.

In the event of having received the setup information request transmitted from the information processing device 23, the relay device 22a includes identification information indicating the network 20a to which the information processing device 23 belongs of the networks 20a and 20b having the same subnet address, in the received setup information request. Examples of the identification information include code set so as to uniquely determine the network to which the information processing device 23 belongs. Also, the identification information may be code allocated so as to uniquely determine the relay device 22a within the communication system. The relay device 22a then transmits a setup information request including the identification information to the server 1. In the event that the setup information request has already included the identification information according to another device at the time of transfer, the relay device 22a may not include the identification information at the own device. The relay device 22a may be a device which relays packets, such as a L2 switch, a L3 switch, a router, an edge device which may set a virtual path, or the like. The communication devices 24a and 24b may be a device which connects networks, such as a L3 switch, a router, an edge device, or the like.

Now, the information processing device 23 transmits data to an information processing device 33 disposed in the network 3 having a network address different from the network 2 via the default router. At this time, in the event of transmitting the packets of user data, the information processing device 23 may transmit the packets with the communication device 24a of the network 20a as the default router. Also, the information processing device 23 may transmit the packets with the communication device 24b of the network 20b as the default router. In this case, which of the communication devices 24a and 24b the information processing device 23 transmits the packets to the information processing device 33 with as the default router is a problem. In this way, it may be a problem how to perform communication setting suitable for the network to which the information processing device 23 belongs.

Now, for example, distance between the networks 20a and 20b is longer distance as compared to the path lengths of other communication paths. In this case, when the information processing device 23 of the network 20a transmits the packets to the information processing device 33 via the communication device 24b disposed in the network 20b, occurrence of delay, or increase in the load of a device included in the communication system may be caused. On the other hand, when the information processing device 23 transmits the packets to the information processing device 33 via the communication device 24a disposed in the network 20a, the above problems are suppressed. In this way, there may be a case where there is change in occurrence/non-occurrence of delay or the load of the communication system, by the information processing device 23 depending on which of the communication devices 24a and 24b communication is performed through. Also, this may be applied to a case where between the networks 20a and 20b is connected a virtual path which may require processing such as encryption, decoding, label conversion, or the like.

On the other hand, with the first embodiment, the relay device 22a disposed in the same network 20a as with the information processing device 23 includes, in the setup information request to be transmitted from the information processing device 23 to the server 1, identification information capable of identifying the network 20a to which the own device belongs, and transfers this to the server 1. Thus, in the event of having received the setup information request from the information processing device 23, the server 1 may determine the network 20a to which the information processing device 23 belongs from identification information included in the setup information request.

In accordance with this, the server 1 may include the setup information indicating settings suitable for the network 20a to which the information processing device 23 belongs in a setup information response, based on the identification information, and transmit this to the information processing device 23.

For example, of the devices within the network 20a, the communication device 24a disposed in the network 20a is suitable as the default router. In this case, the administrator of the communication system correlates, with setup information that the server 1 includes, the identification information of the relay device 22a disposed in the network 20a with that the communication device 24a is set as the default router. In this case, based on the identification information of the relay device 22a included in the setup information request transmitted from the relay device 22a, the server 1 may set the communication device 24a which is the default router suitable for the disposed network 20a to the information processing device 23.

In the event of having received the setup information response transmitted from the server 1, the information processing device 23 may perform communication setting suitable for the network 20a to which the information processing device 23 belongs using setup information included in the setup information response. In the event of belonging to the network 20a, the information processing device 23 may set the communication device 24a as the default router according to the setting selected by the server 1 based on the identification information of the relay device 22a.

With the communication system according to the first embodiment as described above, the relay device 22a which has received the setup information request from the information processing device 23 includes the identification information indicates the network 20a to which the information processing device 23 belongs at the time of relaying the setup information request, in the setup information request, and transfers this to the server 1. The server 1 which has received the setup information request including the identification information transmits a setup information response including setup information indicating the communication setting corresponding to the network 20a to which the information processing device 23 belongs, to the information processing device 23 based on the identification information. The information processing device 23 which has received the setup information response transmitted from the server 1 performs communication setting based on the setup information included in the setup information response. Therefore, communication setting suitable for the location of the information processing device 23 may be performed. Accordingly, occurrence of delay, and load of the communication system may be suppressed.

Note that the communication system according to the first embodiment may be implemented as a wireless access carrier network such as a data center for providing a cloud service, a mobile WiMAX (Worldwide Interoperability for Microwave Access) system, or the like. With second, third, and seventh embodiments which will be described below, an example of a data center employing OTV will be described. With fourth through sixth embodiments, an example of a wireless communication system assumed as WiMAX will be described. With the eighth embodiment, an example of a data center having multiple networks will be described. However, the communication system according to the first embodiment may also be realized as a network employing another method, for example, such as layer 2VPN (Virtual Private Network), wide-area Ethernet (Ethernet: registered trademark), or the like. Also, the communication system according to the first embodiment may also be realized as another type of mobile communication system or fixed wireless communication system, for example, such as a LTE (Long Term Evolution) network or the like.

### Second Embodiment

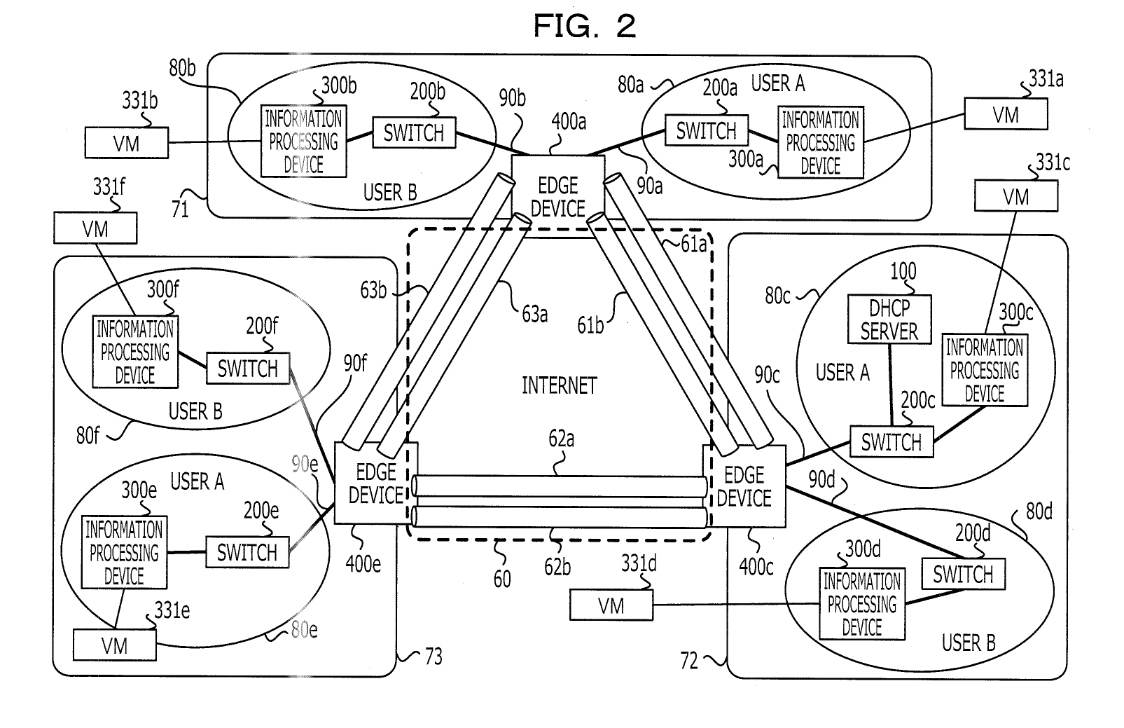

FIG. 2 is a diagram illustrating a communication system according to a second embodiment. With the communication system according to the second embodiment, there are provided data centers (Data Center: DC) 71, 72, and 73 which are multiple data centers for storing the data of a cloud computing service, and also executing processing.

Cloud computing is a technique for operating the communication system cheaply and also effectively using multiple effects by sharing virtual computing resources and network resources by multiple users.

The data centers 71, 72, and 73 provide a cloud service to users A and B which are customers. The data centers 71, 72, and 73 each operate a VM on a physical machine, thereby providing a VM hosting service to the customers. The data center 71 includes switches 200a and 200b, information processing devices 300a and 300b, and an edge device 400a. The data center 72 includes switches 200c and 200d, information processing devices 300c and 300d, and an edge device 400c. The data center 73 includes switches 200e and 200f, information processing devices 300e and 300f, and an edge device 400e. Also, a DHCP server 100 is provided to the data center 72. The edge devices 400a, 400c, and 400e may mutually be connected to OTV tunnels 61a, 61b, 62a, 62b, 63a, and 63b set over the Internet 60, and may transmit/receive data by being subjected to capsulation. Note that, though the tunnels 61a, 61b, 62a, 62b, 63a, and 63b are set over the Internet 60 by the edge devices 400a, 400c, and 400e such as customer edges, the present embodiment is not restricted to this, and these may be set over an IP wide-area network.

With the communication system according to the second embodiment, the two users (user A and user B) each have a base within the data centers 71, 72, and 73 for providing a service to the corresponding user. The user A has a base 80a in the data center 71, a base 80c in the data center 72, and a base 80e in the data center 73. Similarly, the user B has a base 80b in the data center 71, a base 80d in the data center 72, and a base 80f in the data center 73.

The base 80a is a virtual network where the nodes are connected to a VLAN (Virtual LAN) 90a (VLAN ID=100). A VM 331a which is a virtual machine server which the user A has subscribed to is operating at the information processing device 300a. 10.255.100.0/24 has been set to the base 80a as a subnet address. IP address 10.255.100.10 has been set to the VM 331a. The base 80b is a virtual network where the nodes are connected by a VLAN 90b (VLAN ID=200). Within the bases 80a and 80b, the nodes are connected by a physical line via an Ether cable, switch, or the like, and also imaginarily separated by VLANs 90a and 90b for each user. A VM 331b which is a virtual machine server which the user B has subscribed to for receiving offering of a service according to cloud computing is operating at the information processing device 300b. 192.168.2.0/24 has been set to the base 80b as a subnet address. IP address 192.168.2.40 has been set to the VM 331b. Also, the data center 71 may be connected to the Internet 60 via the edge device 400a which is a gateway. The edge device 400a separates the VLAN 90a in the base 80a and the VLAN 90b in the base 80b, and also provides a layer 3 level of connectivity in accordance with a given rule.

The bases 80c and 80e are virtual networks where the nodes are connected by VLANs 90c and 90e (VLAN ID=100) respectively in the same way as with the base 80a. The bases 80d and 80f are virtual networks where the nodes are connected by VLANs 90d and 90f (VLAN ID=200) respectively in the same way as with the base 80b. Within the bases 80c and 80d, the nodes are connected by a physical line and also imaginarily separated by VLANs 90c and 90d for each user. Within the bases 80e and 80f, the nodes are connected by a physical line and also imaginarily separated by VLANs 90e and 90f for each user. VMs 331c and 331e which are virtual machine servers which the user A has subscribed to are each operating at the information processing devices 300c and 300e. With the information processing devices 300d and 300f, the VMs 331d and 331f which are virtual machine servers each subscribed to by the user B are operating. 10.255.100.0/24 has been set to the bases 80c and 80e as a subnet address. 192.168.2.0/24 has been set to the bases 80d and 80f as a subnet address. IP addresses 10.255.100.20 and 10.255.100.30 have been set to the VMs 331c and 331e. IP addresses 192.168.2.50 and 192.168.2.60 have been set to the VMs 331d and 331f. The data center 72 may be connected to the Internet 60 via the edge device 400c. The edge device 400c separates the VLAN 90c in the base 80c and the VLAN 90d in the base 80d, and also provides a layer 3 level of connectivity in accordance with a given rule. The data center 73 may be connected to the Internet 60 via the edge device 400e. The edge device 400e separates and also mutually connects the VLAN 90e in the base 80e and the VLAN 90f in the base 80f.

Also, the VLANs 90a through 90f have switches 200a through 200f respectively. Note that the switches 200a through 200f may be virtual switches. Specifically, the switches 200a and 200b are physically integrated, and may logically separate the VLANs 90a and 90b. This may also be applied to the switches 200c through 200f and VLANs 90c through 90f.

The VLANs 90a, 90c, and 90e which the bases 80a, 80c, and 80e of the user A have respectively are mutually connected at the tunnels 61a, 62a, and 63a by the edge devices 400a, 400c, and 400e. Thus, the bases 80a, 80c, and 80e are connected at the layer 2 via the tunnels 61a, 62a, and 63a, thereby making up one LAN segment and realizing OTV. Similarly, the VLANs 90b, 90d, and 90f which the bases 80b, 80d, and 80f of the user B have respectively are mutually connected at the tunnels 61b, 62b, and 63b by the edge devices 400a, 400c, and 400e. Thus, the bases 80b, 80d, and 80f are connected at the layer 2 via the tunnels 61b, 62b, and 63b, thereby making up one LAN segment and realizing OTV. Also, the bases 80a, 80c, and 80e of the user A, and the bases 80b, 80d, and 80f of the user B may mutually be connected as an extranet (Extranet).

Also, with the communication system according to the second embodiment, a DHCP server 100 for executing setting processing according to DHCP as to hosts such as the information processing devices 300a through 300f and VMs 331a through 331f and so forth is disposed in the base 80c. IP address 192.168.2.5 has been set to the DHCP server 100.

The information processing devices 300a through 300f are physical machines where the VMs 331a through 331f operate. The VMs 331a through 331f are virtual machines for performing processing to be provided to the users A and B of the cloud service employing the data centers 71, 72, and 73. The VMs 331a through 331f operate over the information processing devices 300a through 300f. The VMs 331a through 331f may move over the information processing devices which operate by live migration (Live Migration: LM) are movable in a short interruption time without stopping the operation of an application.

Note that, with the communication system according to the second embodiment, the bases 80a through 80f are connected by the tunnels 61a through 63b, and 61b through 63b which are EoIP tunnels, but the present embodiment is not restricted to this, and these may be connected by a network employing another method such as layer 2 VPN, wide-area Ethernet, or the like.

Also, the communication system according to the second embodiment may include a communication device such as a DNS (Domain Name System) server, a NTP (Network Time Protocol) server, a PROXY server, and so forth. Also, with the communication system, based on the DHCP server 100, the setting of the above communication device according to DHCP may be performed regarding the information processing devices 300a through 300f, and the VMs 331a through 331f.

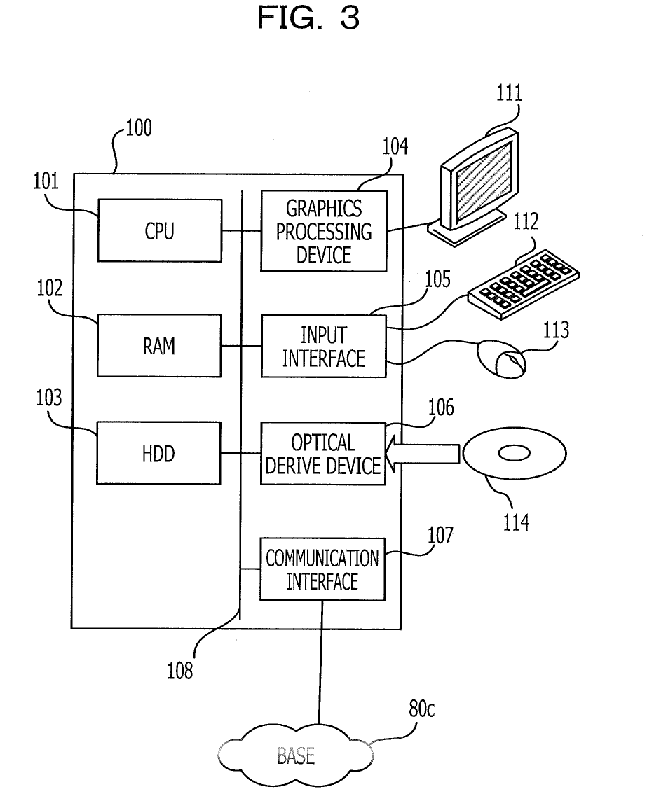

FIG. 3 is a diagram illustrating the DHCP server and information processing device according to the second embodiment. Though the DHCP server will be described below, this may also be applied to the information processing device. With the DHCP server 100, the entire device is controlled by a CPU (Central Processing Unit) 101. RAM (Random Access Memory) 102 and multiple peripheral devices are connected to the CPU 101 via a bus 108.

The RAM 102 is used as the main storage device of the DHCP server 100. At least a portion of an OS (Operating System) program or application program to be executed by the CPU 101 is temporarily stored in the RAM 102. Also, various types of data used for the processing by the CPU 101 are stored in the RAM 102.

Examples of the peripheral devices connected to the bus 108 include a hard disk drive (HDD: Hard Disk Drive) 103, a graphics processing device 104, an input interface 105, an optical drive device 106, and a communication interface 107.

The HDD 103 magnetically performs writing and reading of data as to a built-in disk. The HDD 103 is used as a secondary storage device of the DHCP server 100. An OS program, an application program, and various types of data are stored in the HDD 103. Note that a semiconductor storage device such as flash memory or the like may be used as the secondary storage device.

A monitor 111 is connected to the graphics processing device 104. The graphics processing device 104 displays an image on the screen of the monitor 111 in accordance with the command from the CPU 101. Examples of the monitor 111 include a liquid crystal display device employing a LCD (Liquid Crystal Display).

The input interface 105 is connected with a keyboard 112 and a mouse 113. The input interface 105 transmits the signal transmitted from the keyboard 112 or mouse 113 to the CPU 101. Note that the mouse 113 is an example of a pointing device, and accordingly, and another pointing device may also be employed. Examples of another pointing device include a touch panel, a tablet, a touch pad, and a track ball.

The optical drive device 106 performs reading of data recorded in an optical disc 114 by using a laser beam or the like. The optical disc 114 is a transportable recording medium in which data is recorded so as to be read by reflection of light. Examples of the optical disc 114 include DVD (Digital Versatile Disc), DVD-RAM, CD-ROM (Compact Disc Read Only Memory), and CD-R (Recordable)/RW (ReWritable).

The communication interface 107 is connected to the base 80c. The communication interface 107 performs transmission/reception of data with another computer or communication device such as the VMs 331a through 331f via the base 80c. Note that, though the hardware configuration of the DHCP server 100 is illustrated in FIG. 3, the information processing devices 300a through 300f also have the same hardware configuration.

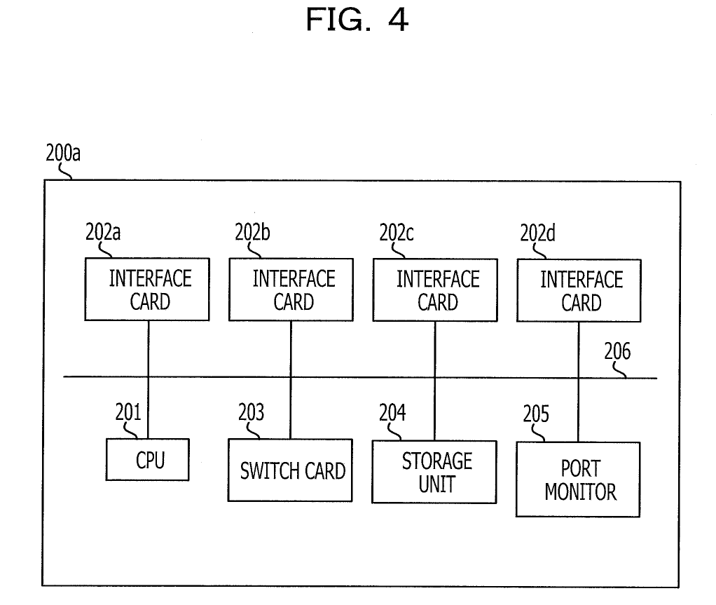

FIG. 4 is a diagram illustrating a switch and edge device according to the second embodiment. Though description will be made below regarding a switch, this may also be applied to an edge device. Though FIG. 4 illustrates the internal configuration of a switch 200a, switches 200b through 200f may also be realized with the same configuration. The switch 200a includes a CPU 201, interface cards 202a, 202b, 202c, and 202d, a switch card 203, a storage 204, a port monitor 205, and a bus 206.

The CPU 201 controls the entire switch 200a. The CPU 201 executes processing according to a program. The CPU 201 uses data held at the storage 204 to similarly execute a program stored in memory.

The storage 204 is configured of nonvolatile memory such as EEPROM (Electrically Erasable and Programmable Read Only Memory) or the like, and stores multiple tables and data used for control of communication. Examples of a table to be stored in the storage 204 include a table for managing the configuration of link, a table for determining the transfer destination of packets, and a table for storing information indicating the transfer destination of packets. Also, the storage 204 stores identification information indicating the location of a host such as the VMs 331a through 331f and so forth. In the event of having received the DHCP DISCOVER message or DHCP REQUEST message from a host such as the VMs 331a through 331f and so forth, the switch 200a includes the identification information in the received DHCP DISCOVER message or the like, and transfers this.

The bus 206 is connected with the CPU 201, interface cards 202a, 202b, 202c, and 202d, switch card 203, storage 204, and port monitor 205.

The interface cards 202a, 202b, 202c, and 202d each include multiple (e.g., eight) communication ports. Each of the communication ports may be connected with one physical link. The interface cards 202a, 202b, 202c, and 202d each monitor their respective communication ports, and obtain packets. The interface cards 202a, 202b, 202c, and 202d then transmit the obtained packets to the switch card 203.

The switch card 203 includes a learning table (not illustrated). The switch card 203 stores the transmission source address of a past received packet, and the communication port to which the packet thereof has come, in the learning table in a correlated manner. The learning table is updated by the switch card 203 whenever occasion occurs.

In the event of having received a packet from one of the interface cards 202a, 202b, 202c, and 202d, the switch card 203 references the learning table, and determines the transfer destination of the packet thereof. The switch card 203 then transmits the packet to the determined interface card 202a, 202b, 202c, or 202d.

The interface card 202a, 202b, 202c, or 202d which has received the packet transmits the received packet to the transmission destination from the determined communication port.

The port monitor 205 monitors the communication ports of the interface cards 202a, 202b, 202c, and 202d. In the event of having detected failure or restoration of a physical link connected to the communication ports of the interface card 202a, 202b, 202c, and 202d, the port monitor 205 informs that effect to the CPU 201.

Note that, though the switches 200a through 200f according to the second embodiment relay the packets of the layer 2, the present embodiment is not restricted to this, the packets of the layer 3 may be relayed. Also, in the event that a host and the DHCP server have been disposed in networks having a different network address, a DHCP DISCOVER message has been transmitted from the host to the DHCP server, and DHCP relay has been performed by the switch 200a. At this time, an arrangement may be made wherein when relaying a DHCP DISCOVER message, the switch 200a includes identification information in the DHCP DISCOVER message transmitted from the host, and transfers to the DHCP server.

The processing functions according to the second embodiment may be realized with the hardware configuration as described above.

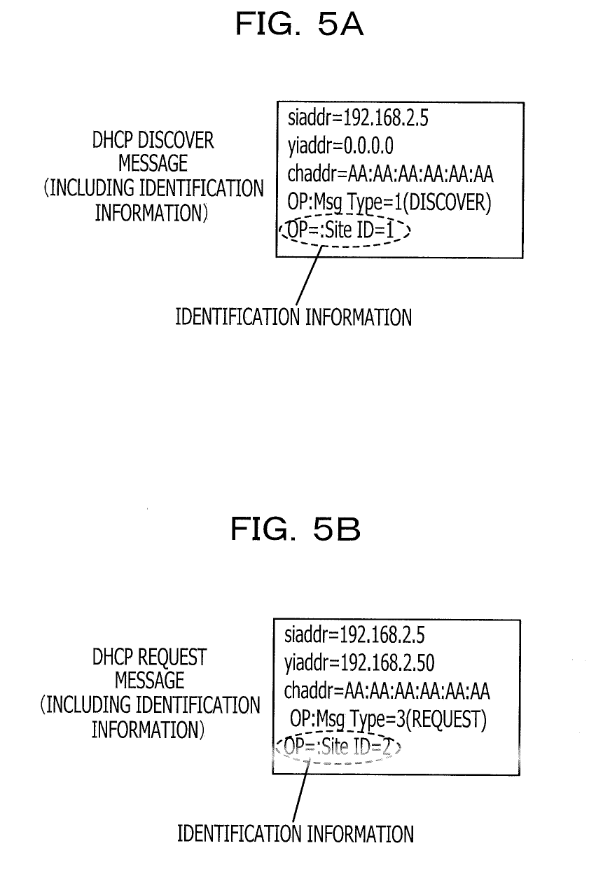

FIGS. 5A and 5B are diagrams indicating a DHCP DISCOVER message and a DHCP REQUEST message including the identification information according to the second embodiment. FIG. 5A indicates a DHCP DISCOVER message including the identification information according to the second embodiment. FIG. 5B indicates a DHCP REQUEST message including the identification information according to the second embodiment.

With the DHCP DISCOVER message indicated in FIG. 5A, “siaddr” is a 4-byte region indicating the IP address of the DHCP server 100. Also, “yiaddr” is a 4-byte region indicating the IP address of a candidate to be assigned to the VM 331a which is a host. Also, the region of “yiaddr” in the DHCP REQUEST message indicated in FIG. 5B is assigned to the VM 331a, and indicates an IP address that is an object of expiration date management.

With the communication system according to the second embodiment, in the event that a switch (e.g., switch 200a) relays the DHCP DISCOVER message transmitted from a host (e.g., VM 331a), the identification information is included in the DHCP DISCOVER message, and is transferred. Such identification information is not included in a common DHCP DISCOVER message and a later-described REQUEST message, and serves as one feature of the present disclosure.

Specifically, as indicated in FIG. 5A, the switch 200a sets the option field of the DHCP DISCOVER message transmitted from the VM 331a to SiteID (e.g., SiteID=3) as the identification information. Also, the location of the VM 331a may be informed to the DHCP server 100 by setting the identification information as the option number (e.g., DHCP option number 230) whereby private use of the DHCP option may be performed. Here, SiteID mentioned here is an identifier for identifying the bases 80a through 80f. Such an identifier is informed, whereby the DHCP server 100 may determine the location of the VM 331a. Now, SiteID may be any as long as this is an identifier whereby the location of the VM 331a may be determined, and accordingly, an identifier for identifying the data centers 71 through 73 may be employed for example.

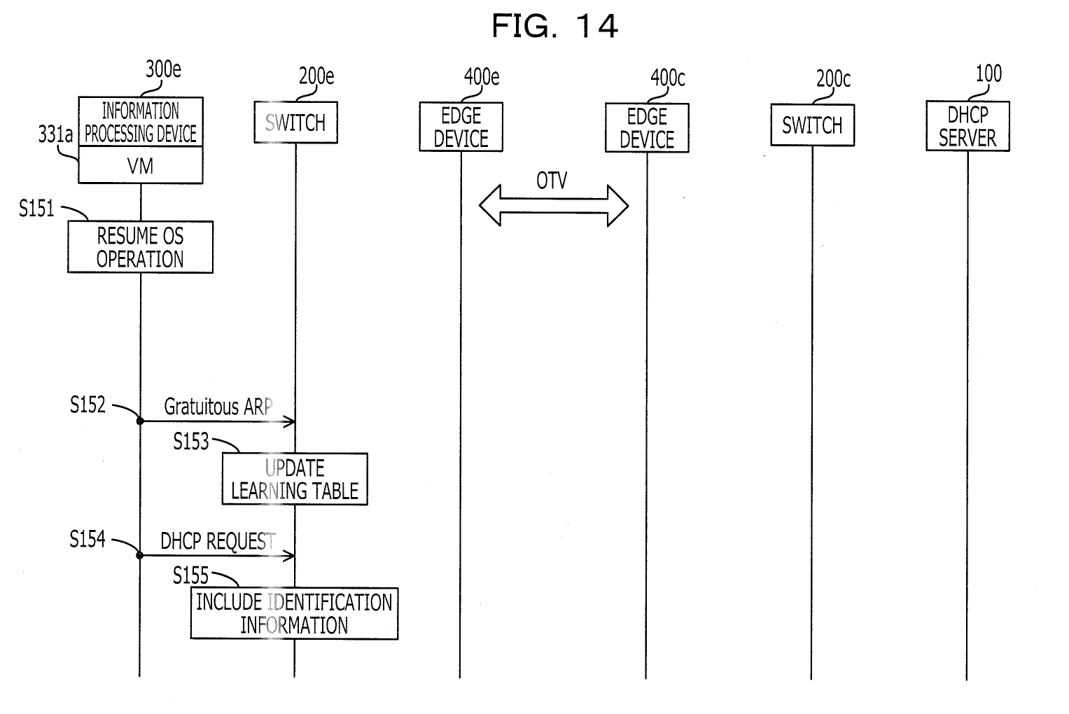

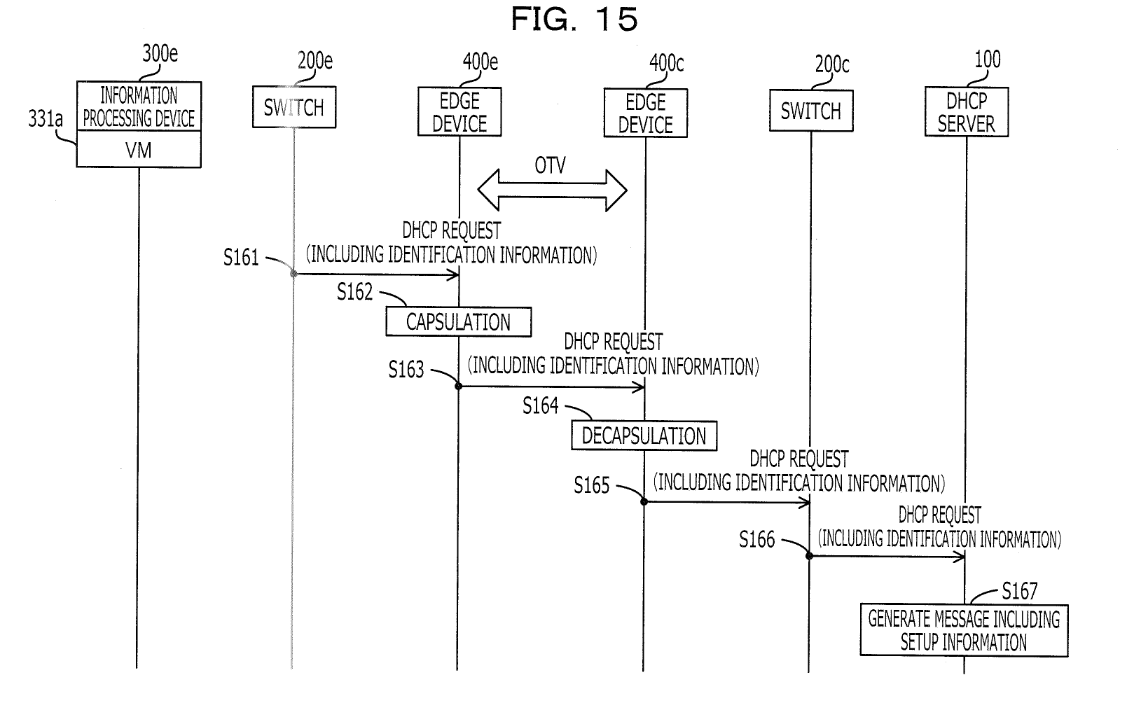

Also, with the communication system according to the second embodiment, after live migration of the VM 331a, as will be described later in FIGS. 14 and 15, the DHCP REQUEST message has been transmitted from the VM 331a based on the expiration date management of DHCP settings. In this case, when relaying the DHCP REQUEST message transmitted from the VM 331a, the switch 200a includes the identification information in the DHCP REQUEST message, and transfers this. Specifically, as indicated in FIG. 5B, the switch 200a sets the option field of the DHCP REQUEST message transmitted from the VM 331a to SiteID as the identification information (e.g., SiteID=3). Also, the location of the VM 331a may be informed to the DHCP server 100 by setting the identification information as the option number whereby private use of the DHCP option may be performed.

With the communication system according to the second embodiment, the identification information is set so as to uniquely determine the base where a host is located. Thus, the DHCP server 100 may recognize which base a host which has transmitted a DHCP DISCOVER message or DHCP REQUEST message is located in, by referencing the identification information included in the received message. Accordingly, the DHCP server 100 may set the optimal default router according to a base, or the like, to the host based on the identification information.

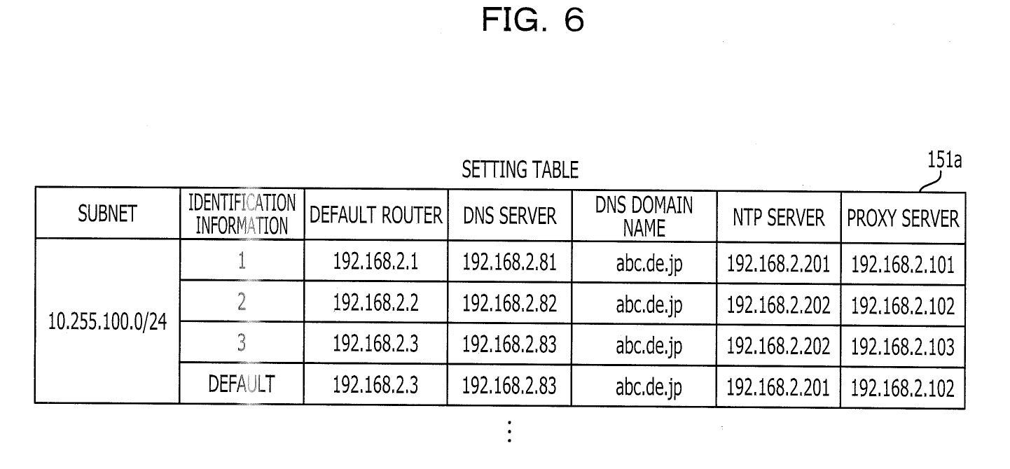

FIG. 6 is a diagram indicating a setting table according to the second embodiment. The setting table 151a indicated in FIG. 6 is stored in a setup information storage 151 which the DHCP server 100 includes. The setting table 151a is a table for storing setup information indicating the settings of DHCP as to a host such as the VM 331a or the like. The setup information is set beforehand by the administrator of the communication system, or the like, based on the subnets with the communication system, and setup content to be set to a host belonging to the subnets thereof. Also, in response to a request from a host (DHCP DISCOVER message, DHCP REQUEST message), the DHCP server 100 transmits a response including the setup information to the host (DHCP OFFER message, DHCP ACK message). The hosts within the communication system perform communication setting based on the setup information that the DHCP OFFER message or DHCP ACK message transmitted from the DHCP server 100 includes.

With the setting table 151a, “SUBNET”, “IDENTIFICATION INFORMATION”, “DEFAULT ROUTER”, “DNS SERVER”, “DNS DOMAIN NAME”, “NTP SERVER”, and “PROXY SERVER” are provided as items. With the setting table 151a, information arrayed in the lateral direction of the items is mutually correlated as setup information.

“SUBNET” indicates the subnet address of a network to which the setup information is applied.

“IDENTIFICATION INFORMATION” indicates identification information corresponding to the location of a host to which the settings that the setup information indicates are applied. Specifically, the setup information indicates settings suitable for a host in the location indicated by the identification information. Here, the location indicated by the identification information has been set based on the bases 80a through 80f to which the switches 200a through 200f belong. Such identification information is not managed by a common DHCP server, and is one feature of the present disclosure.

“DEFAULT ROUTER” indicates the IP address of a router (or edge device, communication device serving as a router such as a gateway or the like) to be set to the host as a default router by the setup information.

“DNS SERVER” indicates the IP address of a server to be set to the host as a DNS server by the setup information.

“DNS DOMAIN NAME” indicates the DNS domain name of the subnet to which the host belongs by the setup information.

“NTP SERVER” indicates the IP address of a server to be set to the host as an NTP server by the setup information.

“PROXY SERVER” indicates the IP address of a server to be set to the host as a proxy server by the setup information.

With the setting table 151a, in the event that setup content suitable for each base of the communication system differs, identification information is set for each base, and different setup information is set for each identification information. For example, even with networks having the same subnet address, in the event that suitable default routers differ, the IP address of a different default router is set based on the location of a host for each piece of identification information.

In the event that no identification information is included in a DHCP DISCOVER message, the DHCP server 100 includes setup information of which the identification information is default in a DHCP OFFER message, and responds. Even in the event that identification information not set in the setting table 151a is included in a DHCP DISCOVER message, the DHCP server 100 similarly includes setup information of which the identification information is default in a DHCP OFFER message, and responds. In the event that no identification information is included in a DHCP REQUEST message to be transmitted at the time of live migration, the DHCP server 100 includes setup information of which the identification information is default in a DHCP ACK message, and responds. Even in the event that identification information not set in the setting table 151a is included in a DHCP REQUEST message at the time of live migration, the DHCP server 100 similarly includes setup information of which the identification information is default in a DHCP ACK message, and responds.

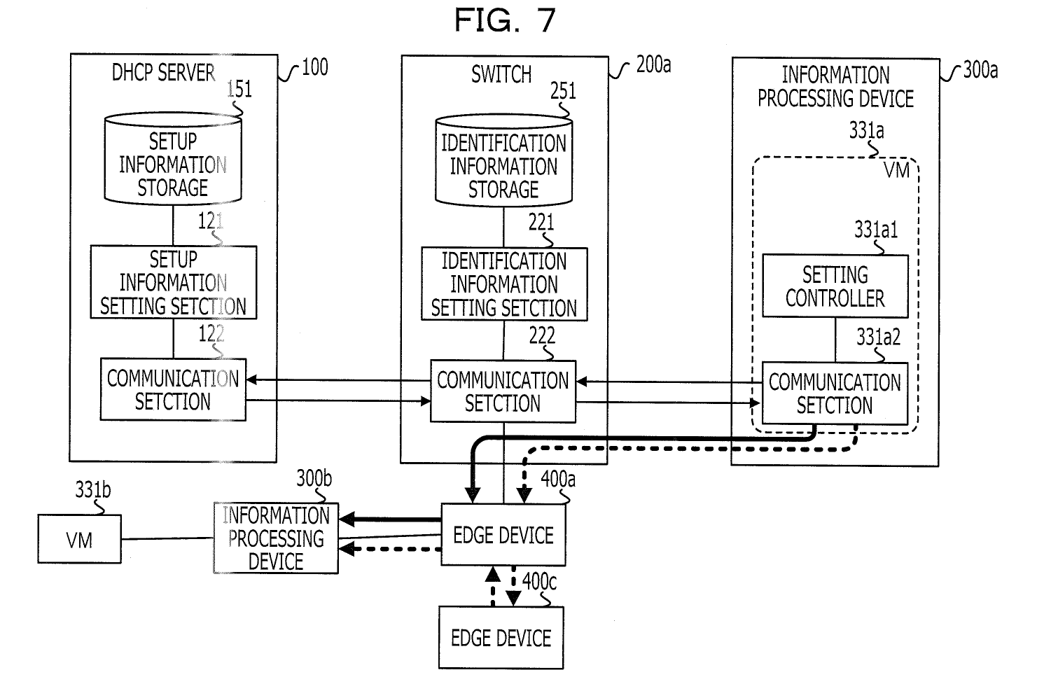

FIG. 7 is a block diagram illustrating the communication system according to the second embodiment. Now, with the second embodiment, though description will be made regarding the time of starting operation and the time of movement occurring due to live migration or the like in the event that the host is a VM, this may also be applied to the time of the physical machine starting operation in the event that the host is a physical machine.

The communication system according to the second embodiment includes the DHCP server 100, switch 200a, information processing devices 300a and 300b, and edge devices 400a and 400b. Here, as described above, the switch 200a, and information processing device 300a belong to the base 80a within the data center 71. Also, the edge device 400a is directly connected to the base 80a. Also, the edge device 400c is disposed in the data center 72 different from the information processing device 300a, and also connected to the edge device 400a by the tunnels 61a and 61b. With the base 80a belonging to the information processing device 300a, the nodes are connected by a physical line, and also between the bases 80c and 80e may be connected by the tunnels 61a and 63a, respectively. Also, the base 80a may be connected to the base 80b via the edge device 400a. Also, the information processing device 300b belongs to the base 80b within the data center 71.

The DHCP server 100 performs communication setting of another device such as the VM 331a or the like by including setup information in a DHCP OFFER message or DHCP ACK message to transmit to the VM 331a. The DHCP server 100 includes a setup information setting section 121, a communication section 122, and a setup information storage 151. The DHCP server 100 serves as a server.

The communication section 122 has received a DHCP DISCOVER message or DHCP REQUEST message including identification information. Here, the DHCP REQUEST message is a DHCP REQUEST message at the time of DHCP Renewing and at the time of DHCP Rebinding. In this case, the setup information setting section 121 causes the communication section 122 to transmit a DHCP OFFER message including the setup information corresponding to identification information, or the like, to the VM 331a. Also, identification information included in a DHCP DISCOVER message or the like does not agree with any of the identification information of setup information. In this case, the setup information setting section 121 causes the communication section 122 to transmit a DHCP OFFER message including setup information indicating settings corresponding to the network to which the DHCP server 100 belongs, or the like, to the VM 331a. The DHCP DISCOVER message and so forth serve as a setup information request. The DHCP OFFER message including setup information, and so forth, serve as a setup information response.

The setup information storage 151 stores setup information indicating the settings corresponding to the network correlated with identification information. The setup information indicates the DHCP settings corresponding to each of the bases 80a through 80f. The setup information includes information indicating a communication device to be set as a default router corresponding to the network. The communication section 122 communicates with another device using a communication line.

The switch 200a includes the identification information setting section 221, communication section 222, and identification information storage 251. The communication section 222 communicates with another device using a communication line. The switch 200a serves as a relay device.

The communication section 222 has received the DHCP DISCOVER message transmitted from the VM 331a, or the like. In this case, the identification information setting section 221 includes identification information in the DHCP DISCOVER message received by the communication section 222, or the like. The identification information setting section 221 then causes the communication section 222 to transmit the DHCP DISCOVER message in which the identification information has been included, or the like to the DHCP server 100. In the event that identification information has already been included in a DHCP DISCOVER message and DHCP REQUEST message by another device at the time of transfer, the identification information setting section 221 does not have to include identification information at the own device. This is because if the identification information of the own device is written over the identification information already included by another device, the location of the VM 331a becomes obscure. Also, this is because there is another device in which identification information is to be included, between the own device and the VM 331a, and if the identification information is additionally included in the event of not being connecting to the VM 331a directly, the identification information of the own device fails to indicate the location of the VM 331a.

The identification information storage 251 stores identification information indicating the base 80a to which the VM 331a of the bases 80a, 80c, and 80e having the same subnet address belongs. The identification information may be information whereby each of the switches 200a through 200f may uniquely be identified.

The VM 331a is a virtual machine which operates over the information processing device 300a which is a physical machine. The VM 331a includes a setting controller 331a1 and a communication section 331a2. The VM 331a serves as an information processing device.

In the event of having obtained setup information included in the DHCP OFFER message or DHCP ACK message transmitted from the DHCP server 100, the setting controller 331a1 performs communication setting based on the obtained setup information. The communication section 331a2 performs communication using a communication line based on the communication settings by the setting controller 331a1.

The VM 331a has received the DHCP OFFER message or the like including setup information transmitted from the DHCP server 100. In this case, the VM 331a performs DHCP setting suitable for the base 80a to which the VM 331a belongs, such as the default router or the like using the setup information included in the DHCP OFFER message including the setup information, or the like.

In the event of performing communication setting in accordance with the DHCP server 100, the VM 331a transmits a DHCP DISCOVER message or the like to the DHCP server 100 via the switch 200a.

Now, the switch 200a has received the DHCP DISCOVER message transmitted from the VM 331a, or the like. In this case, the switch 200a includes identification information indicating the base 80a to which the VM 331a belongs of the bases 80a, 80c, and 80e having the same subnet address in the received DHCP DISCOVER message, or the like. As for the identification information, code set so as to uniquely identify the network to which the VM 331a belongs, such as information uniquely identifying the switch 200a directly connected to the VM 331a without passing through another switch, or the like, is employed. The switch 200a then transmits a DHCP DISCOVER message including identification information, or the like to the DHCP server 100.

The DHCP server 100 has received the DHCP DISCOVER message in which identification information has been included by the switch 200a, or the like. In this case, the DHCP server 100 references setup information indicating the settings of the VM 331a according to the DHCP DISCOVER message from the VM 331a transferred by the switch 200a, or the like. The DHCP server 100 then transmits, based on the referenced setup information, the DHCP OFFER message including the setup information corresponding to the base 80a corresponding to the identification information, or the like to the VM 331a. The setup information may be the IP address of a device (e.g., edge device 400a) to be set as the default router of the host within the communication system, such as the VM 331a or the like, for example. Also, the setup information may be the IP address of a DNS server, NTP server, or PROXY server of the host within the communication system, or DNS domain name. At this time, based on the identification information included in the message from the switch 200a, and the setup information indicating the settings corresponding to the base 80a correlated with the identification information, the DHCP server 100 selects the setup information corresponding to the identification information. The DHCP server 100 then transmits the DHCP OFFER message including the selected setup information or the like, for example. The DHCP OFFER message including setup information, and so forth may be a DHCP OFFER message including the DHCP settings, or a DHCP ACK message at the time of DHCP Renewing and at the time of DHCP Rebinding.

Now, a certain VM (hereafter, transmission source VM) transmits a user packet to a VM (hereafter, transmission destination VM) which operates over an information processing device disposed in another location via the default router. At this time, the transmission source VM may transmit packets with, of the multiple edge devices, one of the edge devices directly connected to the base of the transmission source VM, and the edge device connected thereto via a tunnel as the default router. In this case, which of the multiple edge devices the transmission source VM uses as the default router to transmit packets to the transmission destination VM is a problem. In this way, there may be a case where how to perform communication setting suitable for the network to which the transmission source VM belongs is a problem.

In the event the transmission source VM transmits packets to the transmission destination VM via an edge device connected thereto via a tunnel, processing such as encryption, decoding, label conversion, or the like has to be performed. Thus, occurrence of delay, increase in the load of a device included in the communication system may be caused. On the other hand, in the event of transmitting packets to the transmission destination VM via an edge device connected to a base of the transmission source VM without passing through a tunnel, the above problems are suppressed. In this way, whether or not there is delay, or the load of the communication system, may change depending on which of the edge devices the transmission source VM performs communication with as the default router.

On the other hand, with the second embodiment, the switch 200a disposed in the same base 80a as with the VM 331a includes identification information whereby the base 80a may be determined in the DHCP DISCOVER message from the VM 331a, or the like to transfer to the DHCP server 100. Thus, in the event of having received the DHCP DISCOVER message from the VM 331a, or the like, the DHCP server 100 may determine the base 80a to which the VM 331a belongs from identification information included in the DHCP DISCOVER message, or the like.

In accordance with this, the DHCP server 100 may transmit to the VM 331a by including setup information indicating settings suitable for the base 80a to which the VM 331a belongs in a DHCP OFFER message or the like based on the identification information.

Also, the VM 331a has received the DHCP OFFER message including setup information transmitted from the DHCP server 100, or the like. In this case, the VM 331a may perform communication setting suitable for the base 80a to which the VM 331a belongs using the setup information included in the DCHP OFFER message including setup information, or the like.

Also, as will be described in detail later, in the event that the VM 331a which has operated at the information processing device 300a disposed in the base 80a has moved to the information processing device 300e disposed in the base 80e by live migration, a DHCP REQUEST message is transmitted. In this case, the switch 200e includes identification information for identifying the base 80e in the DHCP REQUEST message from the VM 331a over the information processing device 300e to transfer to the DHCP server 100. The DHCP server 100 transmits a DHCP ACK message including setup information suitable for the base 80e to the VM 331a over the information processing device 300e as a response of the DHCP REQUEST message relayed by the switch 200e. Thus, the VM 331a which has moved to the information processing device 300e after live migration may obtain setup information corresponding to the base 80e, and may perform DHCP setting suitable for the base 80e.

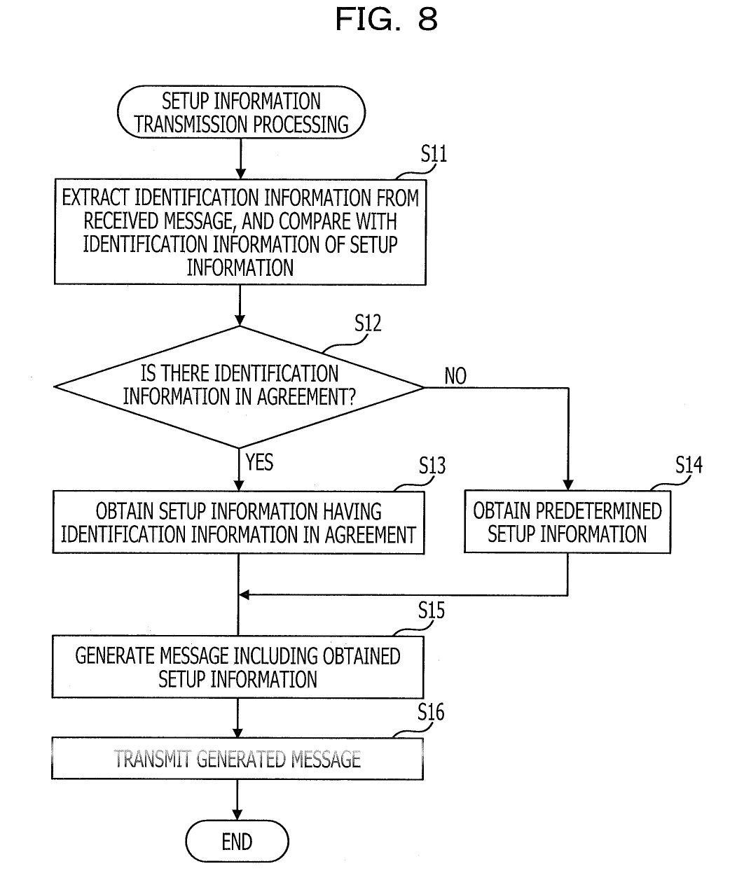

FIG. 8 is a flowchart illustrating setup information transmission processing according to the second embodiment. The setup information transmission processing is executed in the event of having received the DHCP DISCOVER message transmitted from the host such as the VM 331a or the like, in which identification information has been included by a relay device such as the switch 200a or the like, or a DHCP REQUEST message in which identification information has been included. Hereafter, the processing illustrated in FIG. 8 will be described in accordance with step numbers.

[Step S11] The setup information setting section 121 extracts identification information from the received DHCP DISCOVER message, and compares this with the identification information of the setup information stored in the setup information storage 151.

[Step S12] The setup information setting section 121 determines as the comparison result in Step S11 whether or not there is setup information having identification information agreeing with the identification information extracted from the received DHCP DISCOVER message. In the event that there is setup information having identification information agreeing with the extracted identification information (YES in Step S12), the processing proceeds to Step S13. On the other hand, in the event that there is no setup information having identification information agreeing with the extracted identification information, or in the event that there is no identification information included in the received DHCP DISCOVER message (NO in Step S12), the processing proceeds to Step S14.

[Step S13] The setup information setting section 121 obtains the setup information having identification information agreeing with the extracted identification information as the comparison result in Step S11, from the setup information storage 151.

[Step S14] The setup information setting section 121 obtains given setup information (e.g., the setup information with the identification information in FIG. 6 as the default) from the setup information storage 151.

[Step S15] The setup information setting section 121 generates a DHCP OFFER message including the setup information obtained in Step S13 or Step S14.

[Step S16] The communication section 122 transmits the DHCP OFFER message generated in Step S15 to the transmission source host of the DHCP DISCOVER message.

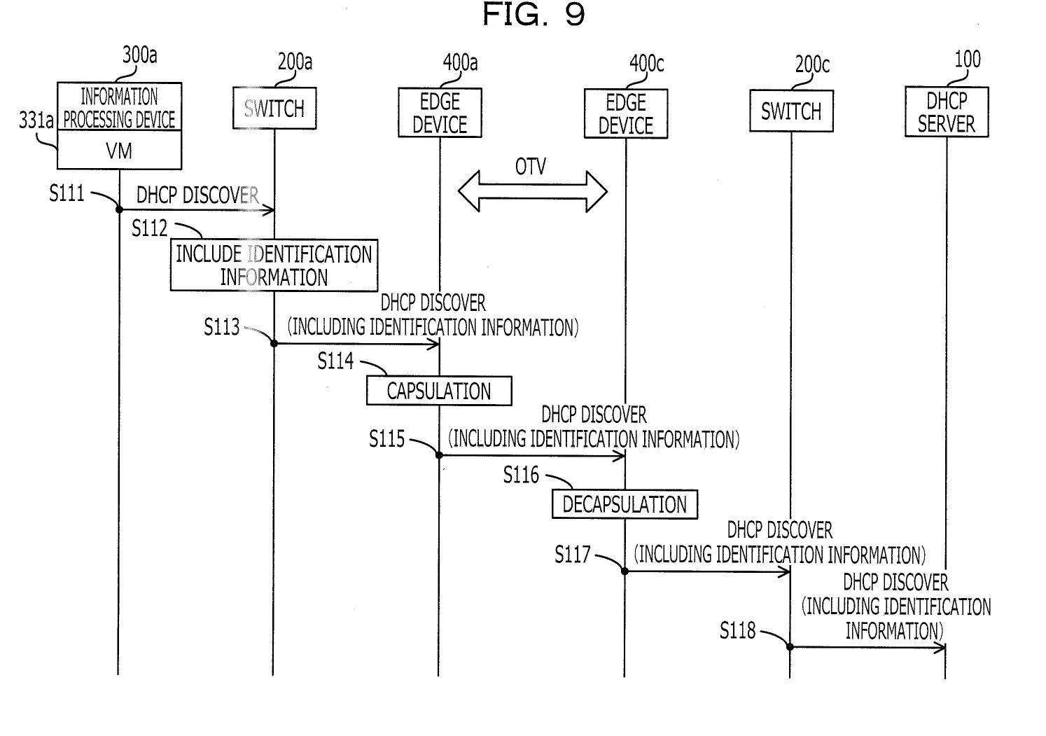

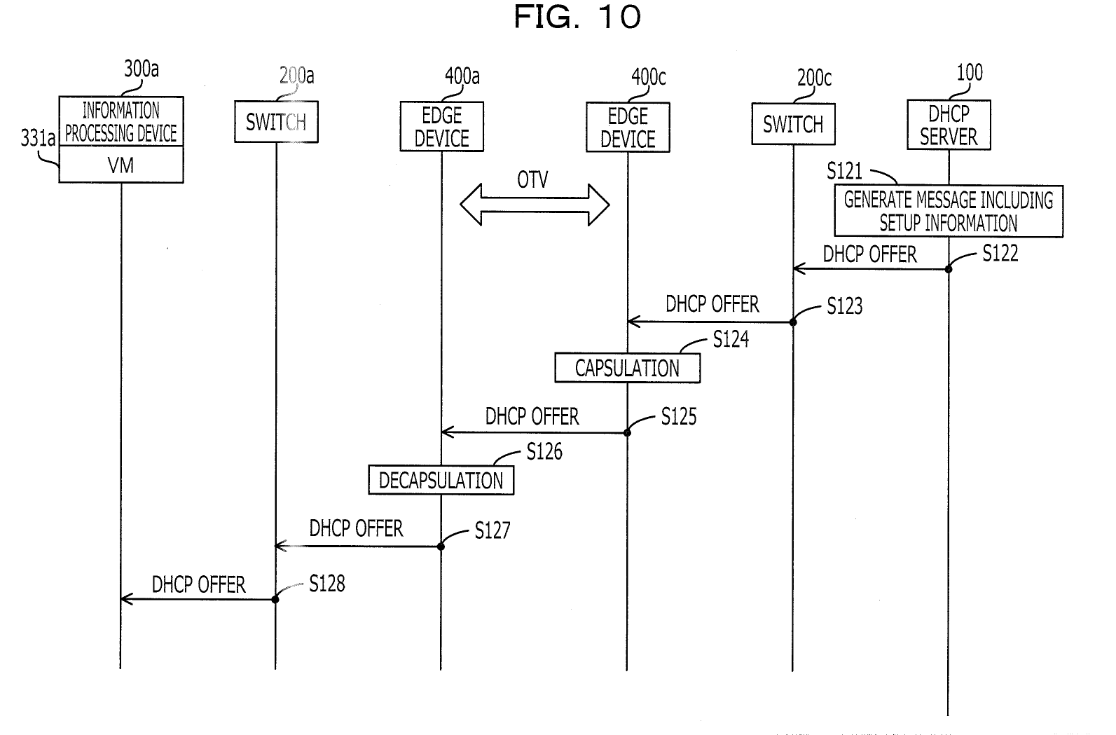

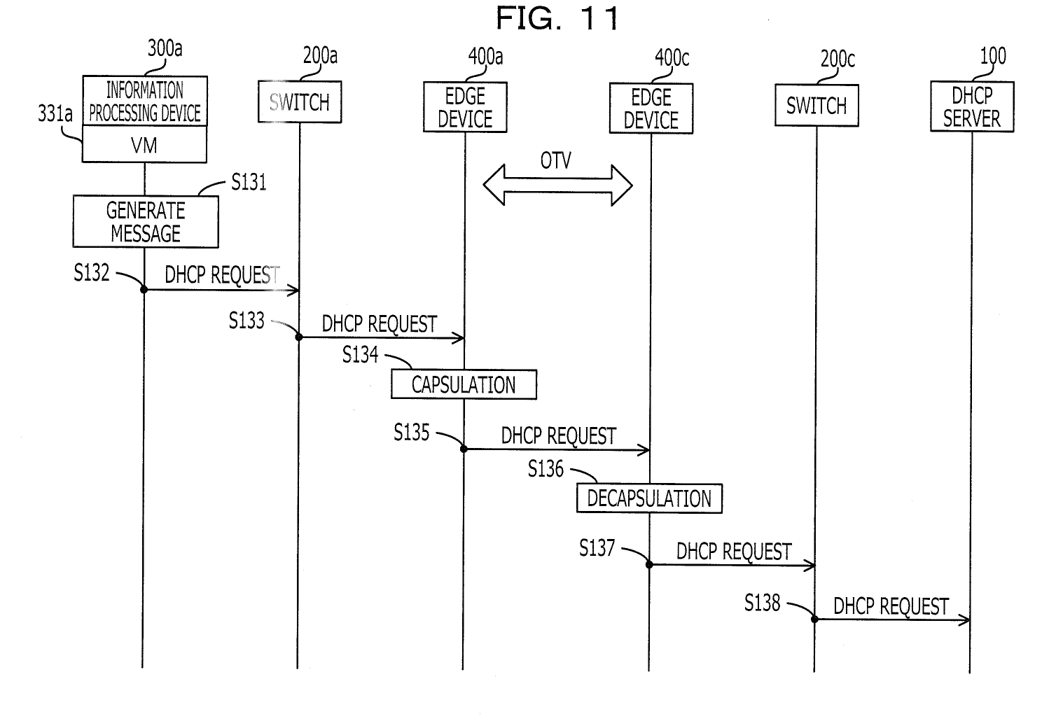

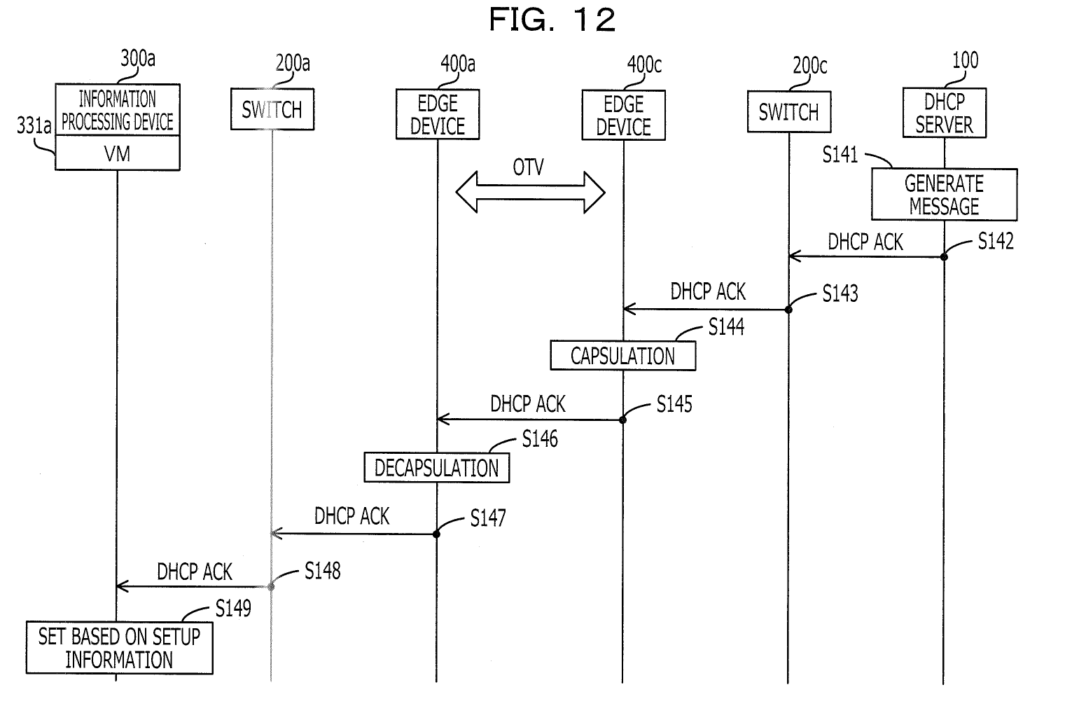

FIGS. 9 through 12 are sequence charts illustrating the operation at the time of activation of a VM in the communication system according to the second embodiment. Now, the VM 331a which is the host and is operating over the information processing device 300a transmits a DHCP DISCOVER message so as to obtain settings according to DHCP at the time of activation of the own device, for example. Also, the DHCP DISCOVER message transmitted from the VM 331a by broadcast arrives at the DHCP server 100 via the switch 200a, edge devices 400a and 400c, and switch 200c. Also, layer 3 packets are transferred between the edge devices 400a and 400c over the Internet 60 by OTV in a capsulated state. Also, with the DHCP server 100, setup information indicating settings such as the default router according to the location of the host, and so forth has already been set to the setup information storage 151 by the administrator of the communication system, or the like.

Hereafter, description will be made regarding the operation procedure of the communication system in the event that a DHCP DISCOVER message has been transmitted from the VM 331a in accordance with FIGS. 9 through 12.

[Step S111] The VM 331a transmits the DHCP DISCOVER message by broadcast.

[Step S112] The switch 200a includes identification information indicating the location of the VM 331a in the DHCP DISCOVER message transmitted from the VM 331a which is the host. Here, the identification information is information for identifying the switch 200a first connected to the VM 331a (information processing device 300a) without passing through another switch.

[Step S113] The switch 200a transfers the DHCP DISCOVER message in which the identification information has been included in Step S112.

[Step S114] In the event of having received the DHCP DISCOVER message (including the identification information) transmitted from the switch 200a in Step S113, the edge device 400a performs EoIP capsulation regarding the received DHCP DISCOVER message.

[Step S115] The edge device 400a transfers the DHCP DISCOVER message capsulated in Step S114 by OW.

[Step S116] The edge device 400c decapsulates the DHCP DISCOVER message capsulated by EoIP and also transferred by OTV.

[Step S117] The edge device 400c transfers the DHCP DISCOVER message capsulated in Step S116.

[Step S118] Upon receiving the DHCP DISCOVER message transmitted from the edge device 400c in Step S117, the switch 200c transfers the received DHCP DISCOVER message.

[Step S121] The DHCP server 100 selects setup information according to the location of the VM 331a based on the identification information included in the received DHCP DISCOVER message transmitted from the switch 200c in Step S118. Also, the DHCP server 100 determines an IP address to be assigned to the VM 331a which has transmitted the DHCP DISCOVER message. The DHCP server 100 generates a DHCP OFFER message including the selected setup information and the proposed IP address for assignment.

[Step S122] The DHCP server 100 transmits the DHCP OFFER message including the setup information selected and IP address for assignment proposed in Step S121 to the VM 331a which is the transmission source of the DHCP DISCOVER message.

[Step S123] Upon receiving the DHCP OFFER message transmitted from the DHCP server 100 in Step S122, the switch 200c transfers the received DHCP OFFER message.

[Step S124] Upon receiving the DHCP OFFER message transmitted from the switch 200c in Step S123, the edge device 400c performs EoIP capsulation regarding the received DHCP OFFER message.

[Step S125] The edge device 400c transfers the DHCP OFFER message capsulated in Step S124 by OTV.

[Step S126] The edge device 400a decapsulates the DHCP OFFER message capsulated by EoIP and also transferred by OTV.

[Step S127] The edge device 400a transfers the DHCP OFFER message capsulated in Step S126.

[Step S128] Upon receiving the DHCP OFFER message transmitted from the edge device 400a in Step S127, the switch 200a transfers the received DHCP OFFER message.

[Step S131] The VM 331a receives the DHCP OFFER message transmitted in Step S128. In the event of performing the settings of the own device based on the setup information and IP address proposed for assignment included in the received DHCP OFFER message, the VM 331a generates a DHCP REQUEST message.

[Step S132] The VM 331a transmits the DHCP REQUEST message generated in Step S131 by broadcast.

[Step S133] Upon receiving the DHCP REQUEST message transmitted from the VM 331a in Step S132, the switch 200a transfers the received DHCP REQUEST message.

[Step S134] Upon receiving the DHCP REQUEST message transmitted from the switch 200a in Step S133, the edge device 400a performs EoIP capsulation regarding the received DHCP REQUEST message.

[Step S135] The edge device 400a transfers the DHCP REQUEST message capsulated in Step S134 by OTV.

[Step S136] The edge device 400c decapsulates the DHCP REQUEST message capsulated by EoIP and also transferred by OTV.

[Step S137] The edge device 400c transfers the DHCP REQUEST message decapsulated in Step S136.

[Step S138] Upon receiving the DHCP REQUEST message transmitted from the edge device 400c in Step S137, the switch 200c transfers the received DHCP REQUEST message.

[Step S141] Upon receiving the DHCP REQUEST message transmitted from the switch 200c in Step S138, the DHCP server 100 assigns the proposed IP address to the VM 331a and also generates a DHCP ACK message.

[Step S142] The DHCP server 100 transmits the DHCP ACK message indicating that the IP address proposed in Step S141 has been assigned, to the VM 331a which is the transmission source of the DHCP REQUEST message.

[Step S143] Upon receiving the DHCP ACK message transmitted from the DHCP server 100 in Step S142, the switch 200c transfers the received DHCP ACK message.

[Step S144] Upon receiving the DHCP ACK message transmitted from the switch 200c in Step S143, the edge device 400c performs EoIP capsulation regarding the received DHCP ACK message.

[Step S145] The edge device 400c transfers the DHCP ACK message capsulated in Step S144 by OTV.

[Step S146] The edge device 400a decapsulates the DHCP ACK message capsulated by EoIP and also transferred by OTV.

[Step S147] The edge device 400a transfers the DHCP ACK message capsulated in Step S146.

[Step S148] Upon receiving the DHCP ACK message transmitted from the edge device 400a in Step S147, the switch 200a transfers the received DHCP ACK message.

[Step S149] Upon receiving the DHCP ACK message transmitted from the switch 200a in Step S148, the VM 331a sets the IP address proposed for assignment from the DHCP server 100 to the IP address of the own device. Also, the VM 331a performs the own communication setting based on the setup information transmitted from the DHCP server 100.

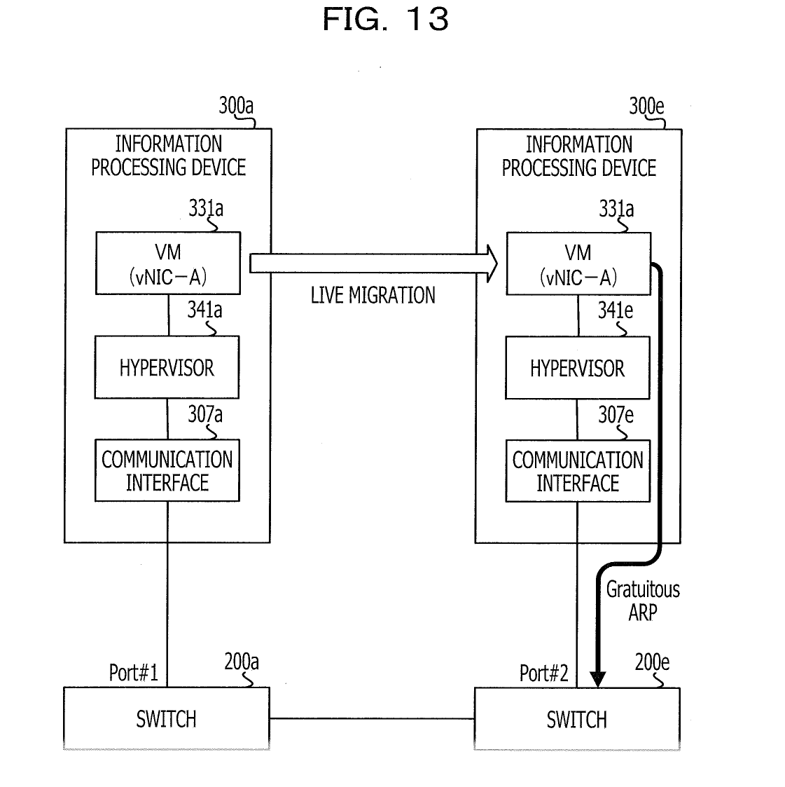

FIG. 13 is a diagram illustrating the live migration of a VM according to the second embodiment. Description will be made regarding live migration wherein the VM 331a which is operating over the information processing device 300a moves over the information processing device 300e in accordance with FIG. 13.

The VM 133a includes a virtual NIC (Network Interface Card), the virtual NIC of the VM 331a is, for example, vNIC-A, the vNIC-A has a given MAC address, and the VM 331a is connected to a communication port of the switch 200a before live migration.

The VM 331a is communicating with another device via the communication port (e.g., Port#1) of the switch 200a before live migration and until the processing of live migration is completed, and the learning table of the switch 200a has learned that the VM 331a (vNIC-A) is connected to the Port#1.

Now, the processing of live migration has been completed, and the VM 331a has resumed operation over the information processing device 300e. At this time, the VM 331a is connected to the switch 200e connected to the information processing device 300e. At this time, the MAC address of the vNIC-A that the VM 331a has is not changed before and after live migration. Also, after live migration, the VM 331a transmits Gratuitous ARP (Address Resolution Protocol) to the switch 200e. Based on this, the switch 200e updates the learning table to reflect that the vNIC-A is connected to the Port#2 of the switch 200e.

FIGS. 14 and 15 are sequence charts illustrating the operation at the time of live migration of a VM in the communication system according to the second embodiment. Now, the VM 331a which has operated over the information processing device 300a moves to the information processing device 300e by live migration. At this time, an OS memory image that is data over the OS of the VM 331a which is operating by the hypervisor of the information processing device 300a, and is data used for operation as the VM 331a is transferred from the information processing device 300a to the information processing device 300e. With the hypervisor of the information processing device 300e, upon receiving the transferred OS memory image, the VM 331a operates using the received OS memory image. In this case, DHCP resetting is performed for expiration date management of DHCP setting in the VM 331a over the information processing device 300e. Here, the VM 331a transmits a DHCP REQUEST message to the DHCP server 100 by broadcast, the DHCP REQUEST message transmitted from the VM 331a arrives at the DHCP server 100 via the edge devices 400e and 400c and switch 200c, and layer 3 packets are transferred in a capsulated state between the edge devices 400e and 400c over the Internet 60 by OTV.

Hereafter, description will be made regarding the operation procedure of the communication system in the event of obtaining DHCP settings again after the VM 331a moves to the information processing device 300e by live migration in accordance with FIGS. 14 and 15.

[Step S151] The information processing device 300e resumes the operation of the VM 331a using the OS memory image transferred from the information processing device 300a.

[Step S152] The VM 331a transmits Gratuitous ARP (Address Resolution Protocol) by broadcast.

[Step S153] Upon receiving the Gratuitous ARP transmitted from the VM 331a in Step S152, the switch 200e performs updating for registering the VM 331a in the learning table.

[Step S154] Upon given time relating to the expiration date of the DHCP settings having elapsed, the VM 331a transmits a DCHP REQUEST message to the DHCP server 100 or by broadcast. Here, in the event that the management of the expiration date of the DHCP settings is based on DHCP Renewing, the VM 331a transmits a DCHP REQUEST message to the DHCP server 100. On the other hand, in the case based on DHCP Rebinding, the VM 331a broadcasts the DHCP REQUEST message as to the DHCP server 100.

Now, with regard to the management of expiration date of the DHCP settings, DHCP Renewing means that in the event that DHCP Renewing Timer (T1) has expired regarding the last obtained DHCP settings, the VM 331a obtains DHCP settings again. Also, DHCP Renewing means that in the event that DHCP Rebinding Timer (T2) has expired regarding the last obtained DHCP settings, the VM 331a obtains DHCP settings again.

[Step S155] The switch 200e includes identification information indicating the location of the VM 331a in the DHCP REQUEST message transmitted from the VM 331a which is the host. Here, the identification information is information for identifying the switch 200e first connected to the VM 331a (information processing device 300e) without passing through another switch.

[Step S161] The switch 200e transfers the DHCP REQUEST message in which the identification information has been included in Step S155.

[Step S162] Upon receiving the DHCP REQUEST message (including the identification information) transmitted from the switch 200e in Step S161, the edge device 400e performs EoIP capsulation regarding the received DHCP REQUEST message.

[Step S163] The edge device 400e transfers the DHCP REQUEST message capsulated in Step S162 by OTV.

[Step S164] The edge device 400c decapsulates the DHCP REQUEST message capsulated by EoIP and also transferred by OTV.

[Step S165] The edge device 400c transfers the DHCP REQUEST message decapsulated in Step S164.

[Step S166] Upon receiving the DHCP REQUEST message transmitted from the edge device 400c in Step S165, the switch 200c transfers the received DHCP REQUEST message.

[Step S167] The DHCP server 100 selects setup information according to the location of the VM 331a based on the identification information included in the DHCP REQUEST message transmitted from the switch 200c in Step S166. Also, the DHCP server 100 determines an IP address to be assigned to the VM 331a which has transmitted the DHCP REQUEST message. The DHCP server 100 generates a DHCP ACK message including the selected setup information and proposed IP address for assignment. With processing thereafter, the DHCP ACK message including the DHCP settings generated by the DHCP server 100 is transmitted to the VM 331a over the information processing device 300e via the communication system. The VM 331a which has received the DHCP ACK message including the DHCP settings sets the IP address proposed for continuity or the IP address proposed for assignment by the DHCP server 100 to the own IP address. Also, the VM 331a performs the own communication setting based on the setup information transmitted from the DHCP server 100.

Thus, with the VM 331a, the DHCP settings are updated by a DHCP REQUEST message being transmitted based on the management of DHCP Renewing or DHCP Rebinding of the expiration date of the DHCP settings after live migration. Thus, the DHCP settings are updated according to the location of the VM 331a after live migration.

Note that, the VM 331a according to the second embodiment performs updating of the DHCP settings using the DHCP REQUEST message based on the expiration date of DHCP after live migration. However, the present disclosure is not restricted to this, and an arrangement may be made wherein the VM 331a releases the DHCP settings by transmitting a DHCP RELEASE message to the DHCP server 100, and requests the DHCP settings according to the location of the VM 331a by transmitting a DHCP DISCOVER message to the DHCP server 100 again.

Also, with the second embodiment, description has been made regarding the operation of DHCP setting suitable for the location of a movement destination in the event that live migration has been performed with the VM 331a. However, the present disclosure is not restricted to this, the communication system according to the second embodiment may be applied to other movements of an information processing device where the VM 331a operates, such as quick migration, fail over, and so forth.

Also, with the second embodiment, though the VM 331a and DHCP server 100 belong to a different base, the present disclosure is not restricted to this, these may belong to the same base. Also, the DHCP server 100 may belong to a network different from the bases.

With the communication system according to the second embodiment as described above, the switches 200a and 200e which have received the DHCP DISCOVER message or the like from the VM 331a transfer this message by including identification information indicting the network to which the VM 331a belongs in this message at the time of relay. Thus, the DHCP server 100 may determine the network to which the VM 331a belongs.

Also, the DHCP server 100 which has received the DHCP DISCOVER message including identification information, or the like transmits a DHCP OFFER message including setup information indicating communication settings according to the network to which the VM 331a belongs, or the like to the VM 331a based on the identification information. The VM 331a which has received the DHCP OFFER message transmitted from the DHCP server 100, or the like performs communication setting based on the setup information. Therefore, setting of the default router may be performed according to the location of the VM 331a (or information processing device 300a where the VM runs). Accordingly, waste of communication resources, and communication delay accompanied with occurrence of the above communication folding back may be suppressed.

Also, with the bases 80a through 80f, the internal nodes are connected by a LAN. Also, the bases 80a through 80f may be connected to the bases of the other data centers using the tunnels 61a through 63a, 61b through 63b by OTV. The setup information indicates the DHCP settings suitable for each of the bases 80a through 80f, whereby DHCP setting suitable for the VM 331a may be performed even if the VM 331a belongs to any of the bases 80a through 80f at the time of activation or due to movement.

Also, setting according to the location of the VM 331a may be performed at the time of activation of the VM 331a, and at the time of movement of a virtual machine due to live migration or the like.

### Third Embodiment

Next, a third embodiment will be described. Description will be made with difference as to the second embodiment as the center, and description will be omitted regarding the same matters as with the second embodiment. The communication system according to the third embodiment differs from the second embodiment in that an edge device includes identification information in the DHCP DISCOVER message transmitted from a VM which is the host.

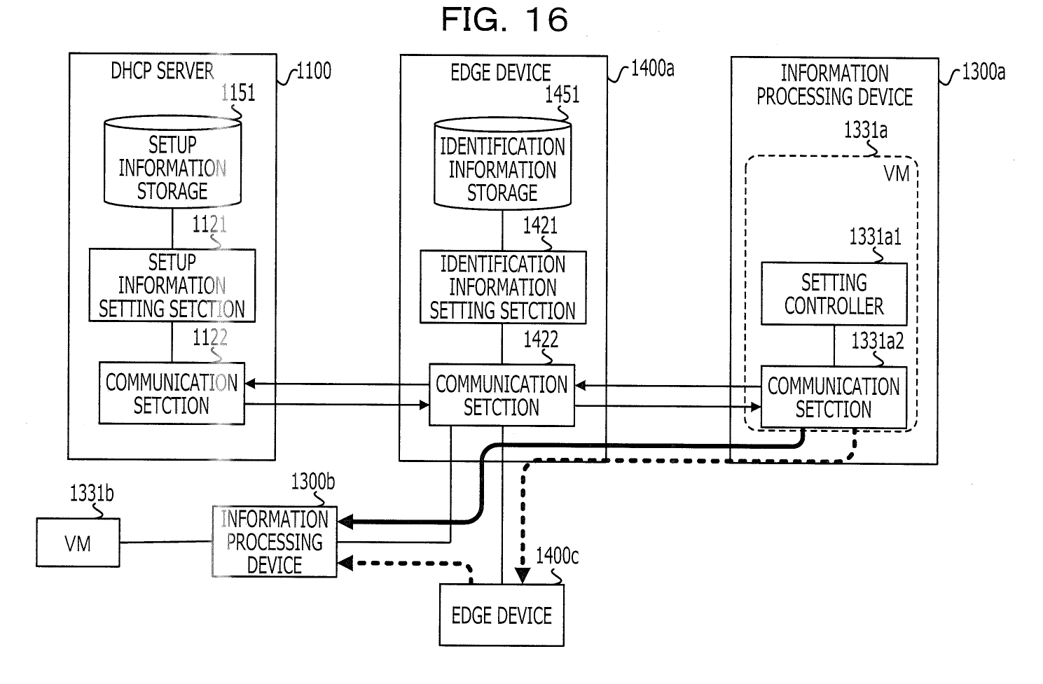

FIG. 16 is a block diagram illustrating the communication system according to the third embodiment. Now, with the third embodiment, though description will be made regarding the time of starting operation and the time of movement occurring due to live migration or the like in the event that the host is a VM, this may also be applied to the time of the physical machine starting operation in the event that the host is a physical machine.

The communication system according to the third embodiment includes a DHCP server 1100, information processing devices 1300a and 1300b, and edge devices 1400a and 1400c. Here, the information processing device 1300a belongs to the base 80a within the data center 71 in the same way as with the information processing device 300a according to the second embodiment, the edge device 1400a is directly connected to the base 80a in the same way as with the edge device 400a according to the second embodiment. Also, the edge device 1400c is disposed in the data center 72 different from the information processing device 1300a in the same way as with the edge device 400a according to the second embodiment, and also connected to the edge device 1400a by the tunnels 61a and 61b. Also, the base 80a may be connected to the base 80b via the edge device 1400a. Also, the information processing device 1300b belongs to the base 80b within the data center 71 in the same way as with the information processing device 300b according to the second embodiment.

The DHCP server 1100 performs communication setting of another device such as the VM 1331a or the like by including setup information in a DHCP OFFER message or DHCP ACK message to transmit this to the VM 1331a. The DHCP server 1100 includes a setup information setting section 1121, a communication section 1122, and a setup information storage 1151. The DHCP server 1100 serves as a server.

The setup information storage 1151 stores setup information indicating the settings corresponding to the network correlated with identification information. The setup information indicates the DHCP settings corresponding to each of the bases 80a through 80f. The setup information includes information indicting a communication device to be set as a default router corresponding to the network. The communication section 1122 communicates with another device using a communication line.

The communication section 1122 has received a DHCP DISCOVER message or DHCP REQUEST message including identification information, and the DHCP REQUEST message is a DHCP REQUEST message at the time of DHCP Renewing and at the time of DHCP Rebinding. In this case, the setup information setting section 1121 causes the communication section 1122 to transmit a DHCP OFFER message including setup information corresponding to the identification information, or the like to the VM 1331a. Also, identification information included in a DHCP DISCOVER message or the like does not agree with any of the identification information of setup information. In this case, the setup information setting section 1121 causes the communication section 1122 to transmit a DHCP OFFER message including setup information indicating settings corresponding to the network to which the DHCP server 1100 belongs, or the like, to the VM 1331a. The DHCP DISCOVER message and so forth serve as a setup information request. The DHCP OFFER message including setup information, and so forth, serve as a setup information response.

In the event that identification information is not included in the received DHCP DISCOVER message or the like, the setup information setting section 1121 selects setup information indicating settings corresponding to the base to which the DHCP server 1100 belongs. The setup information setting section 1121 transmits a DHCP OFFER message including the selected setup information, or the like to the VM 1331a. In the event that identification information is not included in the DHCP DISCOVER message, this means that the DHCP DISCOVER message or the like from the VM 1331a has arrived at the DHCP server 1100 without pasting through any of the edge devices. Therefore, the setup information setting section 1121 may determine that there is no edge device between the VM 1331a and the DHCP server 1100. Accordingly, a DHCP OFFER message including setup information indicating settings suitable for the network to which the DHCP server 1100 belongs, or the like is transmitted from the DHCP server 1100 to the VM 1331a, whereby DHCP setting suitable for the VM 1331a belonging to the same base as with the DHCP server 1100 may be performed.

The edge device 1400a includes an identification information setting section 1421, a communication section 1422, and an identification information storage 1451. The communication section 1422 communicates with another device using a communication line. Also, the communication section 1422 has a function for setting a tunnel (e.g., tunnels 61a and 61b) which virtually connects to another edge device such as the edge device 1400c or the like over the Internet 60. The edge device 1400a serves as a relay device.

The communication section 1422 has received the DHCP DISCOVER message transmitted from the VM 1331a, or the like. In this case, the identification information setting section 1421 includes identification information in the DHCP DISCOVER message received by the communication section 1422. The identification information setting section 1421 causes the communication section 1422 to transmit the DHCP DISCOVER message in which identification information has been included, or the like to the DHCP server 1100 within the same network or between different networks.

The identification information storage 1451 stores identification information indicting the base 80a to which the VM 1331a of the bases 80a, 80c, and 80e having the same subnet address belongs. The identification information may be information whereby each of the edge devices 1400a and 1400c and other edge devices within the communication system may uniquely be identified.

Also, with the communication system according to the third embodiment, all of the devices which connect networks including the edge device 1400c, an edge device not illustrated, a router, and a L3 switch may include identification information in a DHCP DISCOVER message or the like to transfer to the DHCP server 1100, in the same way as with the edge device 1400a.

The VM 1331a is a virtual machine which operates over the information processing device 1300a which is a physical machine. The VM 1331a includes a setting controller 1331a1 and a communication section 1331a2. The VM 1331a serves as an information processing device.

In the event of having obtained setup information included in the DHCP OFFER message or DHCP ACK message transmitted from the DHCP server 1100, the setting controller 1331a1 performs communication setting based on the obtained setup information. The communication section 1331a2 performs communication using a communication line based on the communication settings by the setting controller 1331a1.

The VM 1331a has received the DHCP OFFER message including setup information transmitted from the DHCP server 1100 or the like. In this case, the VM 1331a performs DHCP setting suitable for the base 80a to which the VM 1331a belongs, such as the default router or the like using the setup information included in the DHCP OFFER message including the setup information, or the like.

In the event of performing communication setting in accordance with the DHCP server 1100, the VM 1331a transmits a DHCP DISCOVER message or the like to the DHCP server 1100 via the edge device 1400a.

Now, the edge device 1400a has received the DHCP DISCOVER message transmitted from the VM 1331a, or the like. In this case, the edge device 1400a includes identification information indicating the base 80a to which the VM 1331a belongs of the bases 80a, 80c, and 80e having the same subnet address in the received DHCP DISCOVER message, or the like. As for the identification information, code set so as to uniquely determine the network to which the VM 1331a belongs, such as information whereby the edge device 1400a directly connected to the VM 1331a without passing through another edge device, or the like, is employed. The edge device 1400a then transmits a DHCP DISCOVER message including identification information, or the like to the DHCP server 1100.

The DHCP server 1100 has received the DHCP DISCOVER message in which identification information has been included by the edge device 1400a, or the like. In this case, the DHCP server 1100 references setup information indicating the settings of the VM 1331a according to the DHCP DISCOVER message from the VM 1331a transferred by the edge device 1400a, or the like. The DHCP server 1100 then transmits, based on the referenced setup information, the DHCP OFFER message including the setup information corresponding to the base 80a corresponding to the identification information, or the like to the VM 1331a. The setup information may be the IP address of a device (e.g., edge device 1400a) to be set as the default router of the host within the communication system, such as the VM 1331a or the like. Also, the setup information may be the IP address of a DNS server, NTP server, or PROXY server of the host within the communication system, or DNS domain name. At this time, based on the identification information included in the message from the edge device 1400a, and the setup information indicating the settings corresponding to the base 80a correlated with the identification information, the DHCP server 1100 selects the setup information corresponding to the identification information. The DHCP server 1100 then transmits the DHCP OFFER message including the selected setup information, or the like. The DHCP OFFER message including setup information, and so forth may be a DHCP OFFER message including the DHCP settings, or a DHCP ACK message at the time of DHCP Renewing and at the time of DHCP Rebinding.

With the third embodiment, the edge device 1400a which is disposed in the same base 80a as with the VM 1331a includes identification information whereby the base 80a may be identified in the DHCP DISCOVER message from the VM 1331a, or the like to transfer to the DHCP server 1100. Thus, upon receiving the DHCP DISCOVER message from the VM 1331a, or the like, the DHCP server 1100 may identify the base 80a to which the VM 1331a belongs from the identification information included in the DHCP DISCOVER message or the like.

In accordance with this, the DHCP sever 1100 may include setup information indicating settings suitable for the base 80a to which the VM 1331a belongs in a DHCP OFFER message or the like based on the identification information to transmit this to the VN 1331a.

Also, the VM 1331a has received the DHCP OFFER message including setup information transmitted from the DHCP server 1100, or the like. In this case, the VM 1331a may perform communication setting suitable for the base 80a to which the VM 1331a belongs using the setup information included in the DCHP OFFER message including setup information, or the like.

Also, as will be described later in detail, in the event that the VM 1331a which has operated at the information processing device 1300a disposed in the base 80a has moved to the information processing device 1300e disposed in the base 80e by live migration, a DHCP REQUEST message is transmitted. In this case, the edge device 1400e includes identification information for identifying the base 80e in the DHCP REQUEST message from the VM 1331a over the information processing device 1300e to transfer to the DHCP server 1100. The DHCP server 1100 transmits a DHCP ACK message including setup information suitable for the base 80e to the VM 1331a over the information processing device 1300e as a response of the DHCP REQUEST message relayed by the edge device 1400e. Thus, the VM 1331a which has moved to the information processing device 1300e after live migration may obtain setup information corresponding to the base 80e, and may perform DHCP setting suitable for the base 80e.

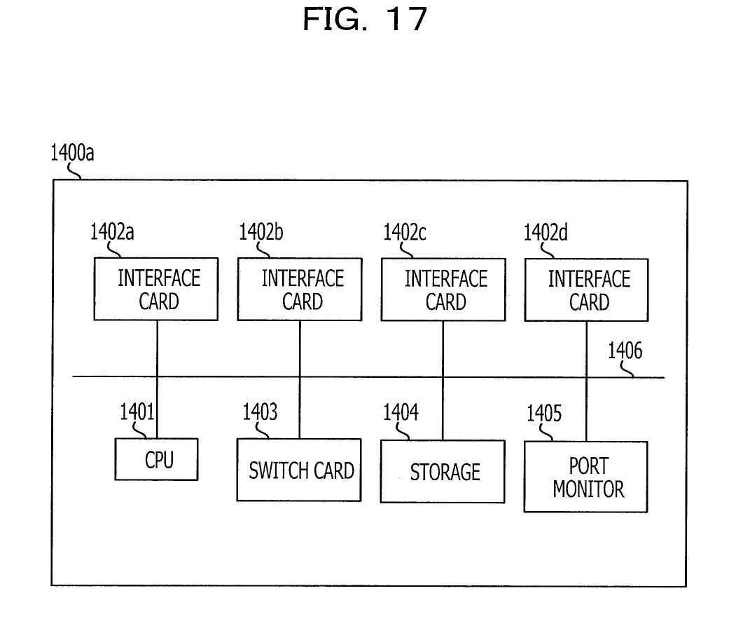

FIG. 17 is a diagram illustrating the edge device according to the third embodiment. Though FIG. 17 is the internal configuration of the edge device 1400a, another edge device included in the third embodiment such as the edge device 1400c or the like may be realized with the same configuration. The edge device 1400a relays packets in the layer 3. The edge device 1400a includes a CPU 1401, interface cards 1402a, 1402b, 1402c, and 1402d, a switch card 1403, a storage 1404, a port monitor 1405, and a bus 1406.

The CPU 1401 controls the entire edge device 1400a.

The storage 1404 is configured of nonvolatile memory, and stores multiple tables and data used for control of communication. Also, the storage 1404 stores identification information indicating the location of a host such as the VMs 1331a or the like. In the event of having received the DHCP DISCOVER message or DHCP REQUEST message from a host such as the VMs 1331a or the like, the edge device 1400a includes the identification information in the received DHCP DISCOVER message or the like to transfer to the DHCP server 1100.

The bus 1406 is connected with the CPU 1401, interface cards 1402a, 1402b, 1402c, and 1402d, switch card 1403, storage 1404, and port monitor 1405.

The interface cards 1402a, 1402b, 1402c, and 1402d each include multiple (e.g., eight) communication ports. The interface cards 1402a, 1402b, 1402c, and 1402d obtain packets by monitoring the respective corresponding communication ports. The interface cards 1402a, 1402b, 1402c, and 1402d transmit the obtained packets to the switch card 1403.

The switch card 1403 includes a learning table (not illustrated). The switch card 1403 stores the transmission source address of a past received packet, and the communication port to which the packet thereof has come, in the learning table in a correlated manner. The learning table is updated by the switch card 1403 whenever occasion occurs.

In the event of having received a packet from one of the interface cards 1402a, 1402b, 1402c, and 1402d, the switch card 1403 references the learning table, and determines the transfer destination of the packet thereof. The switch card 1403 then transmits the packet to the determined interface card 1402a, 1402b, 1402c, or 1402d.

The interface card 1402a, 1402b, 1402c, or 1402d which has received the packet transmits the received packet to the transmission destination from the determined communication port.

The port monitor 1405 monitors the communication ports of the interface cards 1402a, 1402b, 1402c, and 1402d. In the event of having detected failure or restoration of a physical link connected to the communication ports of the interface card 1402a, 1402b, 1402c, and 1402d, the port monitor 1405 informs that effect to the CPU 1401.

Also, the VM 1331a which is the host is disposed in the subnet of the data center where there is the user A, and the DHCP server 1100 is disposed in a network having a different network address such as the subnet of the user B in the data center physically distant from the VM 1331a. In this case, a DHCP DISCOVER message has been transmitted from the VM 1331a to the DHCP server 1100, and DHCP relay has been performed from the subnet of the user A to the subnet of the user B by the edge device 1400a. At this time, when relaying the DHCP DISCOVER message, the edge device 1400a includes identification information in the DHCP DISCOVER message transmitted from the host to transfer to the DHCP server 1100.

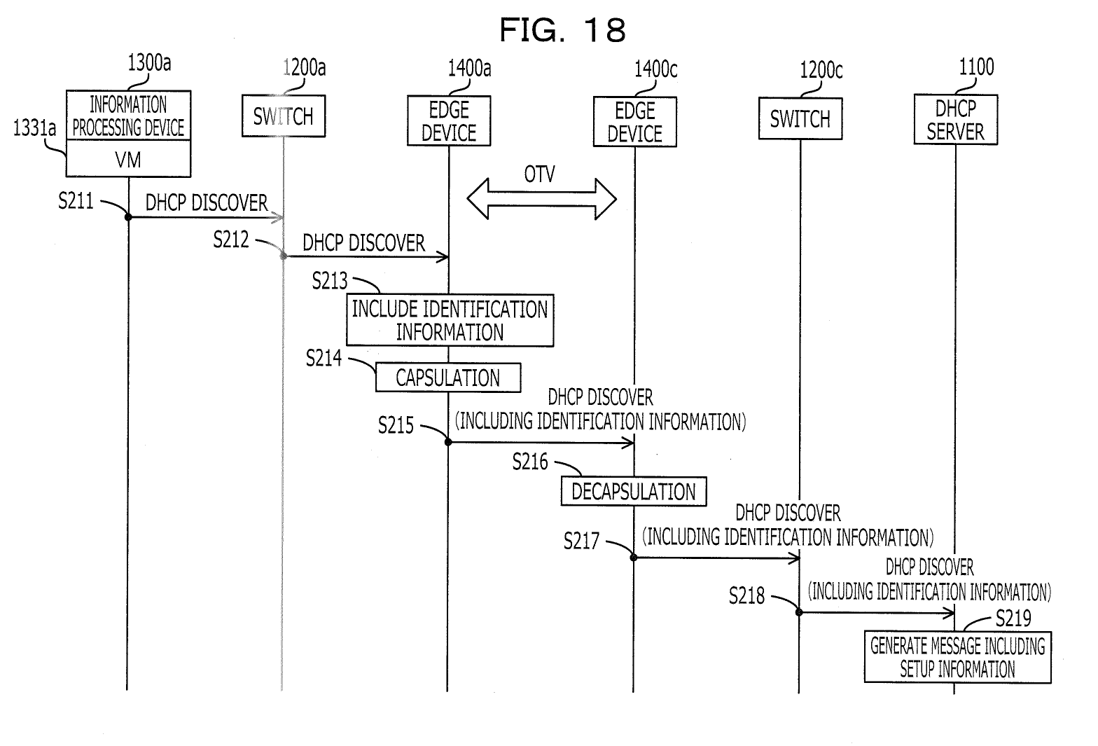

FIG. 18 is a sequence chart illustrating the operation at the time of activation of a VM in the communication system according to the third embodiment. Now, the VM 1331a which is the host and is operating over that information processing device 1300a transmits a DHCP DISCOVER message so as to re-obtain settings according to DHCP at the time of activation of the own device, for example. Also, the DHCP DISCOVER message transmitted from the VM 1331a by broadcast arrives at the DHCP server 1100 via the switch 1200a, edge devices 1400a and 1400c, and switch 1200c. Also, layer 3 packets are transferred between the edge devices 1400a and 1400c over the Internet 60 by OTV in a capsulated state. Also, with the DHCP server 1100, setup information indicating settings such as the default router according to the location of the host, and so forth has already been set to the setup information storage 1151 by the administrator of the communication system, or the like.

Hereafter, description will be made regarding the operation procedure of the communication system in the event that a DHCP DISCOVER message has been transmitted from the VM 1331a in accordance with FIG. 18.

[Step S211] The VM 1331a transmits the DHCP DISCOVER message by broadcast.

[Step S212] The switch 1200a transfers the DHCP DISCOVER message transmitted from the VM 1331a in Step S211.

[Step S213] The edge device 1400a includes identification information indicating the location of the VM 1331a in the DHCP DISCOVER message from the VM 1331a transferred by the switch 1200a. Here, the identification information is information for identifying the edge device 1400a first connected to the VM 1331a (information processing device 1300a) which is the host without passing through another edge device.

[Step S214] The edge device 1400a performs EoIP capsulation as to the DHCP DISCOVER message in which identification information has been included in Step S213.

[Step S215] The edge device 1400a transfers the DHCP DISCOVER message (including identification information) capsulated in Step S214 by OTV.

[Step S216] The edge device 1400c decapsulates the DHCP DISCOVER message capsulated by EoIP and also transferred by OTV.

[Step S217] The edge device 1400c transfers the DHCP DISCOVER message capsulated in Step S216.

[Step S218] Upon receiving the DHCP DISCOVER message transmitted from the edge device 1400c in Step S217, the switch 1200c transfers the received DHCP DISCOVER message.

[Step S219] The DHCP server 1100 selects setup information according to the location of the VM 1331a based on the identification information included in the DHCP DISCOVER message transmitted from the switch 1200c in Step S218. Also, the DHCP server 1100 determines an IP address to be assigned to the VM 1331a which has transmitted the DHCP DISCOVER message. The DHCP server 1100 generates a DHCP OFFER message including the selected setup information and the proposed IP address for assignment. Processing thereafter is the same as with the communication system according to the second embodiment, and description thereof will be omitted.

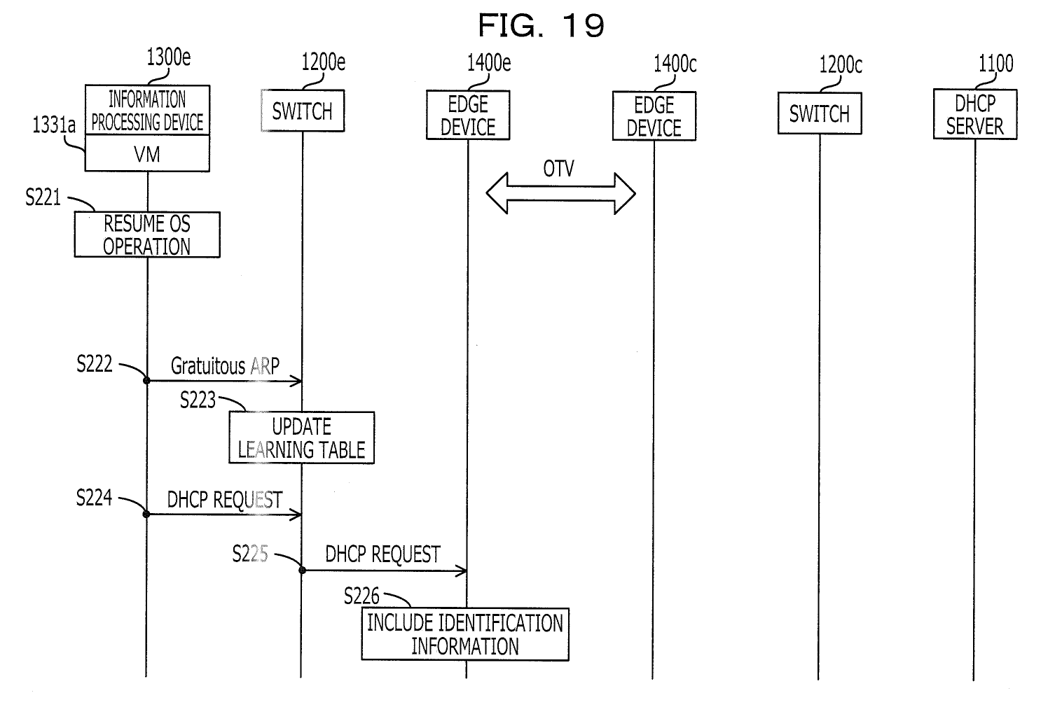

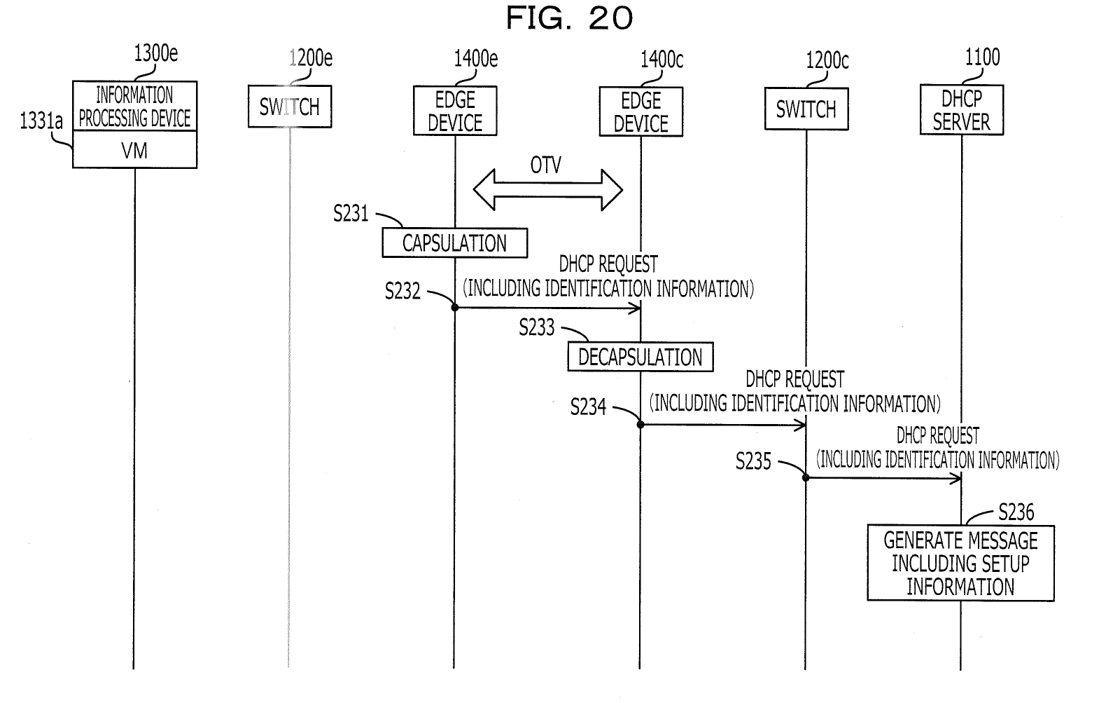

FIGS. 19 and 20 are sequence charts illustrating the operation at the time of live migration of a VM in the communication system according to the third embodiment. Now, the VM 1331a which has operated over the information processing device 1300a moves to the information processing device 1300e by live migration, and further, DHCP resetting is performed for the expiration date management of the DHCP settings at the VM 1331a over the information processing device 1300e. At this time, the VM 1331a transmits a DHCP REQUEST message to the DHCP server 1100 or by broadcast, and the DHCP REQUEST message transmitted from the VM 1331a arrives at the DHCP server 1100 via the switch 1200e, and edge devices 1400e and 1400c, and switch 1200c. Also, the layer 3 packets are transferred between the edge devices 1400e and 1400c over the Internet 60 by OTV in a capsulated state.

Hereafter, description will be made regarding the operation procedure of the communication system in the event of obtaining DHCP settings again after the VM 1331a moves to the information processing device 1300e by live migration in accordance with FIGS. 19 and 20.

[Step S221] The information processing device 1300e resumes the operation of the VM 1331a using the OS memory image transferred from the information processing device 1300a.

[Step S222] The VM 1331a transmits Gratuitous ARP (Address Resolution Protocol) by broadcast.

[Step S223] Upon receiving the Gratuitous ARP transmitted from the VM 1331a in Step S222, the switch 1200e performs updating for registering the VM 1331a in the learning table.

[Step S224] Upon given time relating to the expiration date of the DHCP settings having elapsed, the VM 1331a transmits a DCHP REQUEST message to the DHCP server 1100 or by broadcast. Here, in the event that the management of the expiration date of the DHCP settings is based on DHCP Renewing, the VM 1331a transmits a DCHP REQUEST message to the DHCP server 1100. On the other hand, in the case based on DHCP Rebinding, the VM 1331a broadcasts the DHCP REQUEST message as to the DHCP server 1100.

[Step S225] The switch 1200e transfers the DHCP REQUEST message transmitted from the VM 1331a in Step S224.

[Step S226] The edge device 1400e includes identification information indicating the location of the VM 1331a in the DHCP REQUEST message from the VM 1331a transferred by the switch 1200e.

[Step S231] The edge device 1400e performs EoIP capsulation as to the DHCP REQUEST message in which identification information has been included in Step S226.

[Step S232] The edge device 1400e transfers the DHCP REQUEST message (including identification information) capsulated in Step S231 by OTV.

[Step S233] The edge device 1400c decapsulates the DHCP REQUEST message capsulated by EoIP and also transferred by OTV.

[Step S234] The edge device 1400c transfers the DHCP REQUEST message capsulated in Step S233.

[Step S235] Upon receiving the DHCP REQUEST message transmitted from the edge device 1400c in Step S234, the switch 1200c transfers the received DHCP REQUEST message.

[Step S236] The DHCP server 1100 selects setup information according to the location of the VM 1331a based on the identification information included in the DHCP REQUEST message transmitted from the switch 1200c in Step S235. Also, the DHCP server 1100 determines an IP address to be assigned to the VM 1331a which has transmitted the DHCP REQUEST message. The DHCP server 1100 generates a DHCP ACK message including the selected setup information and proposed IP address for assignment. With processing thereafter, the DHCP ACK message including the DHCP settings generated by the DHCP server 1100 is transmitted to the VM 1331a which operates over the information processing device 1300e via the communication system. The VM 1331a which has received the DHCP ACK message including the DHCP settings sets the IP address proposed for continuity or the IP address proposed for assignment by the DHCP server to the own IP address. Also, the VM 1331a performs the own communication setting based on the setup information transmitted from the DHCP server 1100.

Thus, with the VM 1331a, the DHCP settings are updated by a DHCP REQUEST message being transmitted based on the management of DHCP Renewing or DHCP Rebinding of the expiration date of the DHCP settings after live migration. Thus, the DHCP settings are updated according to the location of the VM 1331a after live migration.

Note that, the VM 1331a according to the third embodiment performs updating of the DHCP settings using the DHCP REQUEST message based on the expiration date management of DHCP after live migration. However, the present disclosure is not restricted to this, and an arrangement may be made wherein the VM 1331a releases the DHCP settings by transmitting a DHCP RELEASE message to the DHCP server 1100, and requests the DHCP settings according to the location of the VM 1331a by transmitting a DHCP DISCOVER message to the DHCP server 1100 again.

Also, with the third embodiment, description has been made regarding the operation of DHCP setting suitable for the location of a movement destination in the event that live migration has been performed with the VM 1331a. However, the present disclosure is not restricted to this, and the communication system according to the third embodiment may be applied to other movements of an information processing device where the VM 1331a operates, such as quick migration, fail over, and so forth.

Also, with the third embodiment, though the VM 1331a and DHCP server 1100 belong to a different base, the present disclosure is not restricted to this, these may belong to the same base. Also, the DHCP server 1100 may belong to a network different from the bases.

The communication system according to the third embodiment as described above has, in addition to the same advantages as with the second embodiment, the following advantages. In the event that identification information is not included in a DHCP DISCOVER message or the like, the DHCP server 1100 selects setup information indicating settings corresponding to the base to which the DHCP server 1100 belongs. The DHCP sever 1100 transmits a DHCP OFFER message including the selected setup information, or the like to the VM 1331a. In the event that identification information is not included in the DHCP DISCOVER message or the like, this means that the DHCP DISCOVER message or the like from the VM 1331a has arrived at the DHCP server 1100 without pasting through any of the edge devices. Therefore, the DHCP server 1100 may determine that there is no edge device between the VM 1331a and the DHCP server 1100. Accordingly, a DHCP OFFER message including setup information indicating settings suitable for the network to which the DHCP server 1100 belongs, or the like is transmitted from the DHCP server 1100 to the VM 1331a, whereby DHCP setting suitable for the VM 1331a belonging to the same base as with the DHCP server 1100 may be performed.

### Fourth Embodiment

Next, a fourth embodiment will be described. Description will be made with difference as to the second embodiment as the center, and description will be omitted regarding the same matters as with the second embodiment. The communication system according to the fourth embodiment is a wireless communication system, and differs from the second embodiment in that when a mobile station (MS: Mobile Station) is connected from a wireless access carrier network to a provider network, identification information is employed for determining whether to connect the provider network by which of gateways.

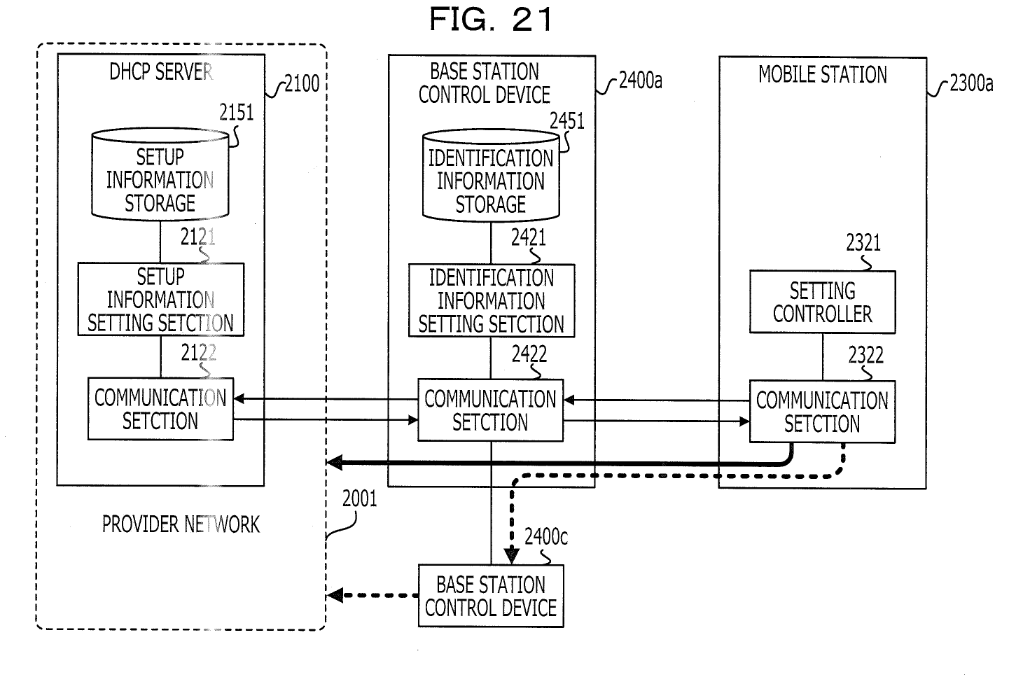

FIG. 21 is a block diagram illustrating the communication system according to the fourth embodiment. The communication system according to the fourth embodiment is a wireless communication system according to mobile WiMax.

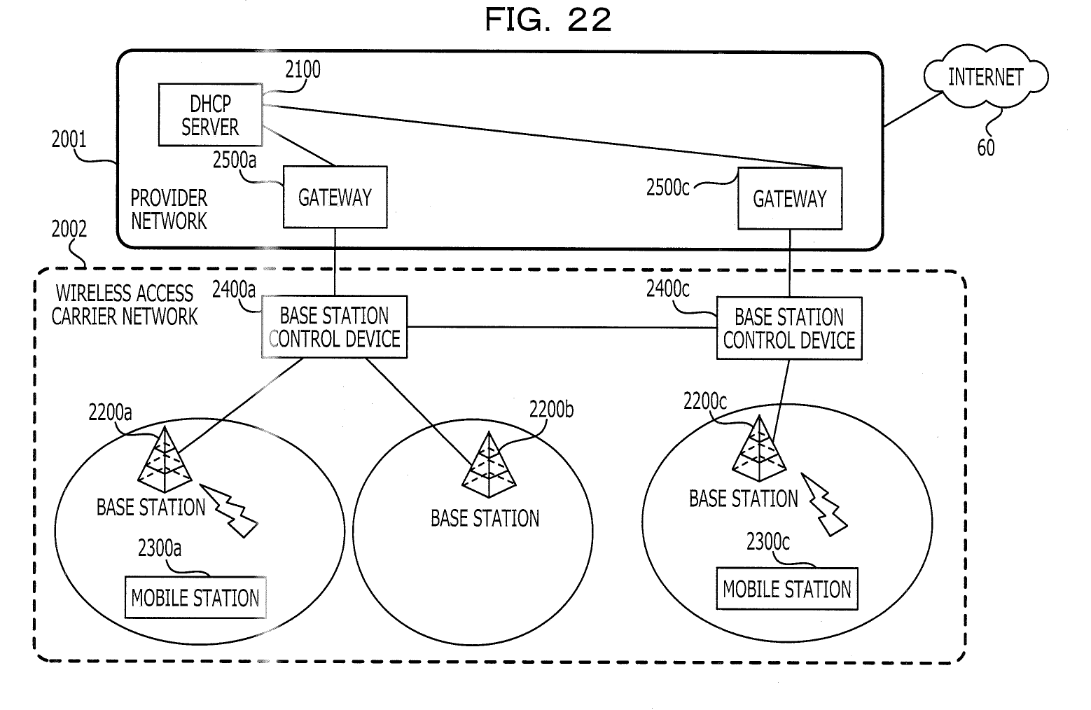

The communication system according to the fourth embodiment includes a DHCP sever 2100, a mobile station 2300a, base station control devices (ASN-GW: Access Service Network-Gateway) 2400a and 2400c. Here, as will be described later in detail in FIG. 22, the mobile station 2300a is connected to a base station (BS: Base Station) controlled by the base station control device 2400a by wireless communication, and also capable of connecting to another network such as a provider network 2001 or the Internet or the like via the base station control device 2400a. Also, the mobile station 2300a may perform communication with the base station control device 2400a as the default router. Also, the base station control device 2400a and base station control device 2400c are disposed in a mutually distant spot, and also connected with a large-capacity network. Also, the mobile station 2300a employs a large-capacity network for connecting the base station control device 2400a and base station control device 2400c, whereby the mobile station 2300a may connect to another network via the base station control device 2400c. Also, the mobile station 2300a may perform communication with the base station control device 2400c as the default router.

The DHCP server 2100 performs communication setting of another device such as the mobile station 2300a or the like by including setup information in a DHCP OFFER message or DHCP ACK message to transmit this to the mobile station 2300a. The DHCP server 2100 includes a setup information setting section 2121, a communication section 2122, and a setup information storage 2151. The DHCP server 2100 may be disposed in the provider network 2001. The DHCP server 2100 serves as a server.

The setup information storage 2151 stores setup information indicating the settings corresponding to the network correlated with identification information. The setup information indicates the DHCP settings of the mobile station 2300a according to a case where the mobile station 2300a performs communication using each of the base station control devices 2400a and 2400c. The setup information includes information indicating the base station control devices 2400a and 2400c to be set as the default router corresponding to the network. The communication section 2122 communicates with another device using a communication line.

The communication section 2122 has received a DHCP DISCOVER message or DHCP REQUEST message including identification information, and the DHCP REQUEST message is a DHCP REQUEST message at the time of handover. In this case, the setup information setting section 2121 causes the communication section 2122 to transmit a DHCP OFFER message including setup information corresponding to the identification information, or the like to the mobile station 2300a. Also, identification information included in a DHCP DISCOVER message or the like does not agree with any of the identification information of setup information. In this case, the setup information setting section 2121 causes the communication section 2122 to transmit a DHCP OFFER message including setup information indicating given settings, or the like, to the mobile station 2300a. The DHCP DISCOVER message and so forth serve as a setup information request. The DHCP OFFER message including setup information, and so forth, serve as a setup information response.

The base station control device 2400a includes an identification information setting section 2421, a communication section 2422, and an identification information storage 2451. The communication section 2422 communicates with another device using a communication line. Also, the base station control device 2400c and another base station control device not illustrated may include identification in the DHCP DISCOVER message transmitted from the mobile station 2300a, or the like, to transfer to the DHCP server 2100. The base station control device 2400a may be disposed in a base station and also in a wireless access carrier network according to later-described mobile WiMAX. The wireless access carrier network may be connected to the provider network 2001 via the base station control devices 2400a and 2400c, and a gateway. The base station control device 2400a serves as a relay device.

The communication section 2422 has received the DHCP DISCOVER message transmitted from the mobile station 2300a, or the like, via a base station. In this case, the identification information setting section 2421 includes identification information in the DHCP DISCOVER message received by the communication section 2422, or the like, at the time of relaying from the wireless access carrier network to the provider network 2001. The identification information setting section 2421 causes the communication section 2422 to transmit the DHCP DISCOVER message in which the identification information has been included, or the like, to the DHCP server 2100.

The identification information storage 2451 stores identification information whereby each of the base station control devices 2400a and 2400c which the mobile station 2300a uses for communication may uniquely be identified. The identification information may be information whereby each of the base station control devices 2400a and 2400c and other devices to be connected to another network may uniquely be identified.

The mobile station 2300a is a terminal device having a wireless communication function. The mobile station 2300a includes a setting controller 2321 and a communication section 2322. The mobile station 2300a serves as an information processing device.

In the event of performing communication setting in accordance with the DHCP server 2100, the setting controller 2321 causes the communication section 2322 to transmit the DHCP DISCOVER message or the like to the DHCP server 2100 via the base station control device 2400a.

In the event of having obtained setup information included in the DHCP OFFER message or DHCP ACK message transmitted from the DHCP server 2100, the setting controller 2321 performs communication setting based on the obtained setup information. The communication section 2322 performs communication using a communication line based on the communication settings by the setting controller 2321.

Now, the mobile station 2300a has received the DHCP OFFER message including setting information, transmitted from the DHCP server 2100, or the like. In this case, the mobile station 2300a performs DHCP setting suitable for the location of the mobile station 2300a, such as the default router or the like, using the setup information included in the DHCP OFFER message including setup information, or the like. Here, the location of the mobile station 2300a may be set based on the base station control device 2400a which connects the communication of the mobile station 2300a to another network such as the provider network 2001 or the like. Specifically, the DHCP DISCOVER message transmitted from the mobile station 2300a has arrived at the DHCP server 2100 of the provider network 2001 not via another base station control device but via the base station control device 2400a. In this case, the location of the mobile station 2300a may be determined based on the base station control device 2400a. In the event of setting a default router to be connected to the provider network 2100, to the mobile station 2300a, it is reasonable to set the base station control device 2400a which has transmitted the DHCP DISCOVER message transmitted from the mobile station 2300a to the provider network 2001 as the default router. Also, with regard to other DHCP settings as well, settings suitable for the mobile station 2300a may be selected based on the base station control device 2400a which has directly transmitted the DHCP DISCOVER message. Accordingly, the base station control device 2400a includes identification information whereby the base station control device 2400a may be identified in the DHCP DISCOVER message transmitted from the mobile station 2300a, or the like, to transfer to the DHCP server 2100. The DHCP server 2100 may perform DHCP setting suitable for the mobile station 2300a by including setup information indicating settings according to identification information for identifying the base station control device 2400a which has transferred in a DHCP OFFER message or the like to transfer to the mobile station 2300a.

Also, as will be described later in detail, in the event that the mobile station 2300a which has been connected to the base station control device 2400a has moved and connected to the base station control device 2400c by handover, the mobile station 2300a transmits a DHCP REQUEST message. In this case, the base station control device 2400c includes identification information for identifying the base station control device 2400c in the DHCP REQUEST message from the mobile station 2300a to transfer to the DHCP server 2100. The DHCP server 2100 transmits a DHCP ACK message including setup information suitable for the mobile station 2300a which employs the base station control device 2400c for communication to the mobile station 2300a as a response of the DHCP REQUEST message relayed by the base station control device 2400c. Thus, the mobile station 2300a which has moved so as to connect to the base station control device 2400c after handover may obtain setup information corresponding to the location after movement, and perform DHCP setting suitable for the location after movement.

Note that, though the communication system according to the fourth embodiment includes a wireless access carrier network according to mobile WiMAX, the present disclosure is not restricted to this, and may include a wireless communication system according to another method such as an LTE network or the like.

FIG. 22 is a diagram illustrating the communication system according to the fourth embodiment. FIG. 22 illustrates a network wherein the mobile stations 2300a and 2300c connect to the provider network 2001 by wireless communication employing the wireless access carrier network 2002, and perform communication with an information processing device, such as another mobile station or the like.

The provider network 2001 is connected to the Internet 60 or another carrier network, and the mobile stations 2300a and 2300c may connect to a communication destination outside the wireless access carrier network 2002 via the provider network 2001. The provider network 2001 includes a DHCP server 2100, and gateways 2500a and 2500c.

The DHCP server 2100 performs setting according to DHCP as to the mobile stations 2300a and 2300c to be connected to the wireless access carrier network 2002.

The gateways 2500a and 2500c connect the provider network 2001 and wireless access carrier network 2002. Thus, communication between the provider network 2001 and the mobile stations 2300a and 2300c will be performed.

The wireless access carrier network 2002 performs wireless communication according to mobile WiMAX between the mobile stations 2300a and 2300c, and also connect the mobile stations 2300a and 2300c, and the connected provider network 2001. The wireless access carrier network 2002 includes the base station control devices 2400a and 2400c, base stations 2200a, 2200b, and 2200c. The wireless access carrier network 2002 is, for example, a network for communication enterprises which provides a wireless communication service. A subnet address has been set to the wireless access carrier network 2002.

The base station control device 2400a is connected to the provider network 2001 via the gateway 2500a. Similarly, the base station control device 2400c is connected to the provider network 2001 via the gateway 2500c. The base station control devices 2400a and 2400c are mutually connected by a large-capacity network such as gigabit Ethernet (GbE: Gigabit Ethernet (registered trademark)) or the like, and may perform mutual communication. The base station control devices 2400a and 2400c may each control multiple base stations.

The base station control device 2400a is connected to base stations 2200a and 2200b. The base station control device 2400c is connected to a base station 2200c. The base station control device 2400a controls the base stations 2200a and 2200b, thereby controlling connection with a mobile station in a connectable range of either of the base stations 2200a and 2200b (e.g., the mobile station 2300a in a connectable range of the base station 2200a). Thus, communication between the mobile station 2300a and the provider network 2001 is relayed. Similarly, the base station control device 2400c controls the base station 2200c, thereby controlling connection with a mobile station in a connectable range of the base station 2200c (e.g., the mobile station 2300c in a connectable range of the base station 2200c). Thus, communication between the mobile station 2300c and the provider network 2001 is relayed.

Also, the base station control devices 2400a and 2400c serve as a DHCP relay agent to transfer the DHCP DISCOVER message transmitted from the mobile stations 2300a and 2300c to the DHCP server 2100. Thus, the setting of the mobile stations 2300a and 2300c of the wireless access carrier network 2002 may be performed from the DHCP server 2100 of the provider network 2001. Also, at this time, the base station control devices 2400a and 2400c include identification information in the DHCP DISCOVER message to transfer to the DHCP server 2100.

The base station 2200a performs wireless communication with the mobile station 2300a in a connectable range by wireless communication based on the control of the base station control device 2400a. The base station 2200b performs wireless communication with a mobile station (not illustrated) in a connectable range by wireless communication based on the control of the base station control device 2400a. The base station 2200c performs wireless communication with the mobile station 2300c in a connectable range by wireless communication based on the control of the base station control device 2400c.

The mobile stations 2300a and 2300c may connect to a base station in a connectable range via radio signals. Now, the mobile station 2300a to which a given MAC address (e.g., CC:CC:CC:CC:CC:CC) is set is located in a range connectable with the base station 2200a, and the mobile station 2300c to an MAC address different from the mobile station 2300a (e.g., DD:DD:DD:DD:DD:DD) is set is located in a range connectable with the base station 2200c.

Though the communication system according to the fourth embodiment includes two gateways and two base station control devices (e.g., gateways 2500a and 2500c, and base station control devices 2400a and 2400c), the present disclosure is not restricted to this, and may include an arbitrary number of gateways and base station control devices. Also, the base station control device 2400a controls two base stations (e.g., base stations 2200a and 2200b), and the base station control device 2400c controls one base station (e.g., base station 2200c). However, the present disclosure is not restricted to this, and the base station control devices 2400a and 2400c may control an arbitrary number of base stations.

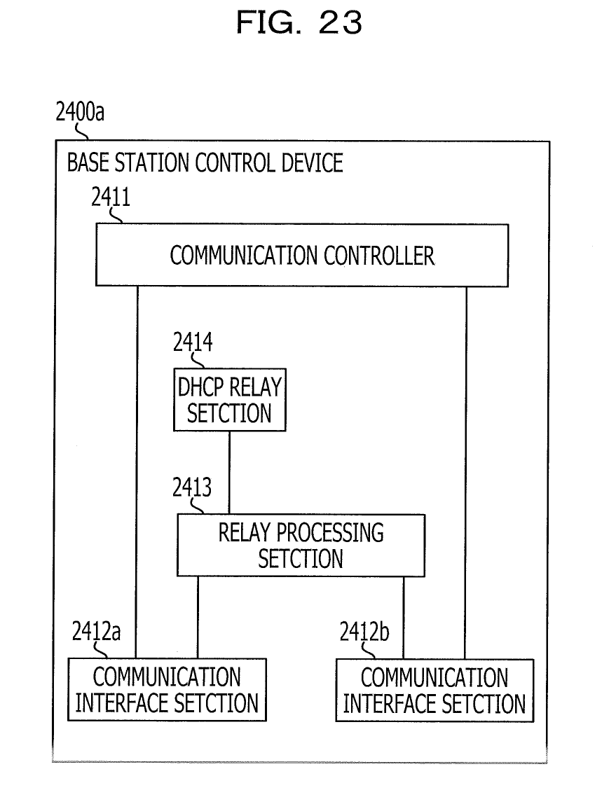

FIG. 23 is a diagram illustrating the base station control device according to the fourth embodiment. Though FIG. 23 illustrates the internal configuration of the base station control device 2400a, the base station control device 2400c may also be realized with the same configuration. The base station control device 2400a includes a communication controller 2411, communication interface sections 2412a and 2412b, a relay processing section 2413, and a DHCP relay section 2414.

The communication controller 2411 controls transmission/reception of a control message for controlling the base stations 2200a and 2200b.

The communication interface sections 2412a and 2412b are connected to a network physical link, and receive packets from the connected network physical link. Also, the communication interface sections 2412a and 2412b transmit packets received by the base station control device 2400a and relayed via the relay processing section 2413 to the network physical link of the transmission destination. Also, the communication interface sections 2412a and 2412b transmit/receive a control message which the communication controller 2411 exchanges with the base stations 2200a and 2200b. Note that, though the base station control device 2400a according to the fourth embodiment includes the two communication interface sections of the communication interface sections 2412a and 2412b, the present disclosure is not restricted to this, and may include an arbitrary number of communication interface sections.

The relay processing section 2413 relays the packet received at either of the communication interface sections 2412a and 2412b, and transfers via the communication interface section connected to the network of the transmission destination of the communication interface sections 2412a and 2412b.

The DHCP relay section 2414 realizes a DHCP relay function in the event that there is the DHCP server 2100 in the network of a subnet address different from the network of the mobile station 2300a. Specifically, in the event of having received the DHCP DISCOVER message from the mobile station 2300a transmitted by broadcast above the wireless access carrier network 2002, the DHCP relay section 2414 transfers this to the DHCP server 2100 of the provider network 2001. In the event of having received the DHCP OFFER message that is a response from the DHCP server 2100, the DHCP relay section 2414 then transfers this to the mobile station 2300a of the wireless access carrier network 2002.

In the event of having received the DHCP DISCOVER message from the mobile station 2300a, the DHCP relay section 2414 performs relay of the layer 3. Thus, the DHCP relay section 2414 relays the received DHCP DISCOVER message to a network having a subnet address different from the network of the transmission source to which the mobile station 2300a belongs, to which the DHCP server 2100 belongs. Also, at the time of relaying the DHCP DISCOVER message from the mobile station 2300a by the DHCP relay section 2414 as described above, the base station control device 2400a includes identification information in the DHCP DISCOVER message to transfer to the DHCP server 2100.

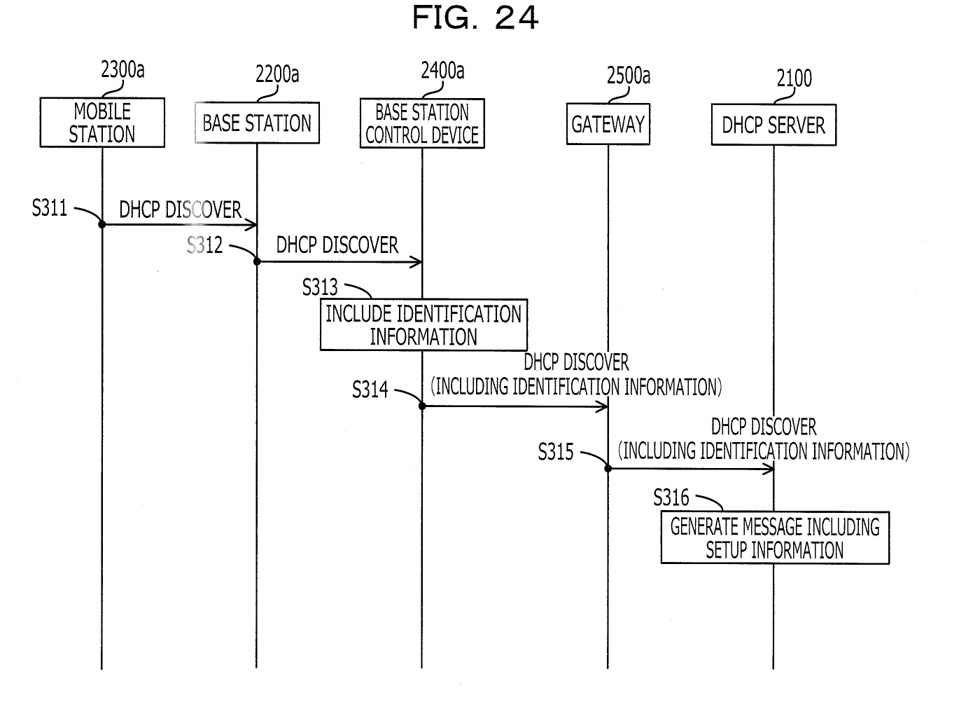

FIG. 24 is a sequence chart illustrating the operation at the time of activation of a mobile station in the communication system according to the fourth embodiment. For example, the mobile station 2300a transmits a DHCP DISCOVER message so as to obtain settings according to DHCP at the time of connection to the own wireless carrier network 2002. Now, the DHCP DISCOVER message is transmitted to the base station 2200a from the mobile station 2300a which is the host by wireless communication, and is transmitted from the base station 2200a to the wireless access carrier network 2002 by broadcast. Also, the DHCP DISCOVER message transmitted from the base station 2200a arrives at the DHCP server 2100 via the base station control device 2400a and gateway 2500a.

Also, with the DHCP server 2100, setup information indicating settings such as the default router according to the location of the mobile station 2300a, and so forth has been set to the setup information storage 2151 beforehand by the administrator of the communication system, or the like.

Hereafter, description will be made regarding the operation procedure of the communication system in the event that a DHCP DISCOVER message has been transmitted from the mobile station 2300a in accordance with FIG. 24.

[Step S311] The mobile station 2300a transmits the DHCP DISCOVER message by broadcast.

[Step S312] The base station 2200a transfers the DHCP DISCOVER message transmitted from the mobile station 2300a by wireless communication in Step S311 to the inside of the wireless access carrier network 2002.

[Step S313] The base station control device 2400a includes identification information indicating the location of the mobile station 2300a in the DHCP DISCOVER message from the mobile station 2300a transferred by the base station 2200a. Here, the identification information is information for identifying the base station control device 2400a first connected to the mobile station 2300a without passing through another base station control device.

[Step S314] The base station control device 2400a transfers the DHCP DISCOVER message in which the identification information has been included in Step S314 to the DHCP server 2100 of the provider network 2001 via the gateway 2500a by the DHCP relay agent.

[Step S315] Upon receiving the DHCP DISCOVER message (including identification information) transmitted from the base station control device 2400a in Step S314, the gateway 2500a transfers the received DHCP DISCOVER message.

[Step S316] The DHCP server 2100 selects setup information according to the location of the mobile station 2300a based on the identification information included in the DHCP DISCOVER message transmitted from the gateway 2500a in Step S315. Also, the DHCP server 2100 determines an IP address to be assigned to the mobile station 2300a which has transmitted the DHCP DISCOVER message. The DHCP server 2100 generates a DHCP OFFER message including the selected setup information and the proposed IP address for assignment. Processing thereafter is the same as with the communication system according to the second embodiment, and description thereof will be omitted.

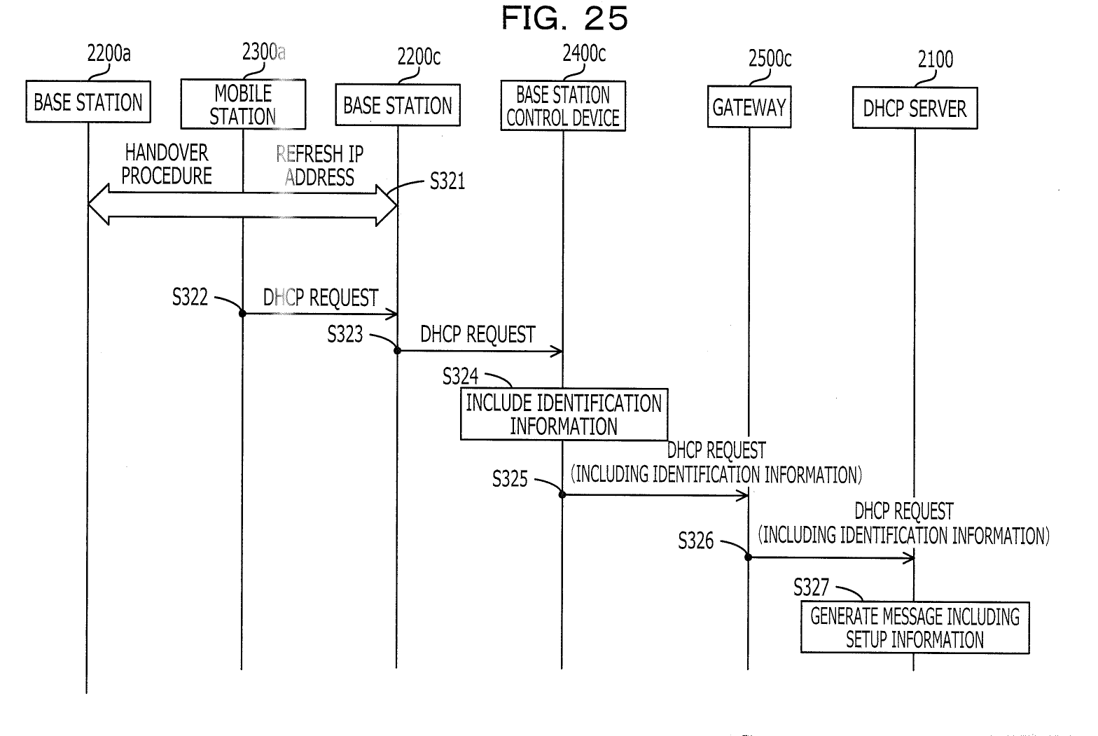

FIG. 25 is a sequence chart illustrating the operation at the time of handover of a mobile station in the communication system according to the fourth embodiment. Now, in the event that the mobile station 2300a which has been connected to the base station 2200a connects to the base station 2200c by handover, DHCP resetting is performed based on refresh such an IP address or the like. At this time, the mobile station 2300a transmits a DHCP REQUEST message by wireless communication, and the DHCP REQUEST message transmitted from the mobile station 2300a arrives at the DHCP server 2100 via the base station 2200c, base station control device 2400c, and gateway 2500c.

Hereafter, description will be made regarding the operation procedure of the communication system in the event that DHCP settings are obtained again at the time of occurrence of handover due to movement of the mobile station 2300a in accordance with FIG. 25.

[Step S321] The mobile station 2300a and base stations 2200a and 2200c execute a handover procedure wherein the mobile station 2300a which is connected to the base station 2200a switches the connection destination to the base station 2200c. Also, according to the handover procedure, instructions for refreshing the IP address of the mobile station 2300a are performed from the base station 2200a to the mobile station 2300a.

[Step S322] The mobile station 2300a transmits a DHCP REQUEST message.

[Step S323] The base station 2300c transfers the DHCP REQUST message transmitted from the mobile station 2300a by wireless communication in Step S322.

[Step S324] The base station control device 2400c includes identification information indicating the location of the mobile station 2300a in the DHCP REQUST message from the mobile station 2300a transferred by the base station 2200c.

[Step S325] The base station control device 2400c transfers the DHCP REQUEST message in which the identification information has been included in Step S324 to the DHCP server 2100 of the provider network 2001 via the gateway 2500c by the DHCP relay agent.

[Step S326] Upon receiving the DHCP REQUEST message (including identification information) transmitted from the base station control device 2400c in Step S325, the gateway 2500c transfers the received DHCP REQUEST message.

[Step S327] The DHCP server 2100 selects setup information according to the location of the mobile station 2300a based on the identification information included in the DHCP REQUEST message transmitted from the gateway 2500c in Step S326. Also, the DHCP server 2100 determines an IP address to be assigned to the mobile station 2300a which has transmitted the DHCP REQUEST message. The DHCP server 2100 generates a DHCP ACK message including the selected setup information and proposed IP address for assignment. With processing thereafter, the DHCP ACK message including the DHCP settings generated by the DHCP server 2100 is transmitted to the mobile station 2300a which is connected to the base station 2200c via the communication system. The mobile station 2300a which has received the DHCP ACK message including the DHCP settings sets the IP address proposed for continuity or the IP address proposed for assignment by the DHCP server 2100 to the own IP address. Also, the mobile station 2300a performs the own communication setting based on the setup information transmitted from the DHCP server 2100.

Thus, with the mobile station 2300a, the DHCP settings are updated by a DHCP REQUEST message being transmitted based on DHCP resetting after handover. Thus, the DHCP settings are updated according to the location of the mobile station 2300a after handover.

Also, with the fourth embodiment, though the DHCP server 2100 belongs to the provider network 2001, the present disclosure is not restricted to this, and may belong to another network.

The communication system according to the fourth embodiment as described above have the following advantages. With the wireless access carrier network 2002, the DHCP server 2100 obtains identification information to be included in a DHCP DISCOVER message or the like and transferred at the base station control device 2400a. Thus, the DHCP server 2100 may determine which of the base station control devices 2400a and 2400c within the wireless access carrier network 2002 to which a single subnet address has been set based on the identification information is connected to the mobile station 2300a. Thus, the DHCP server 2100 may perform suitable DHCP setting according to the location of the mobile station 2300a within the wireless access carrier network 2002. In accordance with this, occurrence of delay and load of the communication system may be suppressed.

Also, connection has occurred between the mobile station 2300a and the wireless access carrier network 2002 where the base station control device 2400a relays, or handover has occurred at the mobile station 2300a where the base station control device 2400c relays. In this case, the DHCP server 2100 may perform DHCP setting as to the mobile station 2300a according to the base station control device 2400a (or base station control device 2400c) which newly relays between the provider network 2001 and the mobile station 2300a.

### Fifth Embodiment

Next, a fifth embodiment will be described. Description will be made with difference as to the fourth embodiment as the center, and description will be omitted regarding the same matters as with the fourth embodiment. The communication system according to the fifth embodiment differs from the fourth embodiment in that PGID (Paging Group IDentification) used for call-up of a mobile station by a base station is employed as identification information.

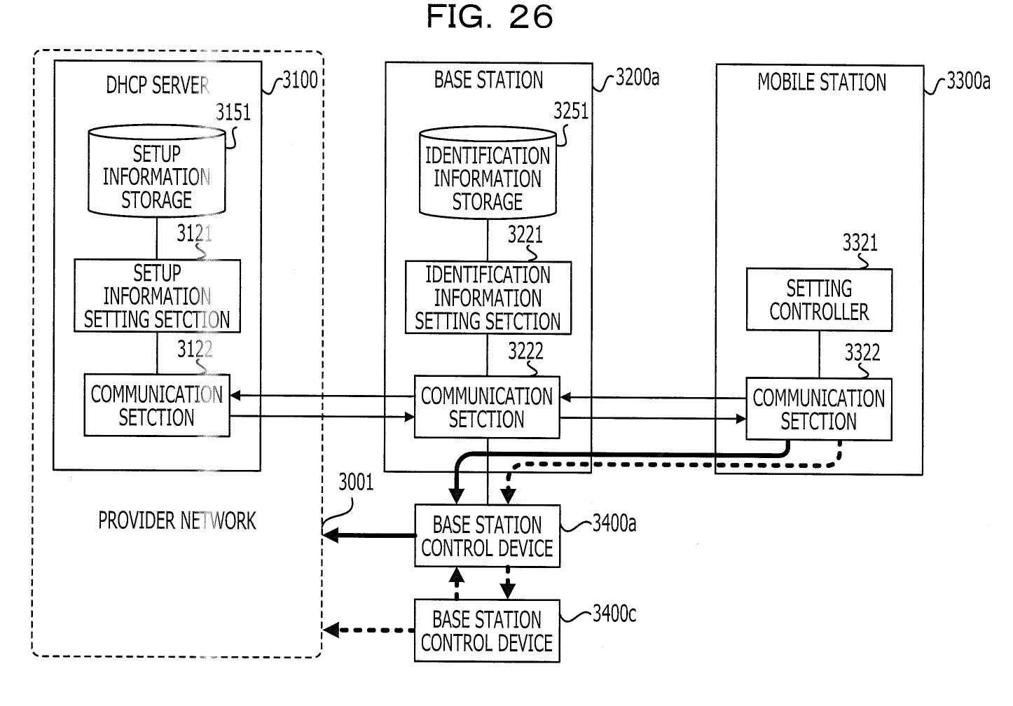

FIG. 26 is a block diagram illustrating the communication system according to the fifth embodiment. The communication system according to the fifth embodiment is a wireless communication system according to mobile WiMax, as with the fourth embodiment.

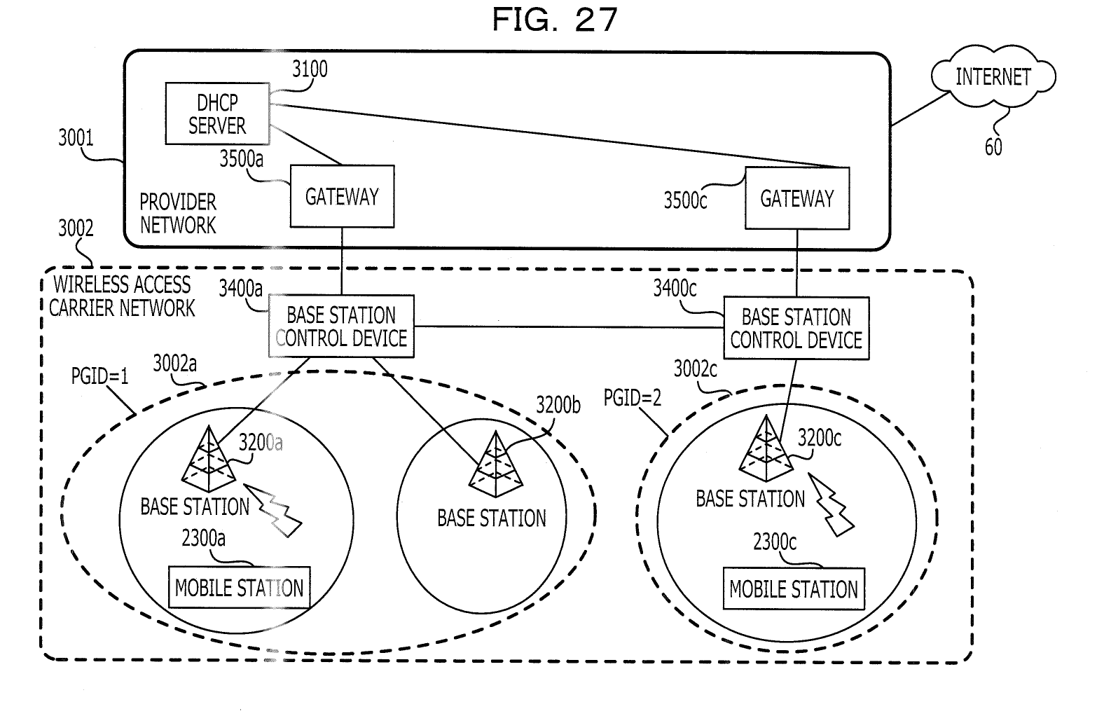

The communication system according to the fifth embodiment includes a DHCP sever 3100, a mobile station 3300a, a base station 3200a, base station control devices 3400a and 3400c. Here, as will be described later in detail in FIG. 27, the mobile station 3300a is connected to the base station 3200a to be controlled by the base station control device 3400a by wireless communication, and also capable of connecting to another network such as a provider network 3001 or the Internet or the like via the base station control device 3400a. Also, the mobile station 3300a may perform communication with the base station control device 3400a as the default router. Also, the base station control device 3400a and base station control device 3400c are disposed in a mutually distant spot, and also connected with a large-capacity network. Also, the mobile station 3300a employs a large-capacity network for connecting the base station control device 3400a and base station control device 3400c, whereby the mobile station 3300a may connect to another network via the base station control device 3400c. Also, the mobile station 3300a may perform communication with the base station control device 3400c as the default router.

The DHCP server 3100 performs communication setting of another device such as the mobile station 3300a or the like by including setup information in a DHCP OFFER message or DHCP ACK message to transmit this to the mobile station 3300a. The DHCP server 3100 includes a setup information setting section 3121, a communication section 3122, and a setup information storage 3151. The DHCP server 3100 may be disposed in the provider network 3001. The DHCP server 3100 serves as a server.

The setup information storage 3151 stores setup information indicating the settings corresponding to the network correlated with PGID indicating a base station group including the base station 3200a. The setup information indicates the DHCP settings of the mobile station 3300a according to a case where the mobile station 3300a performs communication using each of the base station control devices 3400a and 3400c. The setup information includes information indicating the base station control devices 3400a and 3400c to be set as the default router corresponding to the network. The communication section 3122 communicates with another device using a communication line.

The communication section 3122 has received a DHCP DISCOVER message or DHCP REQUEST message in which the PGID has been included, and the DHCP REQUEST message is a DHCP REQUEST message at the time of handover. In this case, the setup information setting section 3121 causes the communication section 3122 to transmit a DHCP OFFER message including setup information corresponding to the PGID, or the like to the mobile station 3300a. Also, the PGID included in a DHCP DISCOVER message or the like does not agree with any PGID of setup information. In this case, the setup information setting section 3121 causes the communication section 3122 to transmit a DHCP OFFER message including setup information indicating given settings, or the like, to the mobile station 3300a. The DHCP DISCOVER message and so forth serve as a setup information request. The DHCP OFFER message including setup information, and so forth, serve as a setup information response.

The base station 3200a includes an identification information setting section 3221, a communication section 3222, and an identification information storage 3251. The communication section 3222 communicates with another device using a communication line. Also, the base station 3200a may be disposed in a wireless access carrier network according to mobile WiMAX along with the base station control devices 3400a and 3400c. The wireless access carrier network may be connected to the provider network 3001 via the base station control devices 3400a and 3400c, and a gateway. The base station 3200a serves as a relay device.

The communication section 3222 has received the DHCP DISCOVER message transmitted from the mobile station 3300a, or the like. In this case, the identification information setting section 3221 includes PGID in the DHCP DISCOVER message received by the communication section 3222, or the like, at the time of relaying from the wireless access carrier network to the provider network 3001. With the fifth embodiment, PGID used for paging of the mobile station 3300a within the wireless access carrier network is employed as identification information. PGID is code for uniquely identifying a paging group set to a base station group within the wireless access carrier network. The identification information setting section 3221 causes the communication section 3222 to transmit the DHCP DISCOVER message in which PGID has been included, or the like, to the DHCP server 3100.

The identification information storage 3251 stores PGID as identification information whereby a base station group including the base station 3200a which the mobile station 3300a uses for communication may uniquely be identified.

The mobile station 3300a is a terminal device having a wireless communication function. The mobile station 3300a includes a setting controller 3321 and a communication section 3322. The mobile station 3300a serves as an information processing device.

In the event of performing communication setting in accordance with the DHCP server 3100, the setting controller 3321 causes the communication section 3322 to transmit the DHCP DISCOVER message or the like to the DHCP server 3100 via the base station 3200a.

Also, in the event of having obtained setup information included in the DHCP OFFER message or DHCP ACK message transmitted from the DHCP server 3100, the setting controller 3321 performs communication setting based on the obtained setup information. The communication section 3322 performs communication using a communication line based on the communication settings by the setting controller 3321.

Now, the mobile station 3300a has received the DHCP OFFER message transmitted from the DHCP server 3100, or the like. In this case, the mobile station 3300a performs DHCP setting suitable for the location of the mobile station 3300a, such as the default router or the like, using the setup information included in the DHCP OFFER message including setup information, or the like. Here, the location of the mobile station 3300a may be set based on the base station control device 3400a which connects the communication of the mobile station 3300a to another network such as the provider network 3001 or the like. Specifically, the DHCP DISCOVER message transmitted from the mobile station 3300a has arrived at the DHCP server 3100 of the provider network 3001 not via another base station but via the base station 3200a. In this case, the location of the mobile station 3300a may be determined based on the base station 3200a. Here, the base station control device 3400a controls the base station group including the base station 3200a, and accordingly, a one-to-many correspondence relation may hold between the base station control device 3400a and the base station 3200a. Therefore, in the event of setting a default router to be connected to the provider network 3100, to the mobile station 3300a, by taking advantage of this correspondence relation, the default router is set based on the PGID of the base station 3200a which has transmitted the DHCP DISCOVER message from the mobile station 3300a to the provider network 3100. Also, with regard to other DHCP settings as well, settings suitable for the mobile station 3300a are selected based on the PGID of the base station 3200a which has directly transmitted the DHCP DISCOVER message. Accordingly, the base station 3200a includes the PGID of the base station 3200a in the DHCP DISCOVER message transmitted from the mobile station 3300a, or the like, to transfer to the DHCP server 3100. The DHCP server 3100 may perform DHCP setting suitable for the mobile station 3300a by including setup information indicating settings according to the transferred PGID of the base station 3200a in a DHCP OFFER message or the like to transmit to the mobile station 3300a.

Also, as will be described later in detail, in the event that the mobile station 3300a which has been connected to the base station 3200a has moved and connected to another base station by handover, the mobile station 3300a transmits a DHCP REQUEST message. In this case, this base station includes the PGID of this base station in the DHCP REQUEST message from the mobile station 3300a to transfer to the DHCP server 3100. The DHCP server 3100 transmits a DHCP ACK message including setup information suitable for the mobile station 3300a connected to this base station as a response of the DHCP REQUEST message relayed by this base station. Thus, the mobile station 3300a which has moved so as to connect to this base station after handover may obtain setup information corresponding to the location after movement, and perform DHCP setting suitable for the location after movement.

Note that, though the communication system according to the fifth embodiment includes a wireless access carrier network according to mobile WiMAX, the present disclosure is not restricted to this, and may include a wireless communication system according to another method such as an LTE network or the like.

Also, though the base station 3200a includes PGID in the received DHCP DISCOVER message or the like to transmit this, the present disclosure is not restricted to this, and the base station control devices 3400a and 3400c may include PGID in the received DHCP DISCOVER message or the like to transmit this.

FIG. 27 is a diagram illustrating the communication system according to the fifth embodiment. FIG. 27 illustrates a network wherein the mobile stations 3300a and 3300c connect to the provider network 3001 by wireless communication employing the wireless access carrier network 3002, and perform communication with an information processing device, such as another mobile station or the like.

The provider network 3001 is connected to the Internet 60 or another carrier network, and the mobile stations 3300a and 3300c may connect to a communication destination outside the wireless access carrier network 3002 via the provider network 3001. The provider network 3001 includes the DHCP server 3100, and gateways 3500a and 3500c.

The DHCP server 3100 performs setting according to DHCP as to the mobile stations 3300a and 3300c to be connected to the wireless access carrier network 3002.

The gateways 3500a and 3500c connect the provider network 3001 and wireless access carrier network 3002. Thus, communication between the provider network 3001 and the mobile stations 3300a and 3300c will be performed.

The wireless access carrier network 3002 performs wireless communication according to mobile WiMAX between the mobile stations 3300a and 3300c, and also connect the mobile stations 3300a and 3300c, and the connected provider network 3001. The wireless access carrier network 3002 includes the base station control devices 3400a and 3400c, and base stations 3200a, 3200b, and 3200c. The wireless access carrier network 3002 is, for example, a network for communication enterprises which provides a wireless communication service. A single subnet address has been set to the wireless access carrier network 3002.

The base station control device 3400a is connected to the provider network 3001 via the gateway 3500a. Similarly, the base station control device 3400c is connected to the provider network 3001 via the gateway 3500c. The base station control devices 3400a and 3400c are mutually connected by a large-capacity network such as gigabit Ethernet (GbE: Gigabit Ethernet (registered trademark)) or the like, and may perform mutual communication. The base station control devices 3400a and 3400c may each control multiple base stations.

The base station control device 3400a is connected to the base stations 3200a and 3200b. The base station control device 3400c is connected to the base station 3200c. The base station control device 3400a controls the base stations 3200a and 3200b, thereby controlling connection with a mobile station in a connectable range of either of the base stations 3200a and 3200b (e.g., the mobile station 3300a in a connectable range of the base station 3200a). Thus, communication between the mobile station 3300a and the provider network 3001 is relayed. Similarly, the base station control device 3400c controls the base station 3200c, thereby controlling connection with a mobile station in a connectable range of the base station 3200c (e.g., the mobile station 3300c in a connectable range of the base station 3200c). Thus, communication between the mobile station 3300c and the provider network 3001 is relayed.

Also, the base station control devices 3400a and 3400c serve as a DHCP relay agent to transfer the DHCP DISCOVER message transmitted from the mobile stations 3300a and 3300c to the DHCP server 3100.

The base station 3200a performs wireless communication with the mobile station 3300a in a connectable range by wireless communication based on the control of the base station control device 3400a. The base station 3200b performs wireless communication with a mobile station (not illustrated) in a connectable range by wireless communication based on the control of the base station control device 3400a. The base station 3200c performs wireless communication with the mobile station 3300c in a connectable range by wireless communication based on the control of the base station control device 3400c. Also, in the event of having received the DHCP DISCOVER message from the mobile stations 3300a and 3300c, the base stations 3200a, 3200b, and 3200c include PGID that is identification information in the DHCP DISCOVER message to transfer to the DHCP server 3100.

The mobile stations 3300a and 3300c may connect to a base station in a connectable range via radio signals. Now, the mobile station 3300a to which a given MAC address (e.g., CC:CC:CC:CC:CC:CC) is set is located in a range connectable with the base station 3200a, and the mobile station 3300c to an MAC address different from the mobile station 3300a (e.g., DD:DD:DD:DD:DD:DD) is set is located in a range connectable with the base station 3200c.

Though the communication system according to the fifth embodiment includes two gateways and two base station control devices (e.g., gateways 3500a and 3500c, and base station control devices 3400a and 3400c), the present disclosure is not restricted to this, and may include an arbitrary number of gateways and base station control devices. Also, the base station control device 3400a controls two base stations (e.g., base stations 3200a and 3200b), and the base station control device 3400c controls one base station (e.g., base station 3200c). However, the present disclosure is not restricted to this, and the base station control devices 3400a and 3400c may control an arbitrary number of base stations.

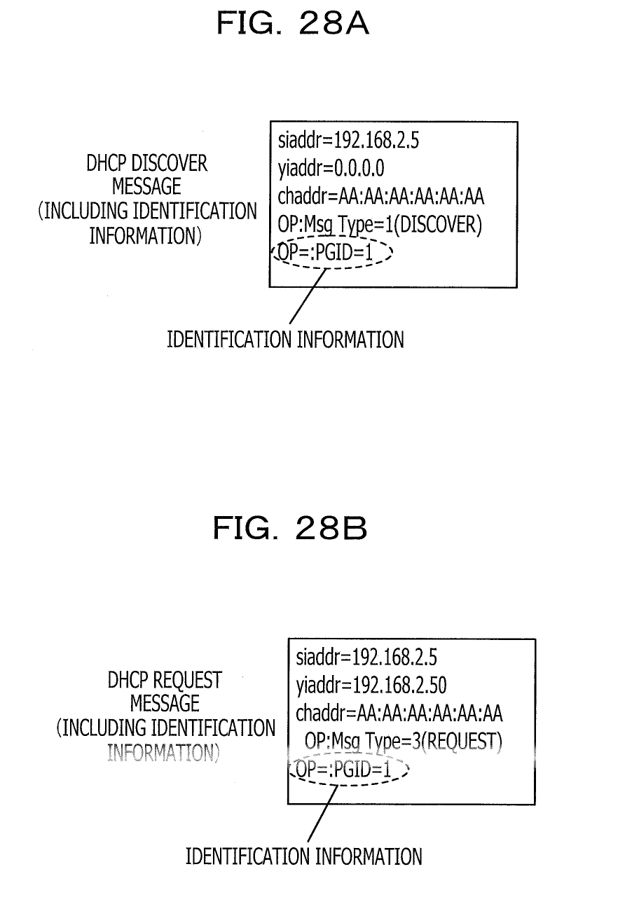

FIGS. 28A and 28B are diagrams indicating a DHCP DISCOVER message and a DHCP REQUEST message including identification information according to the fifth embodiment. FIG. 28A indicates a DHCP DISCOVER message including identification information according to the fifth embodiment. FIG. 28B indicates a DHCP REQUEST message including identification information according to the fifth embodiment.

With the DHCP DISCOVER message indicated in FIG. 28A, “siaddr” is a 4-byte region indicating the IP address of the DHCP server 3100. Also, “yiaddr” is a 4-byte region indicating the IP address of a candidate to be assigned to the mobile station 3300a. Also, “chaddr” is a 6-byte region indicating the MAC address of the mobile station 3300a.

Also, the region of “yiaddr” in the DHCP REQUEST message indicated in FIG. 28B indicates the IP address assigned to mobile station 3300a.

With the communication system according to the fifth embodiment, when the base station 3200a relays the DHCP DISCOVER message transmitted from the mobile station 3300a, the base station 3200a includes identification in the DHCP DISCOVER message to transfer to the DHCP server 3100. Specifically, the base station 3200a sets, as indicated in FIG. 28A, PGID (e.g., PGID=1) in the option field of the DHCP DISCOVER message transmitted from the mobile station 3300a as identification information. Also, the location of the mobile station 3300a may be informed to the DHCP server 3100 by setting identification information to the privately-available option number (e.g., DHCP option number 230) of the DHCP option.

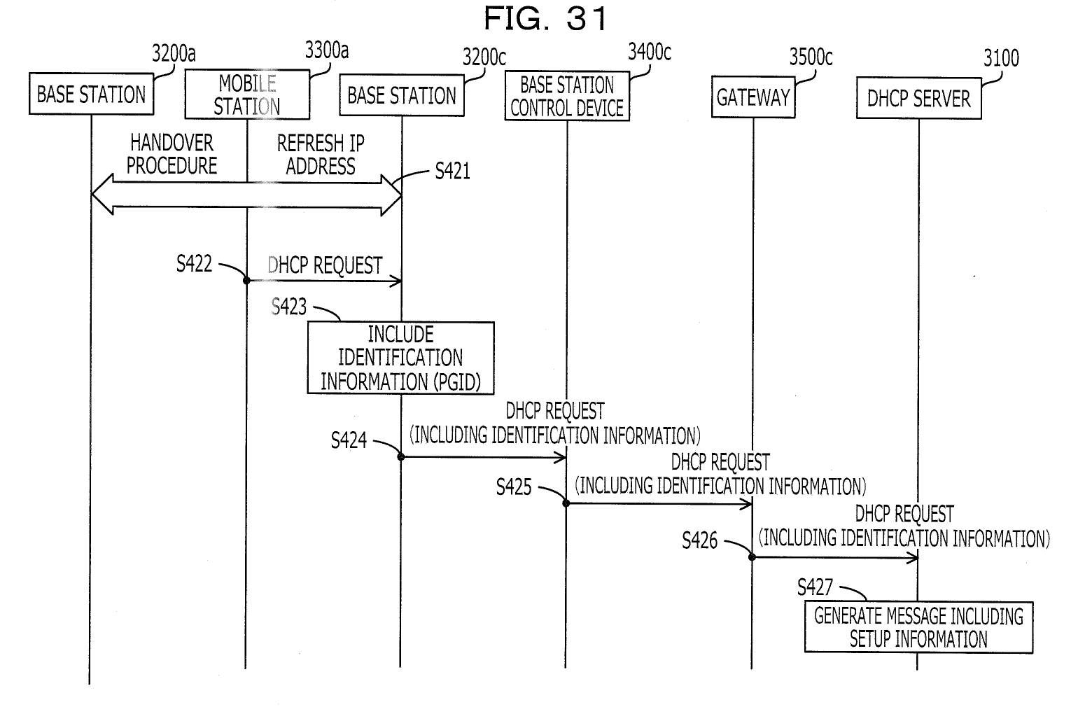

Also, with the communication system according to the fifth embodiment, in the event that handover of the mobile station 3300a has occurred, as will be described later in FIG. 31, a DHCP REQUEST message has been transmitted from the mobile station 3300a. In this case, when relaying the DHCP REQUEST message transmitted from the mobile station 3300a, the base station 3200a includes identification information in the DHCP REQUEST message to transfer to the DHCP server 3100. Specifically, the base station 3200a sets, as indicated in FIG. 28B, PGID (e.g., PGID=1) to the option field of the DHCP REQUEST message transmitted from the mobile station 3300a as identification information. Also, the location of the mobile station 3300a may be informed to the DHCP server 3100 by setting identification information to the privately-available option number of the DHCP option.

With the communication system according to the fifth embodiment, identification information is set so as to uniquely identify a base station which the mobile station 3300a connects. Thus, the DHCP server 3100 may recognize that the mobile station 3300a which has transmitted the DHCP DISCOVER message or the like is connected to the base station 3200a, by referencing identification information included in the message. Based on this, the DHCP server 3100 determines the settings of the default router of setup information in accordance with the correspondence relation between the base station 3200a connected to the mobile station 3300a and the base station control device 3400a. Thus, the DHCP server 3100 may set the optimal default router according to the location as to the mobile station 3300a based on the identification information.

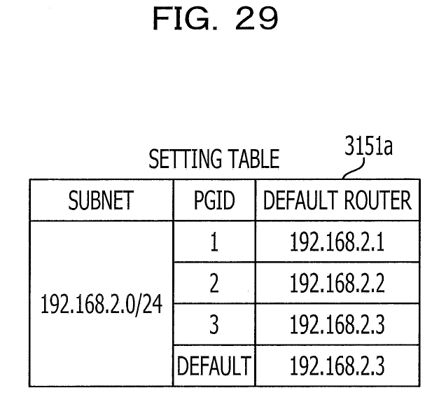

FIG. 29 is a diagram indicating a setting table according to the fifth embodiment. The setting table 3151a indicated in FIG. 29 is stored in a setup information storage 3151 which the DHCP server 3100 includes. The setting table 3151a is a table for storing setup information indicating the DHCP settings as to a mobile station of the communication system. The setup information is set based on the base stations 3200a through 3200c to be controlled by the base station control devices 3400a and 3400c of the communication system, and the setting contents to be set to the mobile stations 3300a and 3300c to be connected to the base stations 3200a through 3200c thereof. The setup information is set beforehand by the administrator of the communication system.

With the setting table 3151a, “SUBNET”, “PGID”, and “DEFAULT ROUTER” are provided as items. With the setting table 3151a, information arrayed in the lateral direction of the items are mutually correlated as setup information.

“SUBNET” indicates the subnet address of the wireless access carrier network 3002 to which the setup information is applied.

“PGID” indicates the locations of the mobile stations 3300a and 3300c to which the settings that the setup information indicates are applied. Specifically, the setup information indicates settings suitable for a mobile station existing in the location indicated by PGID. Here, the location indicated by PGID has been set based on the base stations 3200a through 3200c.

“DEFAULT ROUTER” indicates an IP address of the base station control devices 3400a and 3400c to be set to the mobile station as the default router by the setup information based on PGID.

The DHCP server 3100 transmits a response (DHCP OFFER message, DHCP ACK message) including setup information according to the request (DHCP DISCOVER message, DHCP REQUEST message) from the mobile station 3300a or the like. The mobile stations 3300a and 3300c within the communication system perform communication setting based on setup information included in the DHCP OFFER message or DHCP ACK message transmitted from the DHCP server 3100.

With the fifth embodiment, PGID is set for each base station control device of the communication system. With the setting table 3151a, different setup information is set for each PGID. For example, PGID is set based on the base station control device 3400a for controlling the base station 3200a connected to the mobile station 3300a, and the IP address of the base station control device 3400 is set as the IP address of the default router for each PGID.

In the event that PGID is not included in the DHCP DISCOVER message, the DHCP server 3100 includes setup information with PGID as the default in the DHCP OFFER message to respond. Even in the event that PGID not set to the setting table 3151a is included in the DHCP DISCOVER message, the DHCP server 3100 similarly includes setup information with PGID as the default in the DHCP OFFER message to respond. In the event that PGID is not included in the DHCP REQUEST message to be transmitted at the time of handover, the DHCP server 3100 includes setup information with PGID as the default in the DHCP ACK message to respond. Even in the event that PGID which is not included in the setting table 3151a is included in the DHCP REQUEST message at the time of handover, the DHCP server 3100 similarly includes setup information with PGID as the default in the DHCP ACK message to respond.

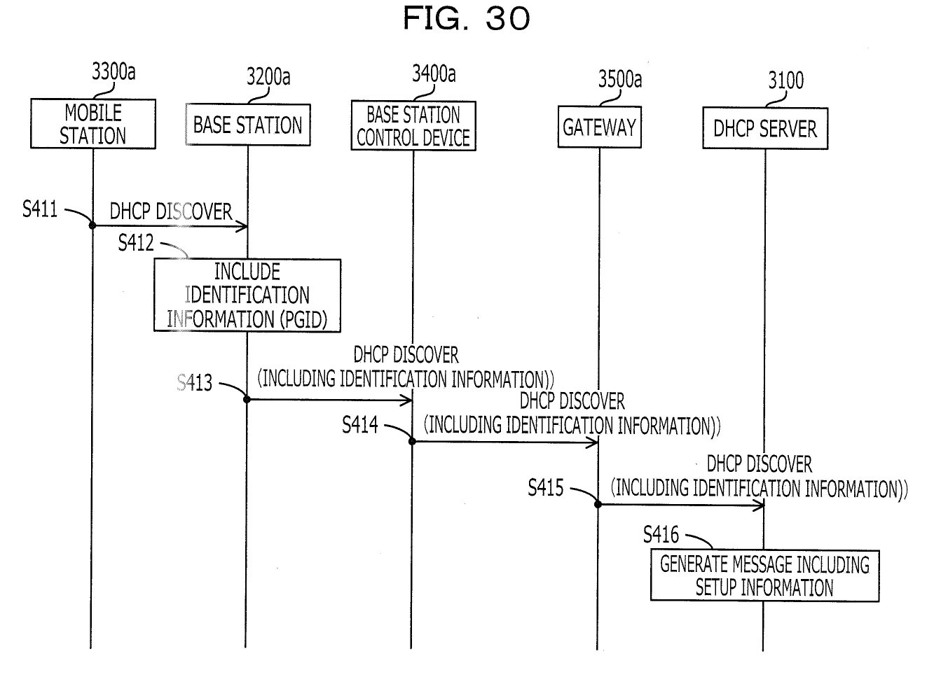

FIG. 30 is a sequence chart illustrating the operation at the time of activation of a mobile station in the communication system according to the fifth embodiment. For example, the mobile station 3300a transmits a DHCP DISCOVER message so as to obtain settings according to DHCP at the time of connection to the own wireless carrier network 3002. Now, the DHCP DISCOVER message is transmitted to the base station 3200a from the mobile station 3300a which is the host by wireless communication, and is transmitted from the base station 3200a to the wireless access carrier network 3002 by broadcast. Also, the DHCP DISCOVER message transmitted from the base station 3200a arrives at the DHCP server 3100 via the base station control device 3400a and gateway 3500a.

Also, with the DHCP server 3100, setup information indicating settings such as the default router according to the location of the mobile station 3300a, and so forth has been set to the setup information storage 3151 beforehand by the administrator of the communication system, or the like.

Hereafter, description will be made regarding the operation procedure of the communication system in the event that a DHCP DISCOVER message has been transmitted from the mobile station 3300a in accordance with FIG. 30.

[Step S411] The mobile station 3300a transmits the DHCP DISCOVER message by broadcast.

[Step S412] The base station 3200a includes PGID indicating the location of the mobile station 3300a in the DHCP DISCOVER message transmitted by the mobile station 3300a. Here, the PGID is identification information for identifying the base station 3200a connected to the mobile station 3300a by wireless communication.

[Step S413] The base station 3200a transfers the DHCP DISCOVER message in which the PGID that is identification information has been included in Step S412 to the inside of the wireless access carrier network 3002.

[Step S414] The base station control device 3400a transfers the DHCP DISCOVER message (including identification information) transmitted from the base station 3200a in Step S413. At this time, the base station control device 3400a transfers the DHCP DISCOVER message to the DHCP server 3100 of the provider network 3001 via the gateway 3500a by the DHCP relay agent.

[Step S415] Upon receiving the DHCP DISCOVER message transmitted from the base station control device 3400a in Step S414, the gateway 3500a transfers the received DHCP DISCOVER message.

[Step S416] The DHCP server 3100 selects setup information according to the location of the mobile station 3300a based on the identification information included in the DHCP DISCOVER message transmitted from the gateway 3500a in Step S415. Also, the DHCP server 3100 determines an IP address to be assigned to the mobile station 3300a which has transmitted the DHCP DISCOVER message. The DHCP server 3100 generates a DHCP OFFER message including the selected setup information and the proposed IP address for assignment. Processing thereafter is the same as with the communication system according to the second embodiment, and description thereof will be omitted.

FIG. 31 is a sequence chart illustrating the operation at the time of handover of a mobile station in the communication system according to the fifth embodiment. Now, in the event that the mobile station 3300a which has been connected to the base station 3200a connects to the base station 3200c by handover, DHCP resetting is performed based on refresh such an IP address or the like. At this time, the mobile station 3300a transmits a DHCP REQUEST message by wireless communication, and the DHCP REQUEST message transmitted from the mobile station 3300a arrives at the DHCP server 3100 via the base station 3200c, base station control device 3400c, and gateway 3500c.

Hereafter, description will be made regarding the operation procedure of the communication system in the event that DHCP settings are obtained again at the time of occurrence of handover due to movement of the mobile station 3300a in accordance with FIG. 31.

[Step S421] The mobile station 3300a and base stations 3200a and 3200c execute a handover procedure wherein the mobile station 3300a which is connected to the base station 3200a switches the connection destination to the base station 3200c. Also, according to the handover procedure, instructions for refreshing the IP address of the mobile station 3300a are performed from the base station 3200a to the mobile station 3300a.

[Step S422] The mobile station 3300a transmits a DHCP REQUEST message.

[Step S423] The base station 3200c includes PGID (identification information) indicating the location of the mobile station 3300a in the DHCP REQUEST message transmitted by the mobile station 3300a using wireless communication.

[Step S424] The base station 3200c transfers the DHCP REQUEST message in which the identification information has been included in Step S423 to the inside of the wireless access carrier network 3002.

[Step S425] The base station control device 3400c transfers the DHCP REQUEST message (including identification information) transferred from the base station 3200c in Step S424. At this time, the base station control device 3400c transfers the DHCP REQUEST message to the DHCP server 3100 of the provider network 3001 via the gateway 3500c by the DHCP relay agent.

[Step S426] Upon receiving the DHCP REQUEST message (including identification information) transmitted from the base station control device 3400c in Step S425, the gateway 3500c transfers the received DHCP REQUEST message.

[Step S427] The DHCP server 3100 selects setup information according to the location of the mobile station 3300a based on the identification information included in the DHCP REQUEST message transmitted from the gateway 3500c in Step S426. Also, the DHCP server 3100 determines an IP address to be assigned to the mobile station 3300a which has transmitted the DHCP REQUEST message. The DHCP server 3100 generates a DHCP ACK message including the selected setup information and proposed IP address for assignment. With processing thereafter, the DHCP ACK message including the DHCP settings generated by the DHCP server 3100 is transmitted to the mobile station 3300a which is connected to the base station 3200c via the communication system. The mobile station 3300a which has received the DHCP ACK message including the DHCP settings sets the IP address proposed for continuity or the IP address proposed for assignment to the own IP address. Also, the mobile station 3300a performs the own communication setting based on the setup information transmitted from the DHCP server 3100.

Thus, with the mobile station 3300a, the DHCP settings are updated by a DHCP REQUEST message being transmitted based on DHCP resetting after handover. Thus, the DHCP settings are updated according to the location of the mobile station 3300a after handover.

Also, with the fifth embodiment, though the DHCP server 3100 belongs to the provider network 3001, the present disclosure is not restricted to this, and may belong to the wireless access carrier network 3002 or another network.

The communication system according to the fifth embodiment as described above has the same advantages as with the fourth embodiment by including PGID in a DHCP DISCOVER message or the like at the base station 3200a as identification information to transfer to the DHCP server 3100.

### Sixth Embodiment

Next, a sixth embodiment will be described. Description will be made with difference as to the fifth embodiment as the center, and description will be omitted regarding the same matters as with the fifth embodiment. The communication system according to the sixth embodiment differs from the fifth embodiment in that a mobile station obtains PGID that is identification information from a base station beforehand, and the mobile station includes the PGID in a DHCP DISCOVER message or DHCP REQUEST message to transmit this.

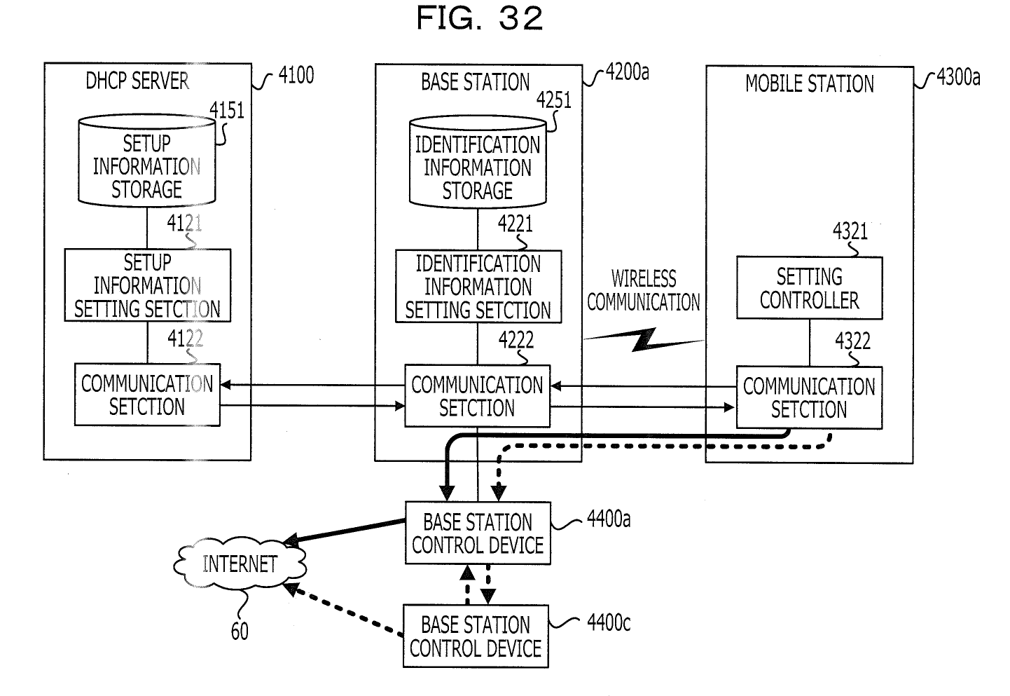

FIG. 32 is a block diagram illustrating the communication system according to the sixth embodiment. The communication system according to the sixth embodiment is a wireless communication system according to mobile WiMax.

The communication system according to the sixth embodiment includes a DHCP sever 4100, a mobile station 4300a, a base station 4200a, base station control devices 4400a and 4400c. Here, in the same way as with the fifth embodiment, the mobile station 4300a is connected to the base station 4200a to be controlled by the base station control device 4400a by wireless communication, and also capable of connecting to another network such as a provider network or the Internet or the like via the base station control device 4400a. Also, the mobile station 4300a may perform communication with the base station control device 4400a as the default router. Also, the base station control device 4400a and base station control device 4400c are disposed in a mutually distant spot, and also connected with a large-capacity network. Also, the mobile station 4300a employs a large-capacity network for connecting the base station control device 4400a and base station control device 4400c, whereby the mobile station 4300a may connect to another network via the base station control device 4400c. Also, the mobile station 4300a may perform communication with the base station control device 4400c as the default router.

The DHCP server 4100 performs communication setting of another device such as the mobile station 4300a or the like by including setup information in a DHCP OFFER message or DHCP ACK message to transmit this to the mobile station 4300a. The DHCP server 4100 includes a setup information setting section 4121, a communication section 4122, and a setup information storage 4151. The DHCP server 4100 may be disposed in the provider network. The DHCP server 4100 serves as a server.

The setup information storage 4151 stores setup information indicating the settings corresponding to the network correlated with PGID indicating a base station group including the base station 4200a. The setup information indicates the DHCP settings of the mobile station 4300a according to a case where the mobile station 4300a performs communication using each of the base station control devices 4400a and 4400c. The setup information includes information indicating the base station control devices 4400a and 4400c to be set as the default router corresponding to the network. The communication section 4122 communicates with another device using a communication line.

The communication section 4122 has received a DHCP DISCOVER message or DHCP REQUEST message in which the PGID has been included by the base station 4200a, and the DHCP REQUEST message is a DHCP REQUEST message at the time of handover. In this case, the setup information setting section 4121 causes the communication section 4122 to transmit a DHCP OFFER message including setup information corresponding to the PGID, or the like to the mobile station 4300a. Also, the PGID included in a DHCP DISCOVER message or the like does not agree with any PGID of setup information. In this case, the setup information setting section 4121 causes the communication section 4122 to transmit a DHCP OFFER message including setup information indicating given settings, or the like, to the mobile station 4300a. The DHCP DISCOVER message and so forth serve as a setup information request. The DHCP OFFER message including setup information, and so forth, serve as a setup information response.

The base station 4200a includes an identification information setting section 4221, a communication section 4222, and an identification information storage 4251. The communication section 4222 communicates with another device using a communication line. The base station 4200a may be disposed in a wireless access carrier network according to later-described mobile WiMAX along with the base station control devices 4400a and 4400c. The wireless access carrier network may be connected to the provider network via the base station control devices 4400a and 4400c, and a gateway. The base station 4200a serves as a relay device.

The mobile station 4300a is newly activated, and is connected to the base station 4200a by handover. In this case, the identification information setting section 4221 causes the communication section 4222 to transmit a control signal including identification information indicating the location of the mobile station 4300a within the wireless access carrier network to which the mobile station 4300a belongs, to the mobile station 4300a. With the sixth embodiment, PGID used for paging of the mobile station 4300a within the wireless access carrier network is employed as identification information. The PGID is code for uniquely identifying a paging group set to a base station group within the wireless access carrier network.

The identification information storage 4251 stores PGID as identification information whereby a base station group including the base station 4200a which the mobile station 4300a uses for communication may uniquely be identified.

The mobile station 4300a is a terminal device having a wireless communication function. The mobile station 4300a includes a setting controller 4321 and a communication section 4322. The mobile station 4300a serves as an information processing device.

The setting controller 431 causes the communication section 4322 to transmit a control signal for requesting identification information to the base station 4200a to be connected, at the time of new connection or handover. In the event of having received the identification information transmitted from the base station 4200a, the setting controller 4321 causes the communication section 4322 to transmit a DHCP DISCOVER message or DHCP REQUEST message including the identification information. Also, in the event of having obtained setup information included in the DHCP OFFER message or DHCP ACK message transmitted from the DHCP server 4100, the setting controller 4321 performs communication setting based on the obtained setup information. The communication section 4322 performs communication using a communication line based on the communication settings by the setting controller 4321.

Also, as will be described later in detail, in the event that the mobile station 4300a which has been connected to the base station 4200a has moved and connected to another base station by handover, the mobile station 4300a transmits a DHCP REQUEST message. In this case, the mobile station 4300a receives the PGID of the base station of the handover destination, and includes the PGID of the base station of the handover destination in a DHCP REQUEST message to transfer to the DHCP server 4100. The DHCP server 4100 transmits a DHCP ACK message including setup information suitable for the mobile station 4300a to the mobile station 4300a as a response of the DHCP REQUEST message from the mobile station 4300a. Thus, the mobile station 4300a which has moved after handover may obtain setup information corresponding to the location after movement, and perform DHCP setting suitable for the location after movement.

Note that, though the communication system according to the sixth embodiment includes a wireless access carrier network according to mobile WiMAX, the present disclosure is not restricted to this, and may include a wireless communication system according to another method such as an LTE network or the like.

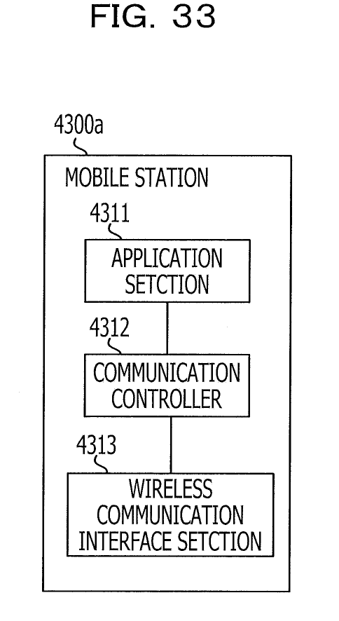

FIG. 33 is a diagram illustrating a mobile station according to the sixth embodiment. The mobile station 4300a according to the sixth embodiment includes an application section 4311, a communication controller 4312, and a wireless communication interface section 4313.

The application section 4311 executes processing of data to be transmitted from the mobile station 4300a, and data received by the mobile station 4300a. The application section 4311 includes data processing sections such as a CPU, an audio processing section, a video processing section, and so forth which read out a program or data from the ROM, load to the RAM, and execute the program.

The communication controller 4312 performs communication processing of data at the mobile station 4300a, and also controls communication by the wireless communication interface section 4313. Also, the wireless communication interface section 4313 obtains an IP address to be assigned to the mobile station 4300a, or DHCP settings indicated by setup information by exchanging a DHCP protocol message with the DHCP server 4100. The communication controller 4312 connects to the wireless access carrier network using the obtained DHCP settings.

The wireless communication interface section 4313 performs processing for receiving packets from the connected wireless access carrier network, and also transmitting packets to the connected wireless access carrier network.

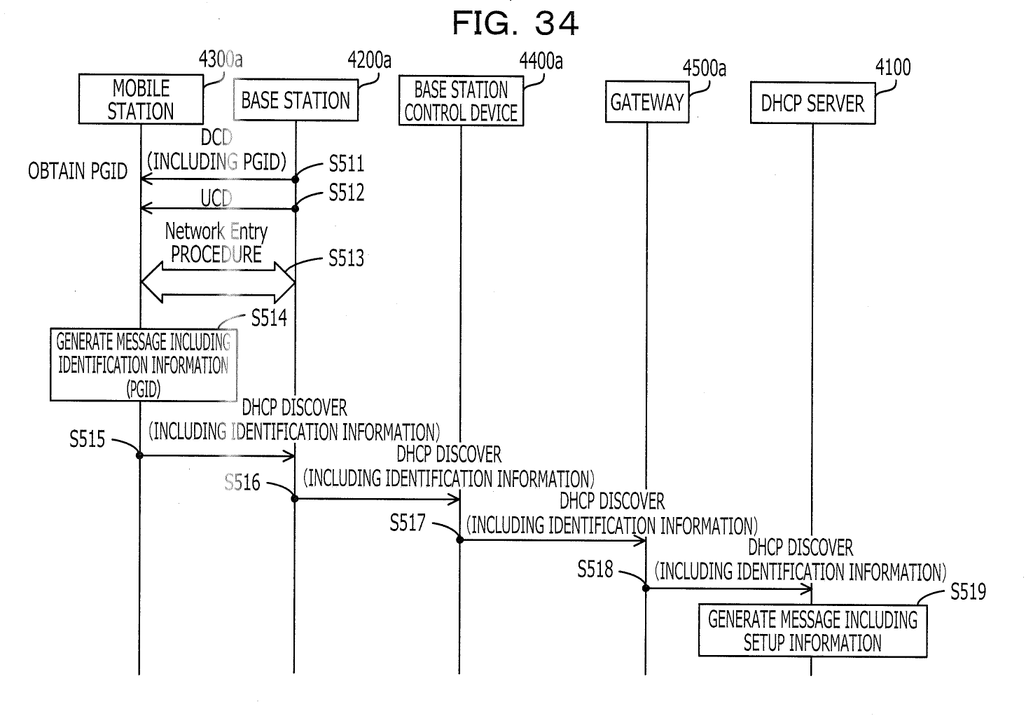

FIG. 34 is a sequence chart illustrating the operation at the time of activation of a mobile station in the communication system according to the sixth embodiment. For example, I the mobile station 4300a transmits a DHCP DISCOVER message so as to obtain settings according to DHCP at the time of connection to the own wireless access carrier network. Now, the mobile station 4300a obtains PGID at the time of connecting to the base station 4200a, and includes the obtained PGID in the DHCP DISCOVER message as identification information for generation. The DHCP DISCOVER message is transmitted from the mobile station 4300a to the base station 4200a by wireless communication, and is transmitted from the base station 4200a to the wireless access carrier network by broadcast, and the DHCP DISCOVER message transmitted from the base station 4200a arrives at the DHCP server 4100 via the base station control device 4400a and gateway 4500a.

Also, with the DHCP server 4100, setup information indicating settings such as the default router according to the location of the mobile station 4300a, and so forth has been set to the setup information storage 4151 beforehand by the administrator of the communication system, or the like.

Hereafter, description will be made regarding the operation procedure of the communication system in the event that a DHCP DISCOVER message has been transmitted from the mobile station 4300a in accordance with FIG. 34.

[Step S511] The base station 4200a transmits, by wireless communication, a DCD (Downlink Channel Descriptor) including PGID indicating the location of the mobile station 4300a. The mobile station 2300a receives the DCD, thereby obtaining PGID included in the DCD. Here, the PGID is identification information for identifying the location of the mobile station 4300a in the wireless access carrier network.

[Step S512] The base station 4200a transmits a UCD (Uplink Channel Descriptor) by wireless communication.

[Step S513] The mobile station 4300a and base station 4200a execute a Network Entry procedure.

[Step S514] The mobile station 4300a generates a DHCP DISCOVER message in which the PGID (identification information) obtained in Step S511 has been included.

[Step S515] The mobile station 4300a transmits the DHCP DISCOVER message generated by the identification information being included therein in Step S514, using broadcast.

[Step S516] The base station 4200a transfers the DHCP DISCOVER message (including identification information) transmitted by the mobile station 4300a in Step S515 to the inside of the wireless access carrier network.

[Step S517] The base station control device 4400a transfers the DHCP DISCOVER message transmitted from the base station 4200a in Step S516. At this time, the base station control device 4400a transfers the DHCP DISCOVER message to the DHCP server 4100 of the provider network via the gateway 4500a by the DHCP relay agent.

[Step S518] Upon receiving the DHCP DISCOVER message transmitted from the base station control device 4400a in Step S517, the gateway 4500a transfers the received DHCP DISCOVER message.

[Step S519] The DHCP server 4100 selects setup information according to the location of the mobile station 4300a based on the identification information included in the DHCP DISCOVER message transmitted from the gateway 4500a in Step S518. Also, the DHCP server 4100 determines an IP address to be assigned to the mobile station 4300a which has transmitted the DHCP DISCOVER message. The DHCP server 4100 generates a DHCP OFFER message including the selected setup information and the proposed IP address for assignment. Processing thereafter is the same as with the communication system according to the second embodiment, and description thereof will be omitted.

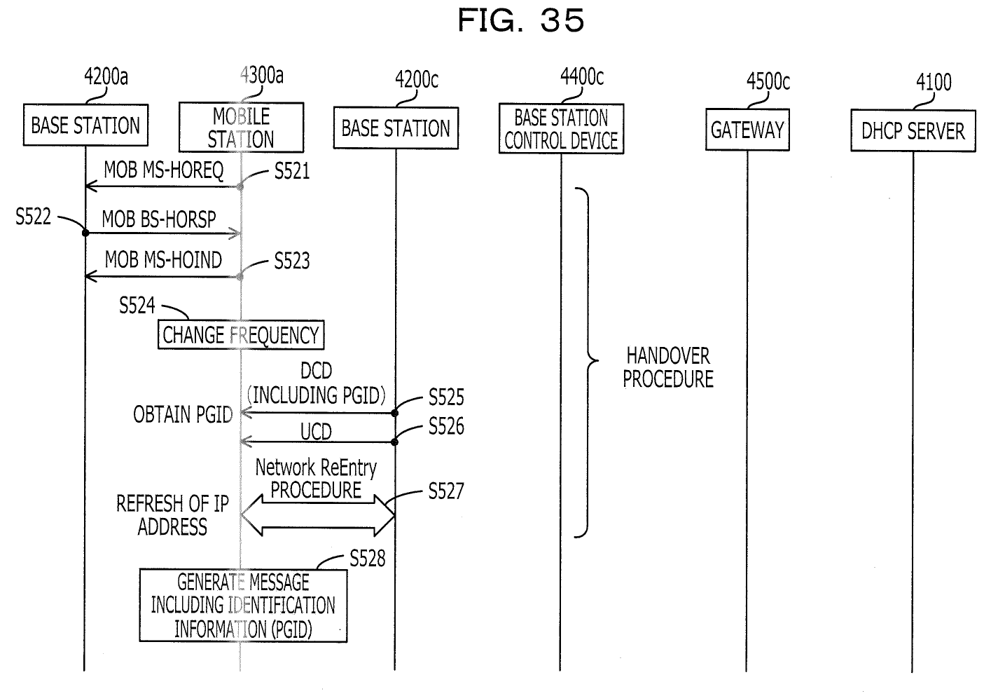

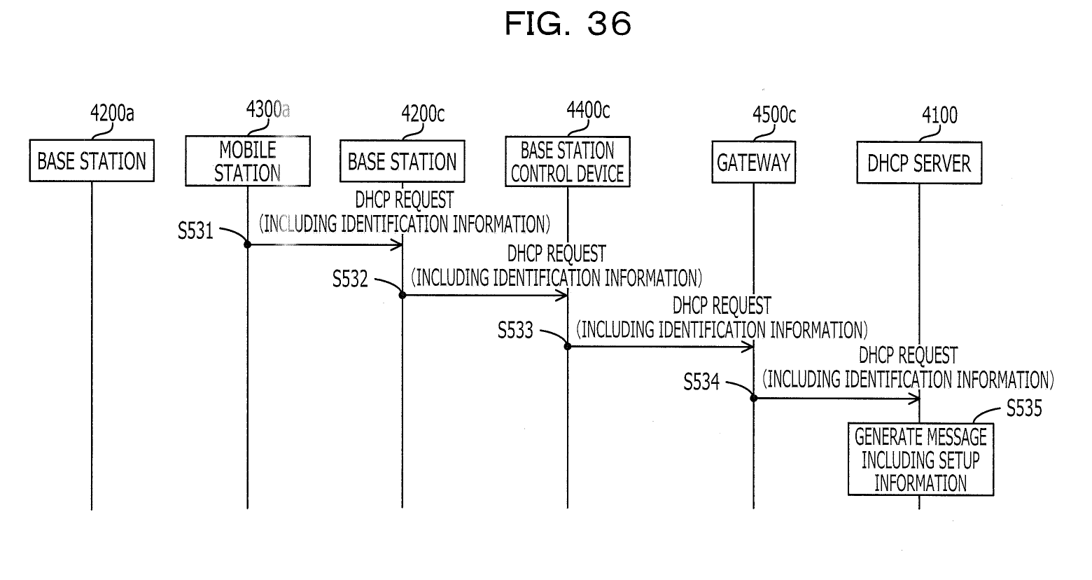

FIGS. 35 and 36 are sequence charts illustrating the operation at the time of handover of a mobile station in the communication system according to the sixth embodiment. Now, in the event that the mobile station 4300a which has been connected to the base station 4200a connects to the base station 4200c by handover, DHCP resetting is performed based on refresh such an IP address or the like. At this time, the mobile station 4300a transmits a DHCP REQUEST message by wireless communication, and the DHCP REQUEST message transmitted from the mobile station 4300a arrives at the DHCP server 4100 via the base station 4200c, base station control device 4400c, and gateway 4500c.

Hereafter, description will be made regarding the operation procedure of the communication system in the event that DHCP settings are obtained again at the time of occurrence of handover due to movement of the mobile station 4300a in accordance with FIGS. 35 and 36.

[Step S521] The mobile station 4300a transmits an MOB MS-HOREQ (HandOver REQuest) to the base station 4200a which has been connected thereto. Processing from Step S521 through the following Step S527 will be taken as a handover procedure.

[Step S522] Upon receiving the MOB MS-HOREQ transmitted in Step S521, the base station 4200a transmits an MOB BS-HORSP (HandOver ReSPonse) to the mobile station 4300a.

[Step S523] Upon receiving the MOB BS-HORSP transmitted in Step S522, the mobile station 4300a transmits an MOB MS-HOIND (HandOver INDication) to the base station 4200a.

[Step S524] The mobile station 4300a changes a frequency used for communication based on changeover of a connection destination by handover.

[Step S525] The base station 4200c transmits a DCD including PGID (identification information) indicating the location of the mobile station 4300a by wireless communication.

[Step S526] The base station 4200c transmits a UCD by wireless communication.

[Step S527] The mobile station 4300a and base station 4200c execute the Network ReEntry procedure. Assignment of the IP address of the mobile station 4300a is refreshed by the Network Entry procedure.

[Step S528] The mobile station 4300a generates a DHCP REQUEST message in which the identification information obtained in Step S525 has been included.

[Step S531] The mobile station 4300a transmits the DHCP REQUEST message generated by the identification information being included therein in Step S528.

[Step S532] The base station 4200c transfers the DHCP REQUEST message (including identification information) transmitted by the mobile station 4300a in Step S531 to the inside of the wireless access carrier network.

[Step S533] The base station control device 4400c transfers the DHCP REQUEST message (including identification information) transferred from the base station 4200c in Step S532. At this time, the base station control device 4400c transfers the DHCP REQUEST message to the DHCP server 4100 of the provider network via the gateway 4500c by the DHCP relay agent.

[Step S534] Upon receiving the DHCP REQUEST message (including identification information) transferred from the base station control device 4400c in Step S533, the gateway 4500c transfers the received DHCP REQUEST message.

[Step S535] The DHCP server 4100 selects setup information according to the location of the mobile station 4300a based on the identification information included in the DHCP REQUEST message transmitted from the gateway 4500c in Step S525. Also, the DHCP server 4100 determines an IP address to be assigned to the mobile station 4300a which has transmitted the DHCP REQUEST message. The DHCP server 4100 generates a DHCP ACK message including the selected setup information and proposed IP address for assignment. With processing thereafter, the DHCP ACK message including the DHCP settings generated by the DHCP server 4100 is transmitted to the mobile station 4300a which is connected to the base station 4200c via the communication system. The mobile station 4300a which has received the DHCP ACK message including the DHCP settings sets the IP address proposed for continuity or the IP address proposed for assignment by the DHCP server to the own IP address. Also, the mobile station 4300a performs the own communication setting based on the setup information transmitted from the DHCP server 4100.

Thus, with the mobile station 4300a, the DHCP settings are updated by a DHCP REQUEST message being transmitted based on DHCP resetting after handover. Thus, the DHCP settings are updated according to the location of the mobile station 4300a after handover.

Also, with the sixth embodiment, though the DHCP server 4100 belongs to the provider network, the present disclosure is not restricted to this, and may belong to the wireless access carrier network or another network.

The communication system according to the sixth embodiment as described above has the same advantages as with the fifth embodiment, and also includes PGID in a DHCP DISCOVER message or the like at the mobile station 4300a to transmit this, and accordingly may not depend on a relay device such as a base station, base station control device, or the like. Also, increase in the load of a relay device due to processing for including PGID in a DHCP DISCOVER message or the like, and so forth may be suppressed by a base station.

### Seventh Embodiment

Next, a seventh embodiment will be described. Description will be made with difference as to the second embodiment as the center, and description will be omitted regarding the same matters as with the fifth embodiment. The communication system according to the seventh embodiment differs from the second embodiment in that a network configuration server manages bases where a VM is operating, a DHCP server requests the location of the VM from the network configuration server in the event of having received a DHCP DISCOVER message or DHCP REQUEST message from a VM, the network configuration server includes identification information indicating the location of the VM in a response and responds to the DHCP server in the event of having received the request from the DHCP server, the DHCP server transmits a message including setup information indicating the DHCP settings according to the location of the VM indicated by the identification information included in the response in the event of having received the response from the network configuration server, and the VM performs DHCP setting based on the setup information included in the received message.

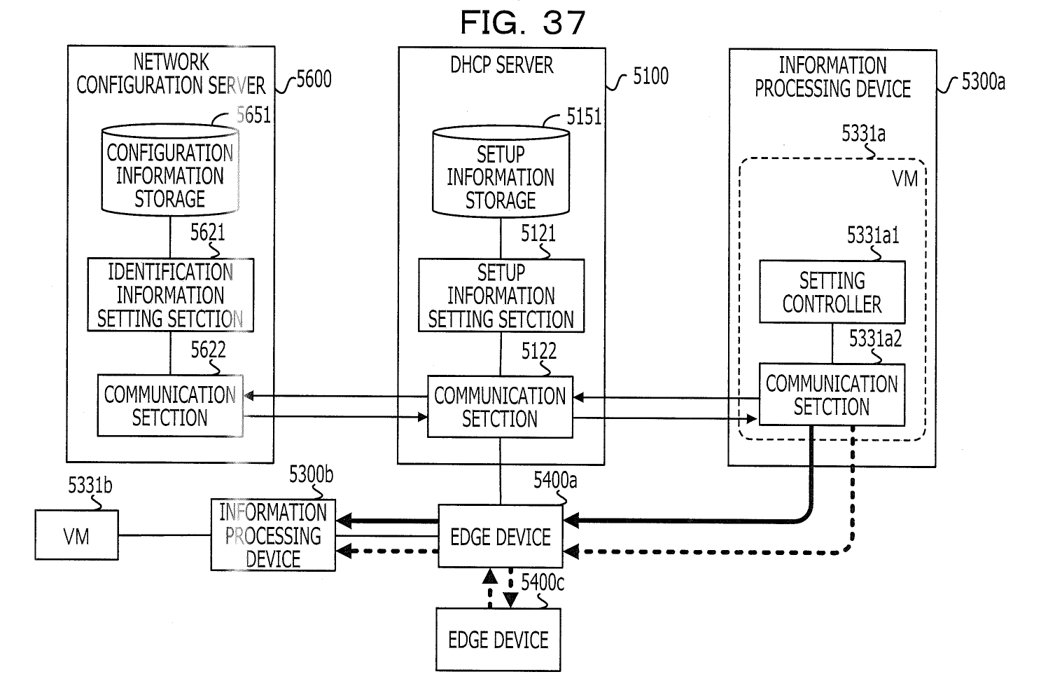

FIG. 37 is a block diagram illustrating the communication system according to the seventh embodiment. Now, with the seventh embodiment, though description will be made regarding the time of starting operation in the case that the host is a VM, and the time of movement due to live migration occurring, this may also be applied to the time of the physical machine starting operation in the case that the host is a physical machine.

The communication system according to the seventh embodiment includes a DHCP sever 5100, information processing devices 5300a and 5300b, edge devices 5400a and 5400c, and a network configuration server 5600. Here, in the same way as with the information processing device 300a according to the second embodiment, the information processing device 5300a belongs to the base 80a within the data center 71, the edge device 5400a is directly connected to the base 80a in the same way as with the edge device 400a according to the second embodiment, and the edge device 5400c is disposed in the data center 72 different from the information processing device 5300a in the same way as with the edge device 400c according to the second embodiment, and also connected to the edge device 5400a by the tunnels 61a and 61b. With the base 80a to which the information processing device 5300a belongs, the nodes are connected by a physical line, and also between the bases 80c and 80e may be connected by the tunnels 61a and 63a respectively. Also, the base 80a may be connected to the base 80b via the edge device 5400a. Also, the information processing device 5300b belongs to the base 80b within the data center 71 in the same way as with the information processing device 300b according to the second embodiment.

The DHCP server 5100 performs communication setting of another device such as a VM 5331a or the like by including setup information in a DHCP OFFER message or DHCP ACK message to transmit this to the VM 5331a. The DHCP server 5100 includes a setup information setting section 5121, a communication section 5122, and a setup information storage 5151. The DHCP server 5100 serves as a first server.

The communication section 5122 has received the DHCP DISCOVER message or DHCP REQUEST message transmitted from the VM 5331a, or the like. The setup information setting section 5121 generates specific information whereby the VM 5331a may uniquely be specified, based on the MAC address of the VM 5331a, or the like included in the DHCP DISCOVER message received by the communication section 5122, or the like. The setup information setting section 5121 generates a location request including extracted specific information, and causes the communication section 5122 to transmit the generated location request to the network configuration server 5600.

Also, the communication section 5122 has received the location response including identification information indicating the location of the VM 5331a transmitted from the network configuration server 5600. In this case, the setup information setting section 5121 causes the communication section 5122 to transmit a DHCP OFFER message or the like including setup information corresponding to the identification information to the VM 5331a. Also, the identification information included in the DHCP DISCOVER message or the like does not agree with any of the identification information of the setup information. In this case, the setup information setting section 5121 causes the communication section 5122 to transmit a DHCP OFFER message or the like including setup information indicating given settings to the VM 5331a. The DHCP DISCOVER message or the like serves as a setup information request. The DHCP OFFER message or the like including setup information serves as a setup information response.

The setup information storage 5151 stores setup information indicating settings corresponding to the network correlated with identification information. The setup information indicates DHCP settings according to each of the bases 80a through 80f. The setup information includes information indicating a communication device to be set as the default router corresponding to the network. The communication section 5122 communicates with another device using a communication line. The setup information may be the IP address of a device (e.g., edge device 5400a) to be set as the default router of the host within the communication system, for example, such as the VM 5331a or the like. Also, the setup information may be the IP address of a DNS server, NTP server, or PROXY server of the host within the communication system, or DNS domain name.

The network configuration server 5600 includes an identification information setting section 5621, a communication section 5622, and a configuration information storage 5651. The communication section 5622 communicates with another device using a communication line. The network configuration server 5600 serves as a second server.

The communication section 5622 has received the location request including specific information for specifying the VM 5331a transmitted from the DHCP server 5100. In this case, the identification information setting section 5621 generates a location response including identification information corresponding to the specific information included in the location request based on the configuration information in response to the location request received by the communication section 5622. The identification information setting section 5621 then causes the communication section 5622 to transmit the location response including the identification information to the DHCP server 5100.

The configuration information storage 5651 stores the specific information of the VM 5331a, and the identification information indicating the base 80a to which the VM 5331a currently belongs in a correlated manner.

The VM 5331a is a virtual machine which operates over the information processing device 5300a which is a physical machine. The VM 5331a includes a setting controller 5331a1 and a communication section 5331a2. The VM 3531a serves as an information processing device.

In the event of having obtained setup information included in the DHCP OFFER message or DHCP ACK message transmitted from the DHCP server 5100, the setting controller 5331a1 performs communication setting based on the obtained setup information. The communication section 5331a2 performs communication using a communication line based on the communication settings by the setting controller 5331a1.

In the event of performing communication setting in accordance with the DHCP server 5100, the VM 5331a transmits a DHCP DISCOVER message or the like to the DHCP server 5100 via the switch 200a.

The VM 5331a has received the DHCP OFFER message including setup information transmitted from the DHCP server 5100 or the like as a response of the transmitted DHCP DISCOVER message or the like. In this case, the VM 5331a performs DHCP setting suitable for the base 80a to which the VM 5331a belongs, such as the default router or the like using the setup information included in the DHCP OFFER message including the setup information, or the like.

In the event that the VM 5331a which has operated at the information processing device 5300a disposed in the base 80a has moved to the information processing device 5300e disposed in the base 80e by live migration, the VM 5331a transmits a DHCP REQUEST message as will be described later. Also, at this time, the VM 5331a informs the network configuration server 5600 that the VM 5331a has moved to the information processing device 5300e in the base 80e. The network configuration server 5600 performs updating wherein the movement of the VM 5331a has reflected on the configuration information based on the notification from the VM 5331a. The DHCP server 5100 transmits a location request including the specific information of the VM 5331a to the network configuration server 5600 in response to the DHCP REQUEST message from the VM 5331a over the information processing device 5300e. Now, with the configuration information of the network configuration server 5600, the specific information of the VM 5331a, and the base 80e where the VM 5331a is currently located are correlated. Upon receiving the location request from the DHCP server 5100, the network configuration server 5600 references the configuration information to transmit a location response including identification information (indicating “base 80e”) corresponding to the specific information included in the location request to the DHCP server 5100. Upon receiving the location request including the identification information transmitted by the network configuration server 5600, the DHCP server 5100 transmits a DHCP ACK message including setup information suitable for the base 80e to the VM 5331a over the information processing device 5300e based on the identification information. Thus, the VM 5331a which has moved to the information processing device 5300e after live migration may obtain the setup information corresponding to the base 80e, and perform DHCP setting suitable for the base 80e.

With the seventh embodiment, upon receiving the DHCP DISCOVER message from the VM 5331a, the DHCP server 5100 transmits a location request including the specific information of the VM 5331a to the network configuration server 5600. Upon receiving the location request, the network configuration server 5600 references the configuration information, and includes identification information corresponding to the specific information in a location response to transmit to the DHCP server 5100. Thus, the DHCP server 5100 may specify the base 80a to which the VM 5331a belongs from the identification information included in the location response transmitted from the network configuration server 5600.

In accordance with this, the DHCP server 5100 may include setup information indicating settings suitable for the base 80a to which the VM 5331a belongs in the DHCP OFFER message or the like to transmit to the VM 5331a based on identification information.

Also, the VM 5331a has received the DHCP OFFER message including setup information transmitted from the DHCP server 5100, or the like. In this case, the VM 5331a may perform communication setting suitable for the base 80a to which the VM 5331a belongs according to the setup information included in the DHCP OFFER message including setup information, or the like.

Note that the network configuration server 5600 may be realized with the same hardware configuration as with the DHCP server 100 illustrated in FIG. 3 according to the second embodiment.

Also, with the seventh embodiment, though the DHCP server 5100 and network configuration server 5600 are individually disposed, the present disclosure is not restricted to this, and may be realized with the same server.

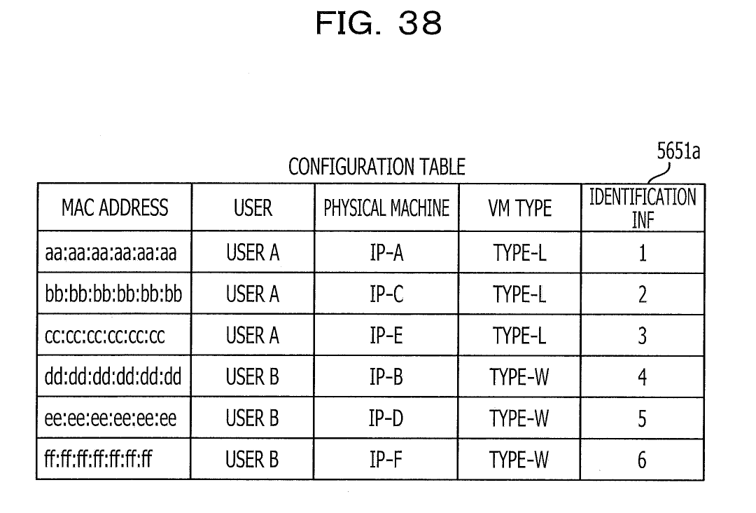

FIG. 38 is a diagram indicating a configuration table according to the seventh embodiment. The configuration table 5651a indicated in FIG. 38 is stored in the configuration information storage 5651 which the network configuration server 5600 includes. The configuration table 5651a is a table for storing the configuration information regarding the VM 5331a or the like. With the network configuration server 5600, the configuration information is employed for a response of identification information such as the VM 5331a or the like as to the request of the DHCP server 5100 which has received the DHCP DISCOVER message from the VM 5331a, or the like. The configuration information indicates the information of each VM which operates within the communication system, and is updated by the network configuration server 5600 each time the operation of the VM starts or movement due to live migration or the like occurs.

With the configuration table 5651a, “MAC ADDRESS”, “USER”, “PHYSICAL MACHINE”, “VM TYPE”, and “IDENTIFICATION INF” are provided as items. With the configuration table 5651a, information arrayed in the lateral direction of the items is mutually correlated as configuration information.

“SUBNET” indicates the subnet address of the network to which the configuration information is applied.

“MAC ADDRESS” indicates the MAC address of vNIC of a VM within the communication system. The DHCP server 5100 determines the VM to be requested using the MAC address of a VM, and transmits a location request for requesting the location of the VM from the network configuration server 5600. The network configuration server 5600 references the configuration information to respond to the DHCP server 5100 with the identification information of the VM to be requested based on the MAC address indicated by the request.

“USER” indicates the user of the VM indicated by the MAC address.

“PHYSICAL MACHINE” indicates an information processing device (e.g., information processing devices 5100a and 5100e and so forth) where the VM indicated by the MAC address currently operates.

“VM TYPE” indicates the type of the OS of the VM indicated by the MAC address.

“IDENTIFICATION INF” indicates the identification information corresponding to the location of the VM indicated by the MAC address. That is to say, the configuration information correlates the VM indicated by the MAC address with the identification information indicating the location of the VM within the communication system. Here, the location indicated by the identification information is set based on a base to which an information processing device where a VM within the communication system operates belongs.

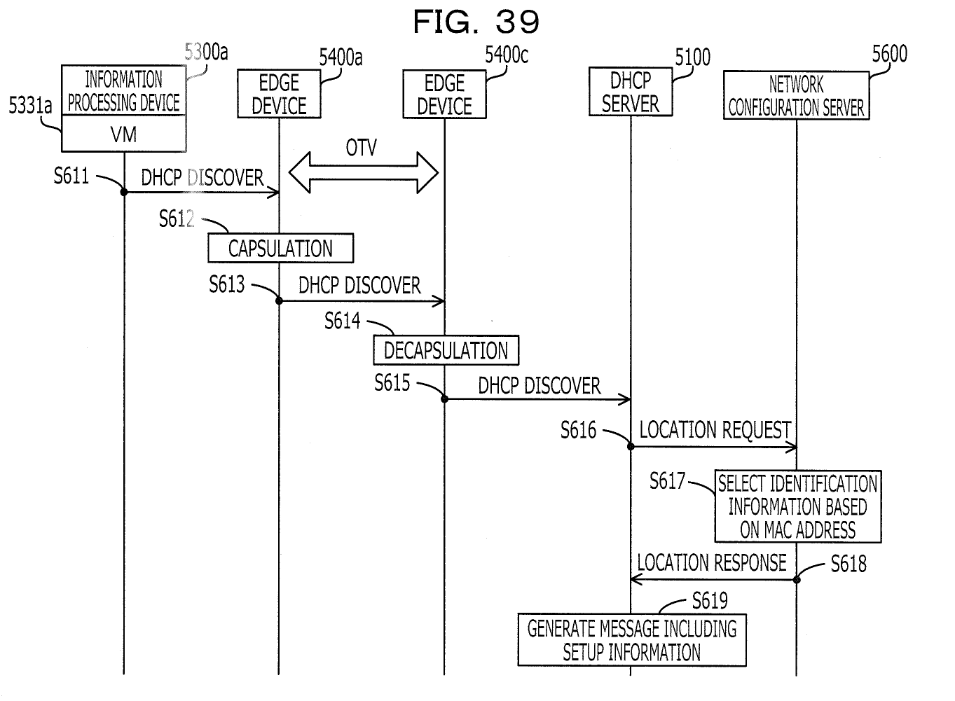

FIG. 39 is a sequence chart illustrating the operation at the time of activation of a VM in the communication system according to the seventh embodiment. Now, the VM 5331a which is the host and is operating over that information processing device 5300a transmits a DHCP DISCOVER message so as to re-obtain settings according to DHCP at the time of activation of the own device, for example. Also, the DHCP DISCOVER message transmitted from the VM 5331a by broadcast arrives at the DHCP server 5100 via the edge devices 5400a and 5400c. Also, layer 3 packets are transferred between the edge devices 5400a and 5400c over the Internet 60 by OTV in a capsulated state. Also, with the DHCP server 5100, setup information indicating settings such as the default router according to the location of the host, and so forth has already been set to the setup information storage 5151 by the administrator of the communication system, or the like.

Hereafter, description will be made regarding the operation procedure of the communication system in the event that a DHCP DISCOVER message has been transmitted from the VM 5331a in accordance with FIG. 39.

[Step S611] The VM 5331a transmits the DHCP DISCOVER message by broadcast.

[Step S612] The edge device 5400a performs EoIP capsulation as to the DHCP DISCOVER message transmitted from the VM 5331a.

[Step S613] The edge device 5400a transfers the DHCP DISCOVER message capsulated in Step S612 by OTV.

[Step S614] The edge device 5400c decapsulates the DHCP DISCOVER message capsulated by EoIP and also transferred by OTV.

[Step S615] The edge device 5400c transfers the DHCP DISCOVER message decapsulated in Step S614.

[Step S616] The DHCP server 5100 extracts the MAC address of the VM 5331a included in the DHCP DISCOVER message transmitted from the edge device 5400c in Step S615. The DHCP server 5100 transfers a location request including the extracted MAC address of the VM 5331a to the network configuration server 5600.

[Step S617] Upon receiving the location request transmitted from the DHCP server 5100 in Step S616, the network configuration server 5600 references the configuration information. The network configuration server 5600 selects identification information corresponding to the MAC address of the VM 5331a included in the location request transmitted from the DHCP server 5100 in Step S616 based on the location request and configuration information.

[Step S618] The network configuration server 5600 transmits a location response including the identification information selected in Step S617 to the DHCP server 5100.

[Step S619] The DHCP server 5100 selects setup information according to the location of the VM 5331a based on the identification information included in the location request transmitted from the edge device 5400c in Step S618. Also, the DHCP server 5100 determines an IP address to be assigned to the VM 5331a which has transmitted the DHCP DISCOVER message. The DHCP server 5100 generates a DHCP OFFER message including the selected setup information and the proposed IP address for assignment. Processing thereafter is the same as with the communication system according to the second embodiment, and description thereof will be omitted.

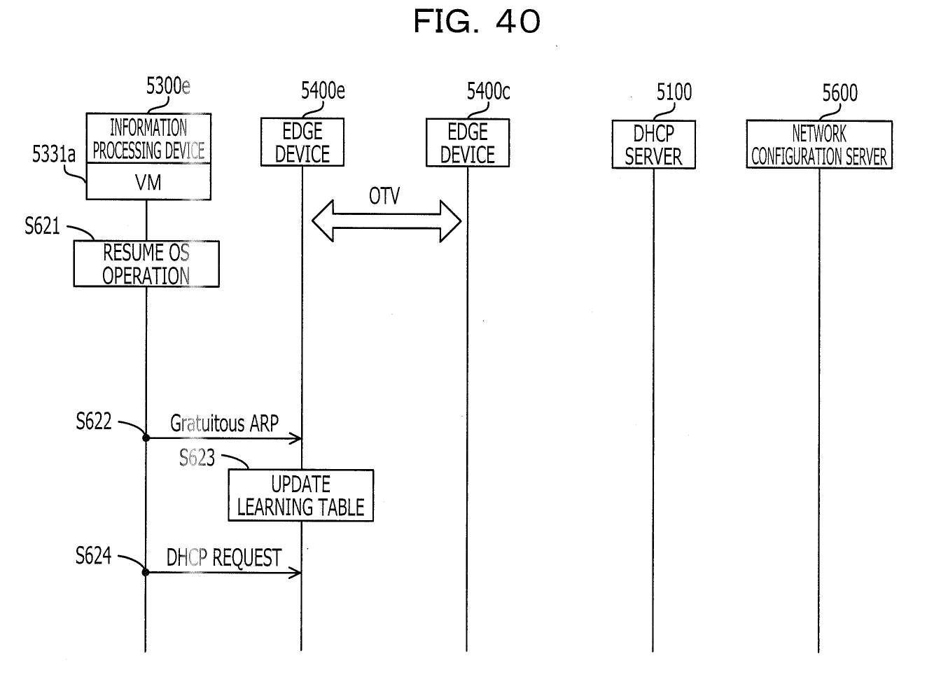

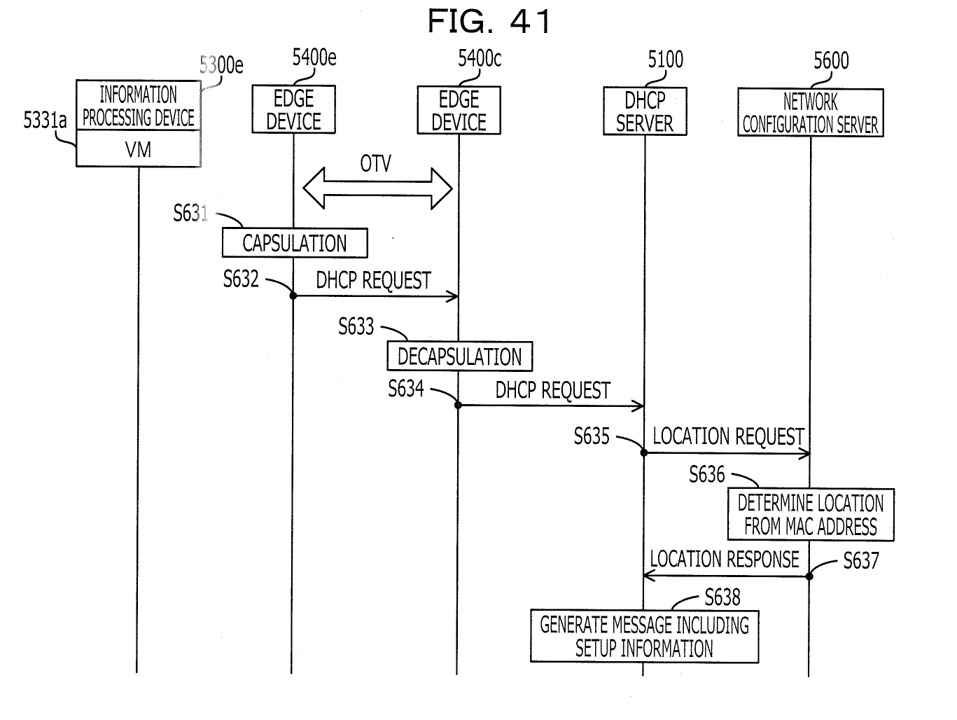

FIGS. 40 and 41 are sequence charts illustrating the operation at the time of live migration of a VM in the communication system according to the seventh embodiment. Now, the VM 5331a which has operated over the information processing device 5300a moves to the information processing device 5300e by live migration, and further, DHCP resetting is performed for the expiration date management of the DHCP settings at the VM 5331a over the information processing device 5300e. At this time, the VM 5331a transmits a DHCP REQUEST message to the DHCP server 5100 or by broadcast, and the DHCP REQUEST message transmitted from the VM 5331a arrives at the DHCP server 5100 via the edge devices 5400e and 5400c. Also, the layer 3 packets are transferred between the edge devices 5400e and 5400c over the Internet 60 by OTV in a capsulated state.

Hereafter, description will be made regarding the operation procedure of the communication system in the event of obtaining DHCP settings again after the VM 5331a moves by live migration in accordance with FIGS. 40 and 41.

[Step S621] The information processing device 5300e resumes the operation of the VM 5331a using the OS memory image transferred from the information processing device 5300a.

[Step S622] The VM 5331a transmits Gratuitous ARP by broadcast.

[Step S623] Upon receiving the Gratuitous ARP transmitted from the VM 5331a in Step S622, the edge device 5400a performs updating for registering the VM 5331a in the learning table.

[Step S624] Upon given time relating to the expiration date of the DHCP settings having elapsed, the VM 5331a transmits a DCHP REQUEST message to the DHCP server 5100 or by broadcast. Here, in the event that the management of the expiration date of the DHCP settings is based on DHCP Renewing, the VM 5331a transmits a DCHP REQUEST message to the DHCP server 5100. On the other hand, in the case based on DHCP Rebinding, the VM 5331a broadcasts the DHCP REQUEST message as to the DHCP server 5100.

[Step S631] The edge device 5400e performs EoIP capsulation as to the DHCP REQUEST message transmitted from the VM 5331a in Step S624.

[Step S632] The edge device 5400e transfers the DHCP REQUEST message capsulated in Step S631 by OTV.

[Step S633] The edge device 5400c decapsulates the DHCP REQUEST message capsulated by EoIP and also transferred by OTV.

[Step S634] The edge device 5400c transfers the DHCP REQUEST message decapsulated in Step S633.

[Step S635] The DHCP server 5100 extracts the MAC address of the VM 5331a included in the DHCP REQUEST message transmitted from the edge device 5400c in Step S634. The DHCP server 5100 transfers a location request including the extracted MAC address of the VM 5331a to the network configuration server 5600.

[Step S636] Upon receiving the location request transmitted from the DHCP server 5100 in Step S635, the network configuration server 5600 references the configuration information. The network configuration server 5600 selects identification information corresponding to the MAC address of the VM 5331a included in the location request transmitted from the DHCP server 5100 in Step S635 based on the location request and configuration information.

[Step S637] The network configuration server 5600 transmits a location response including the identification information selected in Step S636 to the DHCP server 5100.

[Step S638] The DHCP server 5100 selects setup information according to the location of the VM 5331a based on the identification information included in the location request transmitted from the edge device 5400c in Step S637. Also, the DHCP server 5100 determines an IP address to be assigned to the VM 5331a which has transmitted the DHCP REQUEST message. The DHCP server 5100 generates a DHCP ACK message including the selected setup information and proposed IP address for assignment. With processing thereafter, the DHCP ACK message including the DHCP settings generated by the DHCP server 5100 is transmitted to the VM 5331a which operates over the information processing device 5300a via the communication system. The VM 5331a which has received the DHCP ACK message including the DHCP settings sets the IP address proposed for continuity or the IP address proposed for assignment by the DHCP server 5100 to the own IP address. Also, the VM 5331a performs the own communication setting based on the setup information transmitted from the DHCP server 5100.

Thus, with the VM 5331a, the DHCP settings are updated by a DHCP REQUEST message being transmitted based on the management of DHCP Renewing or DHCP Rebinding of the expiration date of the DHCP settings after live migration. Thus, the DHCP settings are updated according to the location of the VM 5331a after live migration.

Note that, the VM 5331a according to the seventh embodiment performs updating of the DHCP settings using the DHCP REQUEST message based on the expiration date management of DHCP after live migration. However, the present disclosure is not restricted to this, and an arrangement may be made wherein the VM 5331a releases the DHCP settings by transmitting a DHCP RELEASE message to the DHCP server 5100, and requests the DHCP settings according to the location of the VM 5331a by transmitting a DHCP DISCOVER message to the DHCP server 5100 again.

Also, with the seventh embodiment, description has been made regarding the operation of DHCP setting suitable for the location of a movement destination in the event that live migration has been performed with the VM 5331a. However, the present disclosure is not restricted to this, and the communication system according to the seventh embodiment may be applied to other movements of an information processing device where the VM 5331a operates, such as quick migration, fail over, and so forth.

Also, with the seventh embodiment, though the VM 5331a and DHCP server 5100 belong to a different base, the present disclosure is not restricted to this, these may belong to the same base. Also, the DHCP server 5100 may belong to a network different from the bases.

With the communication system according to the seventh embodiment as described above, the DHCP server 5100 which has received the DHCP DISCOVER message from the VM 5331a, or the like transmits a location request to the network configuration server 5600. The network configuration server 5600 which has received the location request from the DHCP server 5100 transmits a location response including identification information to the DHCP server 5100. Thus, the communication system according to the seventh embodiment has the same advantages as with the second embodiment.

Also, in the event that the administrator intends to manually change the correspondence relation between the location of the host in the communication system and the DHCP settings, the correspondence relation may be changed by correcting the configuration information of the network configuration server 5600, or the like without changing the physical location of a switch or the like, nor the identification information that the switch has. That is to say, the management of the DHCP settings of the host in the communication system may readily be performed.

### Eighth Embodiment

Next, an eighth embodiment will be described. Description will be made with difference as to the second embodiment as the center, and description will be omitted regarding the same matters as with the second embodiment. With the communication system according to the eighth embodiment, multiple networks are connected by multiple routers. In this case, the eighth embodiment differs from the second embodiment in that upon a VM having transmitted a DHCP DISCOVER message or DHCP REQUEST message, a switch directly connected to the VM includes identification information indicating the location of the VM in the message to transfer to the DHCP server, and upon receiving the DHCP DISCOVER message or DHCP REQUEST message from the VM which has been transferred by the switch, the DHCP server transmits a message including setup information indicating the DHCP settings according to the location of the VM indicated by the identification information to the VM, and the VM performs DHCP setting based on the setup information included in the received message.

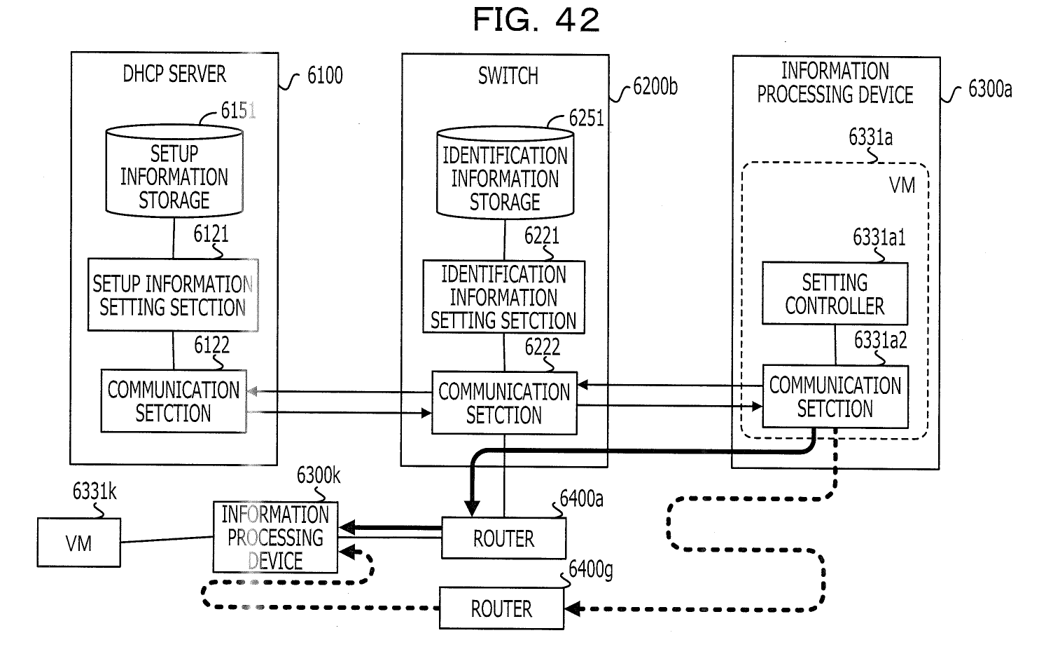

FIG. 42 is a block diagram illustrating the communication system according to the eighth embodiment. Now, with the eighth embodiment, though description will be made regarding the time of starting operation and the time of movement occurring due to live migration or the like in the event that the host is a VM, this may also be applied to the time of the physical machine starting operation in the event that the host is a physical machine.

The communication system according to the eighth embodiment includes a DHCP server 6100, a switch 6200b, information processing device 6300a and 6300k, and routers 6400a and 6400g. Here, as will be described later, the switch 6200b and information processing device 6300a belong to a base 6000a. Also, the information processing device 6300a and switch 6200b may be directly connected without passing through another switch. Also, the router 6400a may be connected to the information processing device 6300a. Also, though the router 6400g may be connected to the information processing device 6300a, the path length at the time of connection is longer as compared to the router 6400a. The path length may be defined according to the physical length and logical length of a communication line, propagation time based on actual measurement, processing time of an intervening device, the number of hops, and so forth. The information processing device 6300k belongs to, as will be described later, a base 6000b which is a network different from the information processing device 6300a, and is a network which may be connected by any of the routers 6400a, 6400d, and 6400g.

The DHCP server 6100 performs communication setting of another device such as a VM 6331a or the like by including setup information in a DHCP OFFER message or DHCP ACK message to transmit to the VM 6331a. The DHCP server 6100 includes a setup information setting section 6121, a communication section 6122, and a setup information storage 6151.

The communication section 6122 has received a DHCP DISCOVER message or DHCP REQUEST message including identification information. Here, the DHCP REQUEST message is a DHCP REQUEST message at the time of DHCP Renewing and at the time of DHCP Rebinding. In this case, the setup information setting section 6121 causes the communication section 6122 to transmit a DHCP OFFER message including the setup information corresponding to the identification information, or the like, to the VM 6331a. Also, identification information included in a DHCP DISCOVER message or the like does not agree with any of the identification information of setup information. In this case, the setup information setting section 6121 causes the communication section 6122 to transmit a DHCP OFFER message including setup information indicating given settings, or the like, to the VM 6331a. The DHCP DISCOVER message and so forth serve as a setup information request. The DHCP OFFER message including setup information, and so forth, serve as a setup information response.

The setup information storage 6151 stores setup information indicating the settings corresponding to the network correlated with identification information. The setup information indicates the DHCP settings in accordance with the location of the VM 6331a. Here, the location of the VM 6331a is a topological location in a network of an operating physical machine, and means a connection relation. The setup information includes information indicating a communication device to be set as the default router corresponding to a network. The communication section 6122 communicates with another device using a communication line. The setup information may be the IP address of a device (e.g., router 6400a) to be set as the default router of the host within the communication system, for example, such as the VM 6331a or the like. Also, the setup information may be the IP address of a DNS server, NTP server, or PROXY server of the host within the communication system, or DNS domain name.

The switch 6200b includes the identification information setting section 6221, communication section 6222, and identification information storage 6251. The communication section 6222 communicates with another device by a communication line.

The communication section 6222 has received the DHCP DISCOVER message transmitted from the VM 6331a, or the like. In this case, the identification information setting section 6221 includes identification information in the DHCP DISCOVER message received by the communication section 6222, or the like. The identification information setting section 6221 then causes the communication section 6222 to transmit the DHCP DISCOVER message in which the identification information has been included, or the like to the DHCP server 6100. In the event that identification information has already been included in a DHCP DISCOVER message and DHCP REQUEST message by another device at the time of transfer, the identification information setting section 6221 does not have to include identification information at the own device. This is because if the identification information of the own device is written over the identification information already included by another device, the location of the VM 6331a becomes obscure. Also, this is because there is another device in which identification information is to be included, between the own device and the VM 6331a, and if the identification information is additionally included in the event of not being connecting to the VM 6331a directly, the identification information of the own device fails to indicate the location of the VM 6331a, which is unnecessary.

The identification information storage 6251 stores identification information indicting the location to which the VM 6331a belongs. The identification information may be information whereby the switch 6200b may uniquely be identified in the communication system.

The VM 6331a is a virtual machine which operates over the information processing device 6300a which is a physical machine. The VM 6331a includes a setting controller 6331a1 and a communication section 6331a2. The VM 6331a serves as an information processing device.

In the event of having obtained setup information included in the DHCP OFFER message or DHCP ACK message transmitted from the DHCP server 6100, the setting controller 6331a1 performs communication setting based on the obtained setup information. The communication section 6331a2 performs communication using a communication line based on the communication settings by the setting controller 6331a1.

The VM 6331a has received the DHCP OFFER message including setup information transmitted from the DHCP server 6100 or the like. In this case, the VM 6331a performs DHCP setting suitable for the location of the VM 6331a, such as the default router or the like using the setup information included in the DHCP OFFER message including the setup information, or the like.

In the event of performing communication setting in accordance with the DHCP server 6100, the VM 6331a transmits a DHCP DISCOVER message or the like to the DHCP server 6100 via the switch 6200b.

Now, the VM 6331a transmits data to the VM 6331k which operates over the information processing device 6300k disposed in a network connectable with any of the routers 6400a, 6400d, and 6400g, via the default router. At this time, in the event of transmitting the packets of user data, the VM 6331a may transmit the packets with the routers 6400a and 6400d as the default routers. In this case, which of the routers 6400a and 6400d the VM 6331a transmits the packets to the VM 6331k with as the default router is a problem. In this way, there may be a case where how to perform communication setting suitable for the network to which the VM 6331a belongs is a problem.

Examples of this case includes a case where the communication system has a large scale, and a case where large capacity of data is communicated with the communication system. In such cases, with regard to the VM 6331a, one having a short path length of the routers 6400a and 6400d may be set as the default router, traffic efficiency may be realized. Thus, occurrence of delay or congestion within the communication system may be reduced. In this way, occurrence of delay, or the load of the communication system may be changed depending on which of the routers 6400a and 6400d the VM 6331a performs communication by.

On the other hand, with the eighth embodiment, the switch 6300b directly connected to the VM 6331a without passing through another switch includes identification information whereby the switch 6300b may be determined in the DHCP DISCOVER message from the VM 6331a, or the like to transfer to the DHCP server 6100. Thus, in the event of having received the DHCP DISCOVER message from the VM 6331a, or the like, the DHCP server 6100 may determine the location of the VM 6331a from the identification information included in the DHCP DISCOVER message or the like based on the switch 6300b.

In accordance with this, the DHCP server 6100 may transmit to the VM 6331a by including setup information indicating settings suitable for the host directly connected to the switch 6300b a DHCP OFFER message or the like based on the identification information.

Also, the VM 6331a has received the DHCP OFFER message including setup information transmitted from the DHCP server 6100, or the like. In this case, the VM 6331a may perform communication setting suitable for the host directly connected to the switch 6300b using the setup information included in the DCHP OFFER message including setup information, or the like.

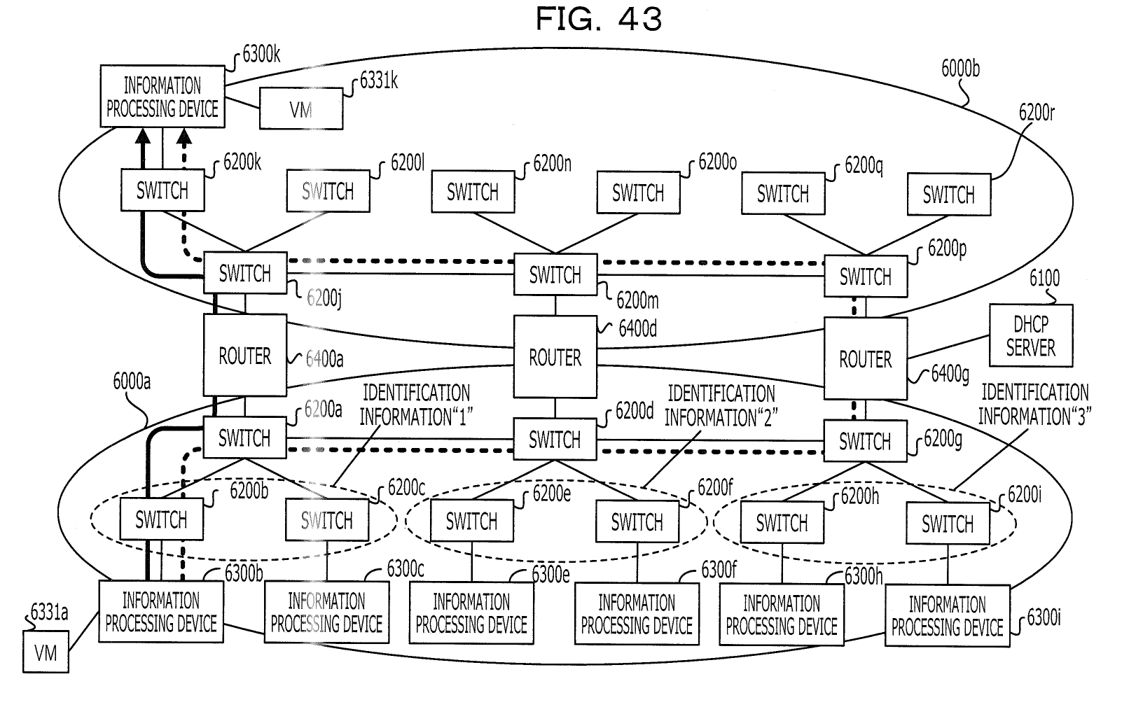

FIG. 43 is a diagram illustrating the communication system according to the eighth embodiment. With the communication system according to the eighth embodiment, there are provided a base 6000a for providing the service of the user A, and a base 6000b for providing the service of the user B at a data center where the data of a cloud computing service is stored, and also processing is executed. The base 6000a includes switches 6200a, 6200b, 6200c, 6200d, 6200e, 6200f, 6200g, 6200h, and 6200i, and information processing devices 6300b, 6300c, 6300e, 6300f, 6300h, and 6300i. The base 6000b includes switches 6200j, 6200k, 6200l, 6200m, 6200n, 6200o, 6200p, 6200q, and 6200r, and an information processing device 6300k. Also, the bases 6000a and 6000b are connected by routers 6400a, 6400d, and 6400g, and may mutually be connected as extranets.

The switch 6200a of the base 6000a is connected to the router 6400a and switches 6200b and 6200c. The switch 6200b is connected to the switch 6200a and information processing device 6300b. The switch 6200c is connected to the switch 6200a and information processing device 6300c. The switch 6200d is connected to the router 6400d and switches 6200e and 6200f. The switch 6200e is connected to the switch 6200d and information processing device 6300e. The switch 6200f is connected to the switch 6200d and information processing device 6300f. The switch 6200g is connected to the router 6400g and switches 6200h and 6200i. The switch 6200h is connected to the switch 6200g and information processing device 6300h. The switch 6200i is connected to the switch 6200g and information processing device 6300i.

The switch 6200j of the base 6000b is connected to the router 6400a and switches 6200k and 6200l. The switch 6200k is connected to the switch 6200j and information processing device 6300k. The switch 6200m is connected to the router 6400d and switches 6200n and 6200o. The switch 6200p is connected to the router 6400g and switches 6200q and 6200r.

The router 6400a is connected to the switches 6200a and 6200j. The router 6400d is connected to the switches 6200d and 6200m. The router 6400g is connected to the switches 6200g and 6200p. Also, the router 6400g is connected with the DHCP server 6100. The router 6400g transfers the DHCP messages from the information processing devices in the bases 6000a and 6000b to the DHCP sever 6100 by DHCP relay agent. Thus, the DHCP setting within the bases 6000a and 6000b is performed by the DHCP server 6100. Note that the present disclosure is not restricted to this, and the DHCP server 6100 may be disposed within any of the bases 6000a and 6000b.

Each of the bases 6000a and 6000b is a network of which the internal nodes are connected by a LAN. A subnet address has been set to the base 6000a. A subnet address different from the base 6000a has been set to the base 6000b.

The information processing devices 6300b, 6300c, 6300e, 6300f, 6300h, and 6300i are physical machines where the VM 6331a can operate. The VM 6331a is a virtual machine which the user A has contracted, and performs service processing as to the user A. The information processing device 6300k is a physical machine where the VM 6331k may operate. The VM 6331k is a virtual machine which the user B has contracted.

“1” has been set to the switches 6200b and 6200c which have a short path length as to the router 6400a as identification information. Accordingly, the DHCP DISCOVER message from a VM which operates over the information processing device 6300b directly connected to the switch 6200b, or the like, is transferred by the identification information “1” being included therein by the switch 6200b. Similarly, the DHCP DISCOVER message from a VM which operates over the information processing device 6300c directly connected to the switch 6200c, or the like, is transferred by the identification information “1” being included therein by the switch 6200c. Also, with the setup information of the DHCP server 6100, the identification information “1” and that the router 6400a is set as the default router are correlated. Thus, with regard to the VM which operates over the information processing devices 6300a and 6300c, the router 6400a may be set as the default router.

“2” has been set to the switches 6200e and 6200f which have a short path length as to the router 6400d as identification information. Accordingly, the DHCP DISCOVER message from a VM which operates over the information processing device 6300e directly connected to the switch 6200e, or the like, is transferred by the identification information “2” being included therein by the switch 6200e. Similarly, the DHCP DISCOVER message from a VM which operates over the information processing device 6300f directly connected to the switch 6200f, or the like, is transferred by the identification information “2” being included therein by the switch 6200f. Also, with the setup information of the DHCP server 6100, the identification information “2” and that the router 6400d is set as the default router are correlated. Thus, with regard to the VM which operates over the information processing devices 6300e and 6300f, the router 6400d may be set as the default router.

“3” has been set to the switches 6200h and 6200i which have a short path length as to the router 6400g as identification information. Accordingly, the DHCP DISCOVER message from a VM which operates over the information processing device 6300h directly connected to the switch 6200h, or the like, is transferred by the identification information “3” being included therein by the switch 6200h. Similarly, the DHCP DISCOVER message from a VM which operates over the information processing device 6300i directly connected to the switch 6200i, or the like, is transferred by the identification information “3” being included therein by the switch 6200i. Also, with the setup information of the DHCP server 6100, the identification information “3” and that the router 6400g is set as the default router are correlated. Thus, with regard to the VM which operates over the information processing devices 6300h and 6300i, the router 6400g may be set as the default router.

Now, in the event of performing communication from the VM 6331a (host) which operates over the information processing device 6300b to the VM 6331k which operates over the information processing section 6300k, the default router set by the DHCP server 6100 is the router 6400g. At this time, communication from the VM 6331a of the information processing device 6300b to the VM 6331k of the information processing device 6300k passes through the router 6400g (dotted line in FIG. 43), and accordingly passes through many switches, and consequently, wasteful delay occurs. Also, in the event that the DHCP server 6100 has set all of the default routers of hosts to the router 6400g, traffic is concentrated on the router 6400g, and accordingly, congestion readily occurs.

Therefore, with the eighth embodiment, identification information is set to the switches (in the case of the base 6000a, the switches 6200b, 6200c, 6200e, 6200f, 6200h, and 6200i) directly connected to the host. The switches 6200b, 6200c, 6200e, 6200f, 6200h, and 6200i transfer the DHCP DISCOVER message that the host transmits, or the like by the identification information being included therein. The DHCP server 6100 which has received the DHCP DISCOVER message in which the identification information has been included, or the like, performs DHCP setting corresponding to the location of the host (the switch directly connected to the host) as to the host based on the identification information.

The administrator of the network may statically set identification information to each of the switches 6200b, 6200c, 6200e, 6200f, 6200h, and 6200i while taking topological distance with the routers 6400a, 6400d, and 6400g into consideration. Alternatively, identification information may automatically be set according to the topology of the network using something like a server which manages the network.

According to these, the DHCP settings may be set so as to handle the location of the host such that the nearest router 6400a is set to the information processing device 6300b by the DHCP server 6100 as the default router, and accordingly, increase in the load of the network may be suppressed.

Note that, with the eighth embodiment, though the VM 6331a and DHCP server 6100 belong to another network connected by the router 6400g, the present disclosure is not restricted to this, and they may belong to the base 6000a or base 6000b.

The communication system according to the eighth embodiment as described above has the following advantages. It may be difficult to recognize the location of the VM 6331a within the network since a single subnet address is set to the network, and also the configuration of the network is complicated or large in scale, and so forth. In such a case, the DHCP server 6100 may determine the location of the VM 6331a at the base 6000a based on the identification information included and transferred at the switch 6200b. Thus, the DHCP server 6100 may perform suitable DHCP setting according to the location of the VM 6331a. Accordingly, occurrence of delay and the load of the communication system may be suppressed.

Note that the above-mentioned processing functions may be realized by a computer. In this case, a program in which the processing contents of the functions that the DHCP servers 100, 1100, 2100, 3100, 4100, 5100, and 6100 have to have are described will be provided. The above-mentioned processing functions are realized over the computer by executing the program thereof at the computer. The program in which the processing contents are described may be recorded in a computer-readable recording medium. Examples of the computer-readable recording medium include magnetic storage devices, optical discs, magneto-optical disks, and semiconductor memory. Examples of the magnetic storage devices include hard disk drives (HDD), flexible disks (FD), and magnetic tapes. Examples of the optical discs include DVD, DVD-RAM, and CD-ROM/RW. Examples of the magneto-optical disks include MO (Magneto-Optical disks).

In the event of circulating the program, transportable recording media such as DVD, CD-ROM, or the like where the program thereof has been recorded will be sold, for example. Alternatively, an arrangement may be made wherein the program is stored in the storage device of a server computer, and the program thereof is transferred from the server computer to another computer via the network.

The computer which executes programs stores the program recorded in a transportable recording medium, or the program transferred from the server computer in the own storage device. The computer then reads the program from the own storage device, and executes processing in accordance with the program. Note that the computer may also directly read out the program from the transportable recording medium, and execute processing in accordance with the program thereof. Also, the computer may execute processing in accordance with the received program each time a program is transferred from the server computer connected via a network.

Also, at least a portion of the above-mentioned processing functions may also be realized with an electronic circuit such as a DSP (Digital Signal Processor), an ASIC (Application Specific Integrated Circuit), a PLD (Programmable Logic Device) or the like.

According to the communication setting methods, servers, relay devices, communication systems, and information processing devices according to the above first through eighth embodiments, communication setting according to the location of a terminal or information processing device may be performed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication setting method comprising:
receiving, at a server in a network to be connected to another network by a plurality of connected devices, a setting request from a terminal to the server;
selecting, at the server, one of the plurality of connected devices based on terminal location information regarding the location of the terminal relating to the received setting request;
transmitting a setting response including identification information for identifying the selected connected device from the server to the terminal;
setting, at the terminal, the connected device of this terminal based on the identification information included in the setting response.

2. The communication setting method according to claim 1, wherein the terminal location information is included in the setting request by a relay device configured to relay communication between the terminal and the server.

3. The communication setting method according to claim 1, wherein the terminal location information is included in the setting request by the terminal which obtains the terminal location information from a relay device configured to relay communication between the terminal and the server.

4. The communication setting method according to claim 1, wherein the server requests a network management server of the terminal location information;
and wherein the selecting selects one of the plurality of connected devices based on the terminal location information received from the network management server, and the transmitting transmits a setting response including identification information for identifying this selected connected device to the terminal.

5. The communication setting method according to claim 1, wherein the terminal is a virtual terminal over a host connected to the network;
and wherein the server receives the setting request including terminal location information regarding the location of the virtual terminal;
and wherein the server selects one of the plurality of connected devices based on the received terminal location information, and transmits a setting response including identification information for identifying this selected connected terminal to the virtual terminal;
and wherein the host causes the terminal to receive the setting response;
and wherein the host causes the terminal to set a connected device of this terminal based on the identification information included in the received setting request.

6. A server comprising:
a receiver configured to receive a setting request from a terminal in a network to which another network and a plurality of connected devices are connected; and
a transmission section configured to select one of the plurality of connected devices based on terminal location information regarding the location of the terminal relating to the received setting request, and to transmit a setting response including identification information for identifying the selected connected device to the terminal, the setting response being a response of the setting request, and the terminal using the setting response for setting of a connected device.

7. A relay device comprising:
a receiver configured to receive a setting request to a server from a terminal in a network to be connected to another network by a plurality of connected devices, and the setting response being a response of the setting request, and the terminal using for setting of a connected device a setting response that is a response of the setting request from the server; and
a transmission section configured to transmit to the server the received setting request by including terminal location information regarding the location of the terminal.

8. A communication setting method comprising:
receiving, at a server, a setting request from an information processing device to the server;
transmitting, at the server, based on setup information indicating a setting corresponding to the location indicated by identification information indicating the location of the information processing device that is identification information relating to the setting request, a setup information response including setup information as to the identification information; and
performing, at the information processing device, communication setting based on the setup information.

9. The communication setting method according to claim 8, wherein, in the event of having received a setting request transmitted from the information processing device, a relay device includes identification information indicating a network to which the information processing device belongs of a plurality of networks having the same subnet address in the received setting request, and transmits a setting request including the identification information to a server;
and wherein, in the event of having received the setting request including the identification information, the server transmits, based on setup information indicting a setting corresponding to a network indicated by the identification information, a setup information response including setup information corresponding to the identification information to the information processing device.

10. The communication setting method according to claim 8, wherein the information processing device is a virtual machine which can be operated at a first physical machine disposed in a first network, and at a second physical machine disposed in a second network different from the first network, and also move an operating physical machine;
and wherein, in the event that the information processing device which has operated at the first physical machine has moved to the second physical machine, the information processing device operates at the second physical machine to transmit the setting request;
and wherein, in the event of having received the setting request transmitted from the information processing device, a relay device disposed in the second network includes identification information indicting the second network in the received setting request, and transmits a setting request including the identification information to the server;
and wherein, in the event of having received a setting request including the identification information, the server transmits, based on the setup information, a setup information response including setup information corresponding to the second network indicated by the identification information to the information processing device.

11. The communication setting method according to claim 8, wherein, in the event that the identification information does not agree with any of the identification information of the setup information, the server transmits a setup information response including setup information indicating a setting corresponding to a network to which the server belongs to the information processing device based on the setup information.

12. The communication setting method according to claim 8, wherein, in the event of having received the setting request transmitted from an information processing device, a relay device includes identification information indicating a location within a network to which the information processing device belongs in the received setting request, and transmits the setting request including the identification information to a server;
and wherein, in the event that of having received the setting request including the identification information, the server transmits, based on setup information indicating a setting corresponding to the location indicated by the identification information, a setup information response including setup information corresponding to the identification information to the information processing device.

13. The communication setting method according to claim 8, wherein, with the network, the information processing device and a base station can be connected by wireless communication;
and wherein, in the event of having received the setting request transmitted from the information processing device via the base station by wireless communication, the relay device includes identification information indicating a location within the network therein, and transmits the setting request including the identification information to the server.

14. The communication setting method according to claim 8, wherein a relay device transmits identification information indicating a location within a network to which the information processing device belongs to the information processing device;
and wherein, in the event of having received the identification information, the information processing device transmits the setting request including the identification information to a server.

15. The communication setting method according to claim 8, wherein, in the event of having received the setting request transmitted from the information processing device, the server transmits a location request including specific information by which the information processing device can be specified to a second server;
and wherein, in the event of having received the location request, the second server includes, based on the specific information included in the location request, identification information indicating a network to which an information processing device belongs of a plurality of networks having the same subnet address correlated with the specific information, and transmits a location request including the identification information to the server;
and wherein, in the event of having received the location request including the identification information, the server transmits, based on the setup information indicating a setting corresponding to the network indicated by the identification information, a setup information response including the setup information corresponding to the identification information to the information processing device.

16. A communication system for performing communication setting of an information processing device based on setup information transmitted from a server, comprising:
a relay device; and
a server;
wherein the relay device includes
an identification information storage configured to store identification information indicating a network to which the information processing device belongs of a plurality of networks having the same subnet address,
a relay device communication section configured to communicate using a communication line, and
an identification information setting section configured to include, in the event of the relay device communication section having received the setting request transmitted from the information processing device, the identification information in the setting request received by the relay device communication section, and causes the relay device communication section to transmit the setting request including the identification information to the server;
and wherein the server includes
a setup information storage configured to store setup information indicating a setting corresponding to the network indicated by the identification information,
a server communication section configured to communicate using a communication line, and
a setup information setting section configured to cause, in the event of the server communication section having received a setting request including the identification information, the server communication section to transmit a setup information response including the setup information corresponding to the identification information to the information processing device.

17. A server for transmitting setup information to perform communication setting of an information processing device, comprising:
a setup information storage configured to store, regarding a plurality of networks having the same subnet address, setup information indicating a setting corresponding to the network indicated by identification information indicating a network to which the information processing device belongs;
a communication section configured to communicate using a communication line;
a setup information setting section configured to cause, in the event of the communication section having received a setting request including the identification information, based on the setup information, the communication section to transmit a setup information response including the setup information corresponding to the identification information to the information processing device.

18. A relay device for relaying communication between an information processing device configured to perform communication setting based on transmitted setup information and a server, comprising:
an identification information storage configured to store identification information indicating a network to which the information processing device belongs of a plurality of networks having the same subnet address;
a communication section configured to communicate using a communication line;
an identification information setting section configured to cause, in the event of the communication section having received the setting request transmitted from the information processing device, the communication section to include the identification information in the setting request received by the communication section, and to transmit the setting request including the identification information to the server which transmits a setup information response including the setup information corresponding to the identification information to the information processing device.

19. An information processing device configured to perform communication setting based on the setup information transmitted from a server, comprising:
a communication section configured to communicate using a communication line;
a setting controller configured to cause, in the event of having received identification information indicating a location within a network to which the information processing device belongs transmitted from a relay device, the communication section to transmit a setting request including the identification information, based on setup information indicating a setting corresponding to the location indicated by the identification information, to a server which transmits a setup information response including the setup information corresponding to the identification information to the own device.
